(19) United States
(12) Patent Application Publication
(10) Pub. No.: US 2024/0144354 A1
(43) Pub. Date: May 2, 2024

(54) DYNAMIC STORE FEEDBACK SYSTEMS FOR DIRECTING USERS

(71) Applicant: Grabango Co., Berkeley, CA (US)

(72) Inventors: William Glaser, Berkeley, CA (US); Andy Jensen, Berkeley, CA (US); Ryan L. Smith, Berkeley, CA (US)

(21) Appl. No.: 18/460,292

(22) Filed: Sep. 1, 2023

Related U.S. Application Data
(60) Provisional application No. 63/402,974, filed on Sep. 1, 2022.

(51) Int. Cl. G06Q 30/0601; G01C 21/00; G06V 20/52; G06V 40/20

(52) U.S. Cl. CPC G06Q 30/0639; G01C 21/38; G06V 20/52; G06V 40/20

(57) ABSTRACT

A system and method for actively directing users within an environment that can include accessing item data of a user at an environment; at a sensor-based monitoring system, monitoring location of the user within the environment; and modifying state of a subset of feedback devices based on the item data and the location of the user, wherein the subset of feedback devices are part of a set of feedback devices distributed within the environment.

This application claims the benefit of U.S. Provisional Application No. 63/402,974, filed on 1 SEP 2022, titled “DYNAMIC STORE FEEDBACK SYSTEMS FOR DIRECTING USERS”, which is incorporated in its entirety by this reference.

### TECHNICAL FIELD

### Technical Field

This invention relates generally to the field of sensor-based navigation technology, and more specifically to a new and useful system and method for dynamic store feedback systems for directing users.

### Background

There has been increasing demand for automation in retail environments and in particular in grocery stores. For example, there has been increasing demand for grocery delivery services allowing customers to place orders of items from a retail store (often a grocery store) and have those items delivered. This often will involve a worker going to the store, picking up all the items for an order and then driving those items to the customer. In some cases, a worker may pick up items for multiple orders.

It can often be challenging for workers to locate items of another user's shopping list, which can lead to selection of incorrect items or missing items. This can lead to customer dissatisfaction. Additionally, the challenges of finding items can result in slower fulfilment times.

Thus, there is a need, especially in the field of sensor-based navigation technology to create a new and useful system and method for dynamic store feedback systems for directing users. This invention provides such a new and useful system and method.

### BRIEF DESCRIPTION OF THE FIGURES

FIG. 1 is a schematic representation of a first system.

FIGS. 2A and 2B are schematic representations of a system variations involving robotic agents.

FIG. 3 is a schematic representation of a system used with user device agents and order delivery systems.

FIG. 4 is a flowchart representation of a first method.

FIGS. 5 and 6 are schematic representations of generating a graph based on a product location map.

FIG. 7 is a flowchart representation of a variation of a method using graph traversal of a waypoint graph.

FIG. 8 is a flowchart representation of a variation of a method providing navigation of a mobile robotic agent.

FIG. 9 is a flowchart representation of a variation of a method performing navigation of a mobile robotic agent.

FIG. 10 is a flowchart representation of a variation of a method providing navigation directions to a user device agent.

FIG. 11 is a flowchart representation of a variation of a method updating multiple agents in parallel.

FIG. 12 is a flowchart representation of a variation of a method updating different types of agents.

FIG. 13 is a schematic representation of a system for automated product location tracking within an environment using various empirical data sources.

FIG. 14 is a flowchart representation of method constructing a candidate product location dataset from communicated operational data sources and transformed into product location tracking output.

FIG. 15 is a flowchart representation of method for automated item location tracking.

FIG. 16 is a flowchart representation of a variation of a method for automated item location tracking.

FIG. 17 is a flowchart representation of a variation of a method for automated product location tracking.

FIG. 18 is a flowchart representation of a variation of a method performed iteratively.

FIG. 19 is a detailed flowchart representation of processes of a variation of a method.

FIG. 20 is a detailed flowchart representation of processes of a variation of a method.

FIG. 21 is a schematic representation of creating a candidate product location dataset using temporal scoping.

FIG. 22 is a schematic representation of creating a candidate location dataset using customer scoping.

FIG. 23 is a schematic representation of using shopping events of multiple potential customers for a receipt.

FIG. 24 is a schematic representation of using intersection of multiple customer paths.

FIG. 25 is an exemplary implementation of the method used with stocking data; and

FIG. 26 a schematic representation of analysis of a collection of candidate location associations for a given product identifier to determine likely locations of the product across a store.

FIG. 27 a schematic representation of analysis of a collection of candidate location associations for a given product identifier to determine likely locations of the product on a shelf.

FIG. 28 is a schematic representation of using computer vision validation.

FIG. 29 is a schematic representation of using computer vision product type segmentation in enhancing product location map.

FIG. 30 is a schematic representation of a product scanning device receiving feedback.

FIG. 31 is a schematic representation of a sequence of events for collecting associated product event location data and then a product scanning event data.

FIG. 32 is a schematic representation of a sequence of events for collecting associated a product scanning event data and then product event location data.

FIG. 33 is a schematic representation of a sequence of events for collecting associated a product scanning event data and using a visual identifier to set product event location data.

FIG. 34 is a schematic representation of a feedback device being updated to assist a user.

FIG. 35 is a flow diagram representation of a method variation.

FIGS. 36-38 are flow diagrams representation of method variations.

FIG. 39 is a detailed flow diagram of a variation of modifying state of a subset of feedback devices.

FIG. 40 is a schematic representation of different of how modifying state of a feedback device may be applied.

FIG. 41 is a schematic representation of using feedback devices in different ways.

FIG. 42 is an exemplary system architecture that may be used in implementing the system and/or method.

### DESCRIPTION OF THE EMBODIMENTS

The following description of the embodiments of the invention is not intended to limit the invention to these embodiments but rather to enable a person skilled in the art to make and use this invention.

### 1. Overview

A systems and methods for actively directing customers functions to use dynamic approaches to delivering feedback to users such that they can more easily locate products.

The systems and methods can be used to make users more efficient in navigating stores and to have an improved experience. The systems and methods preferably include use of a set of feedback devices distributed within an environment like a retail environment. The set of feedback devices can be updated and controlled to provide various cues to users or other agents performing various tasks like finding items from a shopping list. The control of such feedback systems can be based on a dynamic planogram (at least in part), which can supply accurate and updated data on item locations within an environment. Variations for updating such a planogram are described herein.

In one variation, the system and method can control electronic shelf labels (ESLs) and/or other feedback devices distributed across the store to communicate customer specific information based on data of a particular user (e.g., the user's shopping list). Individual ESLs could be updated to visually signal to a relevant user that they should direct their attention towards it, ideally in the interest of picking up an item near that ESL.

The method may additionally or alternatively use other feedback mediums such as personal computing devices to enable other forms of feedback to enhance digital user interfaces abilities to steer a user to particular items.

Feedback is preferably triggered in one or more of the different feedback mediums to draw the attention of a user to a product storage location. This functions to make it easier for the user to locate an item on the shelf. Additionally or alternatively, the feedback could indicate when the user is a general vicinity of a targeted product. For example, a flashing light, or blinking price tag(s) could trigger when the system detects a user to be in a section of the store where a desired product is located.

The systems and method can be used to direct workers who are collecting a shopping basket (or baskets) for other users (such as for a delivery order). For example, the system and method may be used to assist a user trying to find one or more items. The system and method may be used to dynamically trigger user feedback outputs of the feedback devices to help the user navigate to the correct location in a shopping environment and to locate an item on a shelf. The systems and method may also be used to help workers when stocking products in the store. For example, the system and method may receive task updates for different items such as indication of items that need some worker action like if products need to be stacked or tidied. The worker can more easily be directed to these locations by following the cues provided by the feedback devices.

The systems and methods could additionally be used for customers that manage their shopping list in a digital form, that have one or more digital coupons for items, has selected a recipe, or that otherwise has a digital data related one or more items in the store.

The system and method may be used in combination with a CV system or some other monitoring system. The CV system or monitoring may be used to provide user tracking and/or user-item interaction detection (e.g., detecting product selection events).

Additionally or alternatively, other user tracking monitoring systems may be used. For example, GPS, differential GPS, WiFi/RF triangulation, BLE, magnetic or gravity fingerprints, accelerometers/IMUs, user-device cameras, and/or other location tracking techniques may be used to track a user through an environment.

Herein, a CV monitoring system is used as a primary example. However, alternative monitoring systems could similarly be used to supply user location data, user or item event data, and/or other data. In some variations, the system and method could be implemented without CV or monitoring systems. For example, dynamic control of ESLs could be used based on when a shopper starts a shopping session.

In some variations, the system and method can be used in combination with a substantially live planogram so that real-time dynamic route planning may be used to direct a user through the store in an enhanced manner (e.g., shortest path, shortest time, less congestion, best order for a given shopping list (e.g., frozen items last)).

In one example, the system and method may be employed such that: when a picker begins their shop, the system and method could update the state of the LEDs on all of the ESLs that are on their shopping list. If there are more than one picker in-store at once, different colors may be used to represent different pickers, and optionally one distinguished color to mean multi. Alternatively, a single color for everything and the pickers' lists could be allowed to overlap. Alternatively, the system and method might just activate a portion of the graphical display of the ESL for the same purpose. Additionally, activating the LED and the display could be used. The display could be used to communicate extra info on the LCD, like which picker this is for or how many they should get, etc.

Furthermore, a dynamic planogram or other accurate map of the product locations could be used to direct the path of the user through the store, where the path could be enhanced or optimized in some way. Realtime feedback could additionally be provided through personal computing devices like an AR device, smart glasses, connected headphones, a smart phone, a smart watch, some other smart wearable or any suitable mobile computing device.

The system and method may be used in combination with a system and method for reactive navigation using a sensor derived planogram that can leverage accurate and current monitoring of inventory and agents in an environment for more efficient agent navigation through an environment. In particular, the system and method can be applied to enable assistive technology for agents selecting multiple products or performing different actions at different locations or regions from across a retail environment. In some instances, the system and method can be used for coordinating communication and updates of one or more computer-operated devices (e.g., a mobile robotic agent).

The system and method may have various areas of applications. The system and method may, in some variations, be used in augmenting the automated navigation of a mobile robotic device. This could be a robot moving along the ground (e.g., wheeled locomotion, leg-based locomotion, etc.), but may additionally or alternatively include aerial drones, wire-suspended devices, or other computer-controlled devices that can move in at least a semi-automated manner.

The system and method can additionally or alternatively be used for augmenting the user interface of a remote-controlled mobile device. In some variations, the system and method may additionally or alternatively be used in altering the user interface and app state of a user-device agent. For example, a phone, tablet, network-connected audio device (e.g., headphones), headset (e.g., smart glasses, augmented reality (AR) headset, virtual reality (VR) headset, etc.) may have turn-by-turn directions supplied using the sensor-derived planogram.

In one particular application, the system and method can be applied to unique technology-based tools used for custom order selection operations such as may be used within a retail environment like a grocery store or in a warehouse.

As a first exemplary application, the system and method may be used in coordinating operation and/or communication with computing devices used by agents fulfilling orders. The system and method may be used in connection with an order-fulfillment platform such that multiple orders may be processed continuously and simultaneously. The system and method can be used for triggering and executing communications, alerts, and/or user interface updates with appropriate client devices in coordination with CV or sensor-based monitoring and a digital order system. As one example, the system and method can be used to time delivery of interface feedback for on-demand delivery in response to current conditions.

As another exemplary application, the system and method may be used in providing enhanced navigation output that leverages sensor-based data and/or historical order data. For example, the system and method can adapt item selection instructions by altering location of an item pickup, recommended path, order of items for pickup, and/or other modifications in response to sensed inventory status, activities of the agents, state of other agents and/or people in the environment, and/or other variables.

When robotic agents are used within crowded environments, errors or wrong decisions in navigating the store can be costly in many ways. Robot agents must move carefully and so their speed may be reduced to avoid accidents. If in traditional systems product location information is wrong, there could be bad consequences. The system and method may include variations to address such potential issues. The system and method may potentially enhance navigation accuracy and efficiency especially when the navigation route is based on product-based waypoints. The system and method can additionally address changes in conditions within the environment to reactively update the route.

As another exemplary application, the system and method may be used for enhanced digital tracking and control of a digital ordering system. Previous systems often depended on manual self-reporting by an agent or trusting an agent to properly fulfill an order. The system and method may enable integration with a digital ordering system, which may be used in automatically updating digital records regarding the status of an order, communication to a customer, performing sensor data-based audits of order completion, and/or other digital tasks.

The system and method functions to enhance the technical capabilities of client applications/devices and/or digital systems used in connection with a digital ordering system. Herein, a digital ordering system can be any suitable system used to define and/or manage a set of orders. An order will be a list of one or more items for collection. The order will generally be purchased using a digital payment checkout process. However, an order may be fulfilled without or independent of a checkout transaction. In one example, the digital ordering system enables outside customers to pick items for adding to an order and then manage the fulfillment of the order and in some instances deliver the order.

The system and method are generally applied so that it can manage operating across multiple agents simultaneously.

The system and method are generally described as it would be applied to an agent. Examples are supplied for both mobile robotic agents and human controlled user device agents. Human controlled user device agents may be used by customers in a retail store, workers, or any suitable user. Robotic agents and human agents both generally move across an environment and may perform certain product-location focused tasks such as pick items, scanning items or the environment, perform product stocking tasks, perform maintenance tasks (like cleaning a floor), and the like.

The system and method may have applications to grocery retail environments. Herein, a grocery store environment is used as a primary example. Other retail environments may also be suitable environments. Many industrial environments such as warehouses may also be exemplary environments. the system and method are not limited to these environments and may be used in any suitable type of environment.

Herein, product location map is used to characterize a database system, data model, and/or other data system used to represent product locations within an environment. A product location map may alternatively be referred to as a planogram, product placement map, inventory map, shelving map, and/or other term used to refer to a digital resource used to associate product identifiers with locations in one or more environments.

The system and method may provide a number of potential benefits. The system and method are not limited to always providing such benefits and are presented only as exemplary representations for how the system and method may be put to use. The list of benefits is not intended to be exhaustive and other benefits may additionally or alternatively exist.

As one benefit, the system and method can enable a novel user interface capability such that product labels and/or other store-distributed digitally controlled elements could be used to create user-customized feedback. This can be used to make it easier for users to locate locations of items. This could have benefits for store workers, outside parties performing a task within the store (e.g., fulfilling a delivery order, performing product facing duties, etc.), and/or customers.

As another potential benefit, the system and method may enhance the navigation of an agent through a store. For a mobile robot, the robot can use an environment monitoring system and optionally unique planogram generation approach for more accurate navigation to a set of product locations.

As another potential benefit, the system and method may enhance performance and efficiency of a digital ordering system.

As another potential benefit, the system and method may use access to more real-time data to enhance item selection. Better inventory tracking can enable a better presentation of possibilities. Furthermore, the system and method may enable digitally sensed verification of fulfillment of an order (e.g., sensing selection of an item on an order lies.

As another potential benefit, the system and method can have more reactive performance, enabling new technical capabilities to alter operation in reaction to current conditions of inventory and sensed activity in the store.

As another potential benefit, the system and method may enable an enhanced digital user experience where the user interface of a client device used by an agent (or other connected devices in the environment) can better navigate a store and complete instructions. For example, real-time and adaptive instructions can be provided based on real-time remote tracking of a user. Personal computing devices may be remotely controlled to provide instructions based on remotely sensed conditions of that person in relationship to the environment. For example, the CV monitoring system can track if the user is facing and directing attention to the right location for picking an item.

As another potential benefit, the system and method may enable new forms of operational coordination with groups of agents and/or automated devices (e.g., robots). As one example, robust item selection tracking and agent tracking may be used in enabling coordinated item hand-offs. For example, a first agent may pick up a product and leave it in a secondary location which is then picked-up by the agent. This may be used to enable partial order picking and collecting of partial orders into a full order. In other implementations, this may be used to direct, coordinate, and digitally track ad-hoc setup for forward picks (placing of select items near a primary picking/packing location). For example, a user may pick many popular items of pending orders and deposit them in a more centralized/convenient location, then agents collecting an order with that popular can use that prepared item location to add the item to the order.

As a related potential benefit, the system and method may additionally be used to enhance management of multiple orders. The system and method can track and direct selection of item for two or more orders by a single agent. For example, instructions may be mixed appropriately. In another variation, the system and method may be used for verifying sorting of items into appropriate order bins.

### 2. System

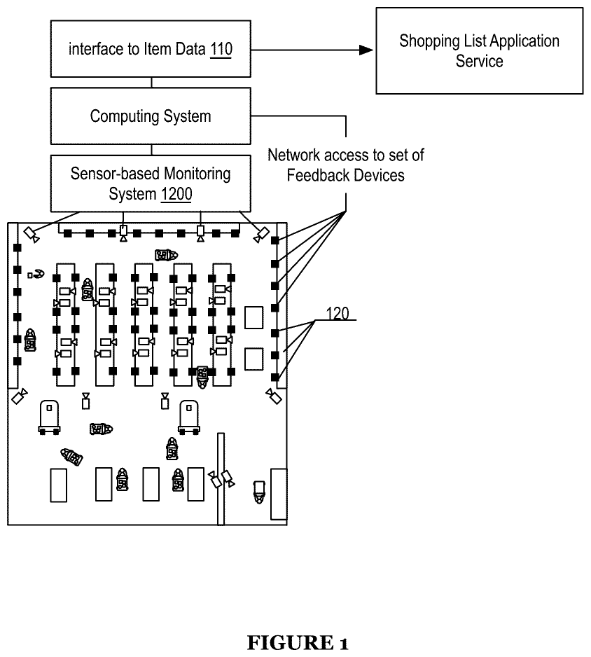

As shown in FIG. 1, a system for actively directing customers can include an interface to item data of users 11o and at least one feedback device 120. In one such variation, the system may include a set of feedback devices 120 distributed at distinct locations across an environment; an interface to item data of users 11o; a computing system (e.g., an agent management system and/or a sensor-based monitoring system) comprising one or more processes and computer-readable medium (e.g., non-transitory computer-readable medium) storing instructions that, when executed by one or more computer processors of a computing system, cause the computing system to perform operations comprising: accessing item data of a user at an environment through the interface to item data 110; and modifying state of a subset of the set of feedback devices 120 based on the item data.

The system can additionally include a sensor-based monitoring system 1200 such as a CV monitoring system and/or a user location monitoring system, which may be used to provide more dynamic and responsive modification capabilities. In such a variation, the system may include: a set of feedback devices 120 distributed at distinct locations across an environment; an interface to item data of users 11o; a sensor-based monitoring system 130 comprising configuration to perform operations comprising: monitoring location of the user within the environment, and modifying state of a subset of feedback devices 120 based on the item data and the location of the user, wherein the subset of feedback devices 120 are part of a set of feedback devices 120 distributed within the environment.

The system may additionally include a planogram mapping processor service, agent device(s), an agent management system, and/or other suitable elements. The systems described herein may include configuration to perform method processes and variations described herein. Accordingly, a system may include a non-transitory computer-readable medium storing instructions that, when executed by one or more computer processors of a computing platform, cause the computing platform to perform operations comprising: dynamically modifying state of the feedback device 120 for a set of targeted items and/or any method substeps and/or variations describes such as accessing item data of a user at an environment; at a sensor-based monitoring system, monitoring location of the user within the environment; and modifying state of a subset of feedback devices 120 based on the item data and the location of the user.

The interface to item data 11o functions to enable access to item data for users. The item data for users is generally motivates why a user is wanting assistance. In the context of retail applications, the item data can be a shopping list. This may be a prospective shopping list (e.g., what a customer is hoping to buy during their visit). The shopping list may alternatively be a list of items based on a digital order, where a worker or some other user is fulfilling the digital order by collecting items in the shopping list. The interface to the item data 110 can be a data interface. This interface 110 may be a public or private application programming interface to some application service. The application service could be a digital grocery/shopping deliver service. The application service may alternatively be a shopping list management service. In some variations, the item data may be more based on worker/operational tasks. in this case the item data may originate from store operational digital services. For example, the item data may relate to stocking tasks, organizing tasks, inventory related tasks, and/or any suitable store operational task.

The feedback devices 120 function as controllable devices that have some output that is observable by an agent. In some variations, the feedback devices 120 include human-perceivable outputs that are modified to provide guidance to a user.

The feedback devices 120 in one variation include a distributed set of feedback devices 120. The distributed feedback devices 120 function as environment-installed elements with at least one medium of output. The distributed feedback devices 120 are preferably digitally controlled, which could be performed wirelessly, through a wired connection, by remote control (e.g., IR or RF signals). The distributed devices are preferably network accessible and individually addressable such that they may be individually controlled (or controlled in small, localized groups). The controlling computing system (e.g., a sensor-based monitoring system 1200, an agent management system 1400 or some other managing system) is communicatively coupled to the set of feedback devices.

In one variation, the distributed feedback devices 120 include a set of electronic shelf labels (ESLs). ESLs may, in some instances, be used primarily in the environment to label products, display in-store content (e.g., coupons or marketing materials), or other information. ESLs may be positioned at multiple stocking locations across an environment. In the context of an aisle in a grocery store, each product stocked on shelving of an aisle can have at least one ESL. This may provide a way for a signal to be triggered to draw attention to each individual product SKU.

An ESL may include one or more LEDs that can be used to provide a light-based indicator. Flashing of the light, intensity of the light, and/or possibly color of the light (if a multicolored LED) could be used as feedback to a user.

An ESL may include a graphical display. The display could be an eink display, an OLED display, an LCD display, and/or any suitable type of display. The display could be changed to display different information or to change its state to provide feedback to a user.

The ESLs could change their state to show positive indication of where a user should be directing attention. For example, when a user is looking for a particular type of cereal, then the shelf label of that type of cereal could flash it's LED and update the graphical display of the ESL to show a graphic relevant to the user.

In some variations, an ESL can include an audio output element. The audio output element could allow a simple audio tone or tones to be played, which could be used as a controlled feedback signal. The audio output element could alternatively include a speaker such that audio like a synthesized speech audio or other type of audio feedback could be used.

The ESLs could additionally or alternatively change their state to show negative indication of where a user should be directing their attention. In other words, the feedback devices 120 could update their state to indicate attention should not be directed at them. For example, the ESLs near the type of cereal in the above example, could dim their display, change the color of display, or make some other change to indicate they are not a match to the targeted item.

In addition to or as an alternative to ESLs, the distributed feedback devices 120 could include a digitally controlled lighting system. This lighting system could be an LED lighting system or any suitable type of lighting system. The lighting system could be an overhead lighting but may additionally or alternatively be a shelf lighting system or other types of lighting system. Individual lights or subsections of lights could have state altered as a signal to users near the lights. For example, a shelf light and/or an overhead light could flash, change its color, grow more intense to indicate where a user should head to look for a product. When a user looks down an aisle, they could see one section lit more brightly and could head to that section. This dynamic control could be controlled based on the other users in the area so as not to confuse or disrupt other customers.

As a related variation, the distributed feedback devices 120 could include one or more projector systems which may be used to display projections onto the ground, shelves, an/or other surfaces.

In addition to or as an alternative to ESLs, the distributed feedback devices 120 could include a distributed speaker system. This distributed speaker system may be used to play music or play other audio content for generally enhancing user experience for all users in the environment. However, localized control of subsets of speakers could be used to play audio feedback targeted at one or more users. In addition to or as an alternative to changing the state of an ESL, a speaker near a targeted type of cereal could play some audio signal to help the user looking for that cereal type. For example, the speaker could say “cereal type X is located on the third shelf in position Y”. This message could play dynamically when the user is in appropriate proximity.

The distributed set of feedback devices 120 are preferably digitally controllable such that individual or subsets of the feedback devices 120 could be controlled independently and in parallel. This can enable a managing system to orchestrate dynamic control of the elements across the store for servicing multiple customers.

The feedback devices 120 are preferably spatially positioned across distinct locations. A feedback device 120 may be associated with an individual stocking location to indicate exact shelf position. A feedback device 120 may alternatively be associated with regional stocking locations, distributed at different lengths down an aisle. For example, a speaker or controlled lighting system may provide signaling for a localized section of an aisle or storage area.

The feedback devices 120 may serve one or more different guidance objectives. As one potential objective, the feedback device 120 may be an item location feedback device 120 used to indicate item location. Such feedback devices 120 are preferably activated based on proximity to an item in the item data of the user. As another potential objective, the feedback device 120 may be a route feedback device, which may be used to signal navigational cues such as what direction to walk, direction to turn, mark an aisle for visiting, and/or other forms of navigational cues. In some instances, the system may include dedicated route feedback devices. These may be positioned at key locations such as at walkway intersections, ends of aisles, or other prominent positions. They may be controlled so as to provide cues to a user where to move.

In some variations, the system may additionally or alternatively include devices for augmented feedback through a user-controlled device (e.g., wearable computer, personal computing device, smart-cart, etc.).

In one variation, feedback could be delivered through an augmented reality (AR) feedback device. The AR feedback device 120 could be a headset, but could alternatively be a phone, watch or any suitable device. The AR feedback device 120 could be used to provide real-time directions. In particular, the AR feedback device 120 could add AR or display-based graphics to direct a user to a targeted item. For example, arrows could direct a user to the vicinity of a product and then an AR circle could circle the item on the shelf when that region of the store is shown within the AR user interface of the device.

In a similar variation, the user-controlled feedback device 120 could be an audio headset. This may be used to play audio for the user with signals to direct the user to a targeted item.

In yet another variation, haptic feedback of a personal computing device or other forms of user feedback of a personal computing device could be used. In one variation, the system could modulate haptic feedback based on detected position of a user relative to a targeted item. In one implementation variation, onboard sensors of the personal computing device may be used to detect how to modulate feedback (e.g., based on direction) In another example, a remote monitoring system like a user location monitoring system and/or a CV monitoring system could be used to determine (at least in part) how to modulate the haptic feedback. For example, a user holding out their phone could feel periodic pulses that increase in frequency or intensity as the user holds the phone in the direction of the product. In an alternative variation, haptic feedback could provide less obtrusive forms of feedback. Using CV or location monitoring, haptic feedback could be delivered without the user making any obvious actions to use their device. For example, haptic feedback could be delivered and felt by a user while a phone is in a pocket or a watch is simply being worn.

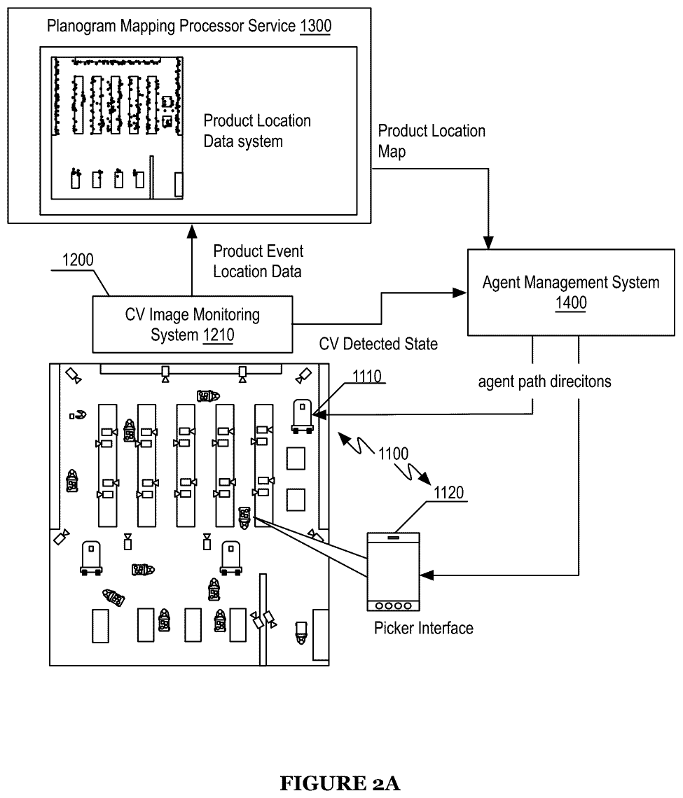

As shown in FIG. 2, in one variation a system variation for reactive route planning using a sensor-derived planogram can include at least one agent device 1100, a sensor-based monitoring system 1200, a planogram mapping processor service 1300, an agent management system 1400. The sensor-based monitoring system may be or include a computer vision monitoring system 1110.

In a system variation used with a robotic device, the system, as shown in FIG. 2A, may include different types of agent devices 1100 such as at least one mobile robotic agent 1110 and at least one user device agent 1120, a sensor-based monitoring system 1200, a planogram mapping processor service 1300, and an agent management system 1400. Some variations may be specifically applied to facilitating interactions with mobile robotic agents 1110 as shown in FIG. 2B.

The mobile robotic agent 1110 functions as the computer-controlled device moving through the store to different waypoints set based on product locations. The mobile robotic agent 1110 may be any suitable type of robotic device or other computer-controlled device with a form of locomotion. The mobile robotic agent 1110 may include additional sensor systems and navigational control systems to facilitate moving through the environment. In one variation, the system (more specifically an agent management system 1400) supplies agent path directions, and that is used in combination with an obstacle avoidance system and/or other subsystems of the robotic agent 1110 to navigate through the environment with the objective of following the agent path directions while negotiating the immediate environment.

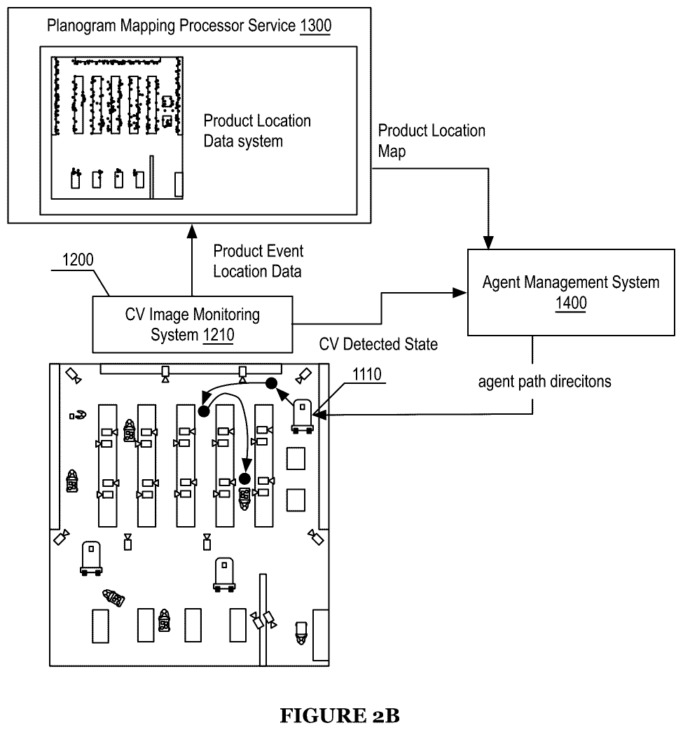

In a system variation used for providing navigation guidance to a user of a computing device, the system, as shown in FIG. 3, may include at least one user device agent 1120, a sensor-based monitoring system 1200, a planogram mapping processor service 1300, and an agent management system 1400.

In a system variation used for a user device agent 1120 that may be used by a human user navigating the environment, the user device agent 1120 may be customized to the particular application. The user device agent 1120 may be an application or digital service provided through the computing device. In the use case where the user device agent 1120 is used to provide product picking instructions, the user device agent 1120 may be or include a picker interface. When used for order fulfilling the system may additionally include an order interface 1500.

A CV monitoring system 1210 of a preferred embodiment functions to transform image data collected within the environment into observations relating in some way to items in the environment. Preferably, the CV monitoring system 1210 is used for detecting items, monitoring users, tracking user-item interactions, and/or making other conclusions based on image and/or sensor data. The CV monitoring system 1210 will preferably include various computing elements used in processing image data collected by an imaging system. In particular, the CV monitoring system 1210 will preferably include an imaging system and a set of modeling processes and/or other processes to facilitate analysis of user actions, item state, and/or other properties of the environment.

The CV monitoring system 1210 is preferably configured to facilitate identifying of items and detection of interactions associated with identified items.

The CV monitoring system 1210 preferably provides specific functionality that may be varied and customized for a variety of applications. In addition to item identification, the CV monitoring system 1210 may additionally facilitate operations related to person identification, virtual cart generation, item interaction tracking, store mapping, and/or other CV-based observations. Preferably, the CV monitoring system 1210 can at least partially provide: person detection; person identification; person tracking; object detection; object classification; object tracking; gesture, event, or interaction detection; detection of a set of customer-item interactions, and/or other forms of information.

In one preferred embodiment, the system can use a CV monitoring system 1210 and processing system such as the one described in the published US Patent Application 2017/0323376 filed on May 9, 2017, which is hereby incorporated in its entirety by this reference. The CV monitoring system 1210 will preferably include various computing elements used in processing image data collected by an imaging system.

The imaging system functions to collect image data within the environment. The imaging system preferably includes a set of image capture devices. The imaging system might collect some combination of visual, infrared, depth-based, lidar, radar, sonar, and/or other types of image data. The imaging system is preferably positioned at a range of distinct vantage points. However, in one variation, the imaging system may include only a single image capture device. In one example, a small environment may only require a single camera to monitor a shelf of purchasable items. The image data is preferably video but can alternatively be a set of periodic static images. In one implementation, the imaging system may collect image data from existing surveillance or video systems. The image capture devices may be permanently situated in fixed locations. Alternatively, some or all may be moved, panned, zoomed, or carried throughout the facility to acquire more varied perspective views. In one variation, a subset of imaging devices can be mobile cameras (e.g., wearable cameras or cameras of personal computing devices). For example, in one implementation, the system could operate partially or entirely using personal imaging devices worn by users in the environment (e.g., workers or customers).

The imaging system preferably includes a set of static image devices mounted with an aerial view from the ceiling or overhead. The aerial view imaging devices preferably provide image data that observes at least the users in locations where they would interact with items. Preferably, the image data includes images of the items and users (e.g., customers or workers). While the system (and method) is described herein as they would be used to perform CV as it relates to a particular item and/or user, the system and method can preferably perform such functionality in parallel across multiple users and multiple locations in the environment. Therefore, the image data may collect image data that captures multiple items with simultaneous overlapping events. The imaging system is preferably installed such that the image data covers the area of interest within the environment.

Herein, ubiquitous monitoring (or more specifically ubiquitous video monitoring) characterizes pervasive sensor monitoring across regions of interest in an environment. Ubiquitous monitoring will generally have a large coverage area that is preferably substantially continuous across the monitored portion of the environment. However, discontinuities of a region may be supported. Additionally, monitoring may monitor with a substantially uniform data resolution or at least with a resolution above a set threshold. In some variations, a CV monitoring system 1210 may have an imaging system with only partial coverage within the environment.

In some variations, the imaging system may be used for only a particular region in the environment. For example, if a limited set of products is subject to product marketing analysis, the imaging system may include imaging devices that are oriented with fields of view covering the set of products. For example, one implementation of the system may include a single camera mounted so that the field of view of the camera captures the shelf space and surrounding area of one type of cereal.

A CV-based processing engine and data pipeline preferably manages the collected image data and facilitates processing of the image data to establish various conclusions. The various CV-based processing modules are preferably used in detecting products, detecting product presentation variations, generating user-item interaction events, capturing a recorded history of user actions and behavior, and/or collecting other information within the environment. The data processing engine can reside local to the imaging system or capture devices and/or an environment. The data processing engine may alternatively operate remotely in part or whole in a cloud-based computing platform.

The CV-based processing engine may use a variety of techniques. In some instances, one or more CV models may be used to process image data to yield a characterizing result which could be an identifier, classification, imaged mask, and the like. At least for different models used for classification, detection and/o identification, a CV model may apply classification technique such as a “bag of features” approach, convolutional neural networks (CNN), statistical machine learning, or other suitable approaches. Neural networks or CNNS such as Fast regional-CNN (r-CNN), Faster R-CNN, Mask R-CNN, and/or other neural network variations and implementations can be executed as computer vision driven object classification processes.

The item detection module of a preferred embodiment, functions to detect and apply an identifier to an object. The item detection module preferably performs a combination of object detection, segmentation, classification, and/or identification. This is preferably used in identifying products or items displayed in a store. Preferably, a product can be classified and associated with a product identifier such as a Stock Keeping Unit (SKU) identifier, a Universal Product Code (UPC), or other suitable type of product identifier. In some cases, a product may be classified as a general type of product. For example, a carton of milk may be labeled as milk without specifically identifying the SKU of that particular carton of milk. An object tracking module could similarly be used to track items through the store.

As described below, the item detection module may additionally be used to detect product packaging and presentation variations. In one implementation, the item detection module may be preconfigured to detect product packaging variations as distinct items, which are then modeled as being product variations. In another implementation, the item detection module or a related system can facilitate detecting a product identifier of an item and then classifying the item as a product packaging variation. Other suitable classifier or processing modules may additionally be used such as image data comparison/matching, text extraction, and the like.

In a successfully trained scenario, the item detection module properly identifies a product observed in the image data as being associated with a particular product identifier. In that case, the CV monitoring system 1210 and/or other system elements can proceed with normal processing of the item information. In an unsuccessful scenario (i.e., an exception scenario), the item detection module fails to fully identify a product observed in the image data. An exception may be caused by an inability to identify an object but could also be other scenarios such as identifying at least two potential identifiers for an item with sufficiently close accuracy, identifying an item with a confidence below a certain threshold, and/or any suitable condition whereby a remote item labeling task could be beneficial. In this case the relevant image data is preferably marked for labeling and/or transferred a product mapping tool for human assisted identification.

The item detection module in some variations may be integrated into a real-time inventory system. The real-time inventory system functions to detect or establish the location of inventory/products in the environment. The real-time inventory system can manage data relating to higher level inventory states within the environment. For example, the inventory system can manage a location/position item map, which could be in the form of a planogram. The inventory system can preferably be queried to collect contextual information of an unidentified item such as nearby items, historical records of items previously in that location, and/or other information. Additionally, the inventory system can manage inventory data across multiple environments, which can be used to provide additional insights into an item. For example, the items nearby and/or adjacent to an unidentified item may be used in automatically selecting a shortened list of items used within the product mapping tool.

User-item interaction processing modules function to detect or classify scenarios of users interacting with an item (or performing some gesture interaction in general). User-item interaction processing modules may be configured to detect particular interactions through other processing modules. For example, tracking the relative position of a user and item can be used to trigger events when a user is in proximity to an item but then starts to move away. Specialized user-item interaction processing modules may classify particular interactions such as detecting item grabbing or detecting item placement in a cart. User-item interaction detection may be used as one potential trigger for an item detection module.

A person detection and/or tracking module functions to detect people and track them through the environment.

A person identification module can be a similar module that may be used to uniquely identify a person. This can use biometric identification. Alternatively, the person identification module may use Bluetooth beaconing, computing device signature detection, computing device location tracking, and/or other techniques to facilitate the identification of a person. Identifying a person preferably enable customer history, settings, and preferences to be associated with a person. A person identification module may additionally be used in detecting an associated user record or account. In the case where a user record or account is associated or otherwise linked with an application instance or a communication endpoint (e.g., a messaging username or a phone number), then the system could communicate with the user through a personal communication channel (e.g., within an app or through text messages).

A gesture, event, or interaction detection modules function to detect various scenarios involving a customer. One preferred type of interaction detection could be a customer attention tracking module that functions to detect and interpret customer attention. This is preferably used to detect if, and optionally where, a customer directs attention. This can be used to detect if a customer glanced in the direction of an item or even if the item was specifically viewed. A location property that identifies a focus, point, or region of the interaction may be associated with a gesture or interaction. The location property is preferably 3D or shelf location “receiving” the interaction. An environment location property on the other hand may identify the position in the environment where a user or agent performed the gesture or interaction.

Alternative forms of CV-based processing modules may additionally be used such as customer sentiment analysis, clothing analysis, customer grouping detection (e.g., detecting families, couples, friends, or other groups of customers that are visiting the store as a group), and/or the like. The system may include a number of subsystems that provide higher-level analysis of the image data and/or provide other environmental information such as a real-time virtual cart system.

The system may additionally or alternatively include other sensing systems to augment a CV monitoring system 1210 or to be used in place of the CV monitoring system 1210. For example, smart shelves with proximity and/or weight sensors, RFID tracking systems, and/or other inventory tracking solutions.

The planogram mapping processor service 1300 functions to generate a product location map (e.g., a planogram). The product location map can indicate where in the environment particular items are located. This can be used to indicate where a product is stocked on a shelf in a store. The resolution of the product location map can vary depending on implementation.

The CV monitoring system 1210 is preferably used in creating a digital planogram or product location map. The product location map can be a continuously update data model relating inventory labels to locations in the store.

In some variations, the product location map can be a data model tracking and/or predicting individual inventory items and associations with locations.

In some variations, the product location map can be a data model tracking and/or predicting counts of inventory types and associations with a location.

As discussed herein the planogram mapping processor service 1300 may be configured to use product identifier data output from one or more product scanning devices. This verified product identification data can be associated with a location, and then the item (or an item associated object) may be associated back to a location in the environment. Different variations of such an approach are described herein.

In a variation for order fulfillment, the system may include an order interface 1500. The order interface 1500 functions to provide a digital interface for collection and management of order data. In one preferred variation, the order interface 1500 uses an online ordering system that collects online orders from customer client devices. The collected online order can then be stored, communicated, and/or assigned to agents in cooperation with the agent management system. In some implementations, the order interface 1500 can oversee an order from ordering to completion.

Other alternative systems may be used to supply lists of items or otherwise set waypoints within a store for navigation.

The order interface 1500 may include a client user interface accessible through a native application or a web application. Customers can select items, compile an order, and then place (or commit) the order. In some cases, this can involve completion of a digital transaction.

The order interface 1500 may include a data interface to order details which can be used for enabling the agent management system 1400 to integrate with the order interface 1500.

The order interface 1500 may additionally include a messaging interface which may enable communication with customer participants. The messaging interface may be a computer system configured for communication in-app or over another communication channel such as phone or messaging (e.g., SMS, MMS, third-party over-the-top messaging channels, or other messaging channel).

The agent management system 1500 functions to be a computing system configured for using the product location map in connection with order data and agent data for calculating enhanced order fulfillment instructions, communicating instructions, and/or managing digital interactions related to fulfillment and updating instructions. The agent management system 1400 as described in the method below may use a path planning module (using traveling salesperson problem models for determining how to improve picking products.

The Picker interface functions as an agent client with a user interface updated in coordination with instructions from the agent management system. The picker interface is a user interface of one or more mediums used in communicating requests, instructions, status, and/or other data related to order fulfillment.

The picker interface may include one or more of a graphical user interface component, an auditory user interface component, a tactile user interface component. A graphical user interface may be user interface of a phone, watch, tablet, heads-up display, computer, or other suitable type of device.

In one variation, the picker interface is an augmented reality (AR) user interface. The AR user interface may be worn or through handheld mobile computing device (e.g., camera-enabled digital camera application)

Additionally or alternatively, the picker interface can include an auditory user interface. For example, the system may be used to provide spoken instructions (using text-to-speech (TTS) instruction conversion) and/or audio cues for directing movement through a store and picking of items. Additionally or alternatively, the picker interface can include a haptic/tactile user interface output.

### 2. Method

A method for actively directing customers can use one or more mediums for dynamically providing feedback to a user to steer them to a particular item location.

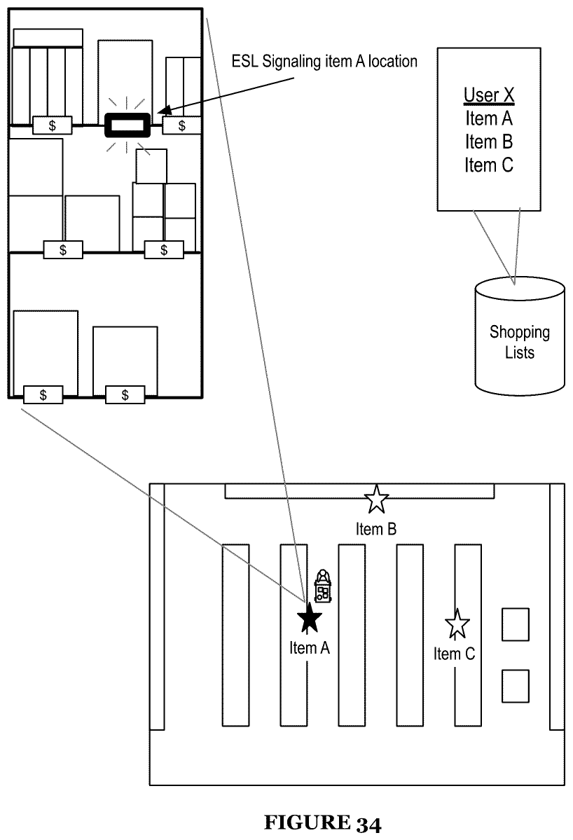

As shown in FIG. 35, the method for actively directing users to items in an environment can include dynamically modifying state of the feedback device for a set of targeted items. This functions to change the state of a feedback device. This will generally involve modifying state of at least one feedback device from a set of feedback devices, and the feedback devices may have state modified as a mechanism to provide guidance to a user such as to draw the attention of a user to a particular location near an item of interest or possibly to provide environment navigation guidance or instructions for a user.

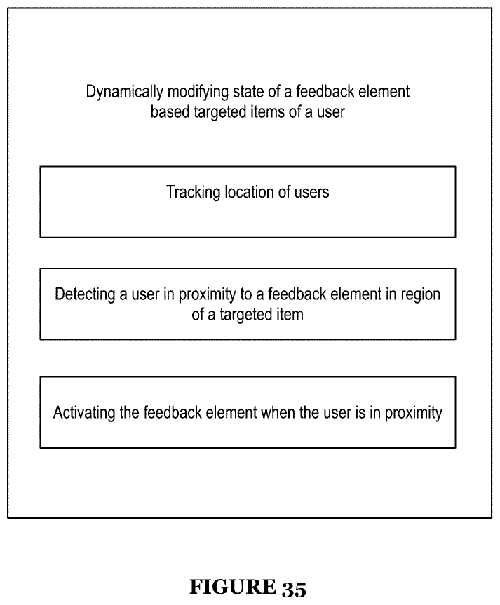

The method for actively directing customers is preferably based on items associated with specific users. Accordingly, in some variations as shown in FIG. 36, the method can include accessing item data of a user at an environment Silo; and modifying state of a subset of feedback devices S130 based on the item data, wherein the subset of feedback devices is part of a set of feedback devices distributed within the environment. In some variations, the method may include using user location as an additional factor in how state of the feedback devices is modified.

However, in some variations, the method may be implemented without use or dependence on user location tracking or other forms of location information. For example, feedback devices could have their state changed for a set time or until some other event occurs (e.g., the user completes a shopping session, or the item is marked as picked up).

In some variations, this may be performed independent of the position of the user. In some such variations, feedback devices could have their state changed for a set time or until some other event occurs (e.g., the user completes a shopping session, or the item is marked as picked up). For example, when a user enters a store, the relevant feedback devices may have their states activated to serve as a signal to the user during their shopping visit.

As mentioned, in some variations, dynamically modifying state of the feedback device for a set of targeted items includes dynamically modifying state of the feedback device based on relative position of a user and a targeted item. This may function to adjust the state at least partially in response to how a user is moving through an environment. This dynamic modification of state can include tracking locations of users; detecting a user in proximity to a feedback device in region of a targeted item; and activating the feedback device. This method can be performed when there is one or more targeted items determined for a particular user. In one variation, one or more targeted items could be based on a shopping list or from some other data source.

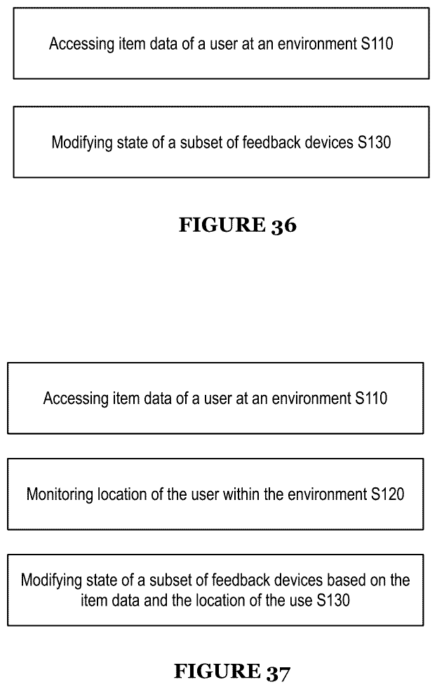

As shown in FIG. 37, such a method variation may include accessing item data of a user at an environment Silo; at a sensor-based monitoring system, monitoring location of the user within the environment S120; and modifying state of a subset of feedback devices S130 based on the item data and the location of the user, wherein the subset of feedback devices are part of a set of feedback devices distributed within the environment.

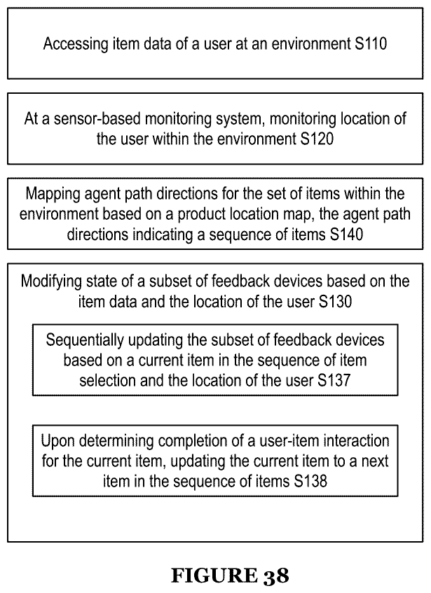

The method for actively directing a user to items in an environment may additionally use reactive route planning. Routes may be updated and determined based on a sensor-based planogram that can have substantially real-time conditions of item (e.g., product) locations in a retail environment. As shown in FIG. 38, a method variation directing a user to items in environment with dynamic routing may include: accessing item data of a user at an environment Silo; at a sensor-based monitoring system, monitoring location of the user within the environment S120; mapping agent path directions for the set of items within the environment based on a product location map S140, the agent path directions indicating a sequence of items; and modifying state of a subset of feedback devices S130 based on the item data and the location of the user, which comprises, sequentially updating the subset of feedback devices based on a current item in the sequence of item selection and the location of the user S137, and upon determining completion of a user-item interaction for the current item, updating the current item to a next item in the sequence of items S138.

The method may be implemented in a variety of ways. As discussed herein the method may use one or more different types of feedback devices, ways of delivering feedback, how the feedback is used (e.g., indicating a product location on a shelf, indicating an aisle for the user to visit, indicating a direction to turn, etc.), integrate with an item data source for different use cases, provide different forms of environment route navigation features, and/or other variations.

The methods described herein are primarily described in the context of a single user. However, the methods may more preferably be implemented as parallel processes such that feedback devices are being updated for multiple users in an environment. For example, a grocery store may have multiple workers picking up orders for delivery and multiple shoppers picking up items from their shopping list. Each of these workers may have feedback devices being updated so as to provide appropriate guidance.

The method is preferably implemented in connection with a system such as described herein that includes a set of feedback devices distributed within an environment. In some variation, the method may be implemented by a system that additionally includes a sensor-based monitoring system such as a computer vision monitoring system and/or other sensor-based monitoring subsystems. Accordingly, the method may include providing a set of feedback devices distributed within the environment and a sensor-based monitoring system. The sensor-based monitoring system can have monitoring coverage within the environment. The set of feedback devices are preferably positioned to have distribution overlapping with coverage of the sensor-based monitoring system. Other system components may similarly be provided or otherwise established in the environment.

Block S110, which includes accessing item data of a user at an environment, functions to identify at least one item of potential interest to a user. The item data will generally include a set of one or more items (e.g., products) with which the user may want to interact with while in the environment.

The set of items, in some variations, may be from a shopping list. Accordingly, accessing item data of the user at the environment Sino may include accessing a shopping list with a set of items.

In one such variation, the shopping list is user generated within a digital platform. For example, a user may create a shopping list on a shopping application. Alternatively, a shopping list may be at least partially generated for a user on a shopping application.

In another variation, the shopping list may originate from a digital order. The user that is provided guidance for locating the items of the digital order may or may not be the same as the person who made the digital order. In some instances, the shopping list may be for a worker that is assisting in fulfilling the digital order. For example, an end customer may order items from a digital store user interface, this generates a digital order with shopping list information. A worker (someone serving as the picker) may be assigned for fulfilling the digital order, in which case the worker is the user that benefit from the guidance offered through the method. In some cases, a worker may be selecting items for multiple different digital orders in which case, the shopping list for this worker would be a compiled list of items from multiple digital orders. Such digital order fulfillment may be particularly helpful for order-delivery services that may enable ordering groceries that can be home delivered or for in-store pickup services where a worker gathers items and then a customer can pick up their purchase at some convenient location in the store. Since workers may have less familiarity with the items in the shopping list, the method may particularly help guide the worker to reduce the time to gather the set of items for an order.

Accessing the item data may be in response to an action and/or detected state of the user. In one variation, the method may include tracking location of the user beyond the primary environment (e.g., the retail environment) and when the user enters or comes within some distance threshold (e.g., within 0-500 feet), requesting or receiving at least one item of the set of items for the user. In another variation, the method may include receiving a triggered event indicating one or more item that a user is now wishing to locate and/or navigate to. In some such variations, a user may take some action with a user application, and this can lead to receiving at least data one at least one item associated with the user. For example, a user, upon starting a shopping visit, may select an option to check-in and start their shopping visit, this may result in sending an item or items from a shopping list for that visit. In another example, a user may manually select an item from their app to which they wish to navigate. This can cause the system to trigger operations to facilitate guiding the user to that selected item using the feedback devices.

Block S120, which includes monitoring location of the user within the environment, functions to track or otherwise determine where the user is located. Monitoring location of the user may provide location information of the user in a substantially uniform way throughout the environment. Alternatively, monitoring location of the user may provide location information in just regions of interest. For example, location of the user may not be actively tracked or monitored in some regions.

Monitoring location of the user is preferably performed at a sensor-based monitoring system. The sensor-based monitoring system may track location using a computer vision (CV) monitoring system but may alternatively use some additional or alternative location tracking system such as GPS, differential GPS, WiFi/RF triangulation, BLE, magnetic or gravity fingerprints, accelerometers/IMUs, user-device cameras, and/or other location tracking techniques.

Monitoring location of the user preferably provides resolution or capabilities to detect location of the user at least when in proximity to relevant feedback devices. Detecting a user in proximity to a feedback device in region of a targeted item, functions to determine when state should be changed. This can be used so that feedback devices are not changed until the relevant user is an appropriate location in the environment (e.g., the store). For example, digital price tags serving as the feedback devices may update when a user get in the appropriate section of a grocery store aisle.

In some variations, the sensor-based monitoring system (in particular, the CV monitoring system) may additionally detect direction of attention of the user. This may be used so that feedback devices may be updated based on which feedback devices are in a field of view of user.

As discussed, there are some variations that may not depend on detecting proximity. Such variations may use alternative mechanisms to determine when and how to change state or revert state of a feedback device. For example, a shopping visit event may activate the feedback devices, and a checkout event may deactivate the feedback devices for the user.

Block S130, which includes modifying state of a subset of feedback devices, functions to dynamically update outputs of one or more feedback devices to provide suitable context and potentially help direct a user towards a targeted item.

Modifying state of the subset of feedback devices can include activating, deactivating, changing an output of the feedback device, or otherwise changing the state of a feedback device. Activating the feedback device could include changing the color of a display, displaying a message or graphic on a display, activating a light beacon (e.g., an LED), updating a graphical display (e.g., adding a user identifier like their name to an ESL), playing an audio signal. Activating may be used to generally describing setting the feedback device to a state intended to signal to a user or other type of agent.

Activating a feedback device may additionally be used to communicate relevant information for that user. For an order delivery worker, the feedback device could be updated to communicate the number of an item to select. For example, the ESL could be updated to display instructions to pick three items of a particular variety.

Feedback devices may additionally be deactivated or otherwise set back to a state where it is not intended to draw attention or actively signal to a user or agent. In some variations, the state of a feedback device may be reset when not being used to signal to a user or agent. The state of a feedback device could be reset in a variety of ways. In one variation, the state could be reset after detecting the user selecting the associated item. In an alternative variation, state of a feedback device may be updated and/or reset based on predicted time when a user would need the signal. For example, an ESL may not flash until a time when the user is predicted to be in that section of the store. In another example, the ESL may turn of after some time duration or a predicted time needed to complete the item selection.

Modifying state of a subset of feedback devices may be based on the item data. In some cases, feedback devices may be updated after accessing item data of a user. For example, when a user is initiating a shopping visit, feedback devices may be activated to mark items on the shopping list of the user. When the method is used for multiple users simultaneously, there may be multiple different feedback devices that are activating. User-specific signals may be used so that a user can differentiate. However, other solutions may alternatively be used.

In another method variation, upon a user starting a new shopping session, items from a digital shopping list could be used for updating the state of feedback devices. The feedback devices may be used during the shopping session as a static marker of items on the shopping list. This can function to use the feedback devices as feedback tools without needing to dynamically activate the feedback devices in real-time. All feedback devices associated with items of a shopping list could be activated when the user starts shopping. When the method is used for multiple users simultaneously, there may be multiple different feedback devices that are activating. User-specific signals may be used so that a user can differentiate. However, other solutions may alternatively be used. For example, ESLs may be updated with a blue marker to signal to user A and a red marker for user B. The feedback devices may be deactivated after some other condition (e.g., after some delay or when the user checks out).

In some variations, the location of the user may be used such that modifying state of a subset of feedback devices S130 may be based on the item data and the location of the user. This may function to make feedback devices change their state in response to user location or proximity. More specifically, the user proximity to a feedback device and optionally the detected direction of attention may be used to dynamically change the state of the feedback device. In other words, the feedback devices may be activated when a user comes within some proximity threshold. In another variation, the approximate distance to the item could change how a feedback device changes. State changes may additionally be conditional on other factors such as other detected users in the region, and if any of other nearby users have targeted items.

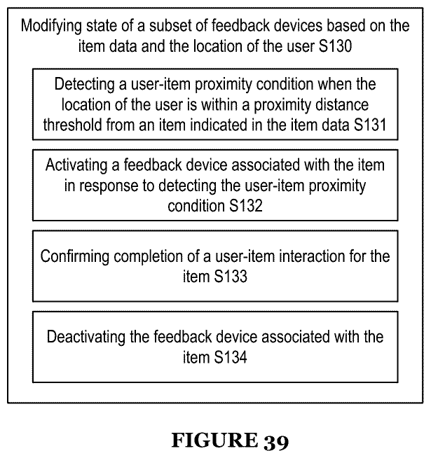

Accordingly, in one variation shown in FIG. 39, modifying state of a subset of feedback devices based on the item data and the location of the user may include: detecting a user-item proximity condition when the location of the user is within a proximity distance threshold from an item indicated in the item data S131, and activating a feedback device associated with the item in response to detecting the user-item proximity condition S132. The user-item proximity condition could be based on being within some distance threshold. In some variations, the user-item proximity condition may include or set one or more properties. One property could be a user-item distance measurement. Another property could be user-item attention measurement, which is a property that relates to if the item is in the field of view of the user or some other indicator of a user's attention. Detecting the user-item proximity condition accordingly may include measuring distance from the user location to an item. The location of the item may be based on a planogram or some other data source. The method may include modeling location of items within the environment, accessing a planogram, or otherwise determining location of the items (e.g., products in the environment). A method for dynamically determining a planogram or product location map is described herein.

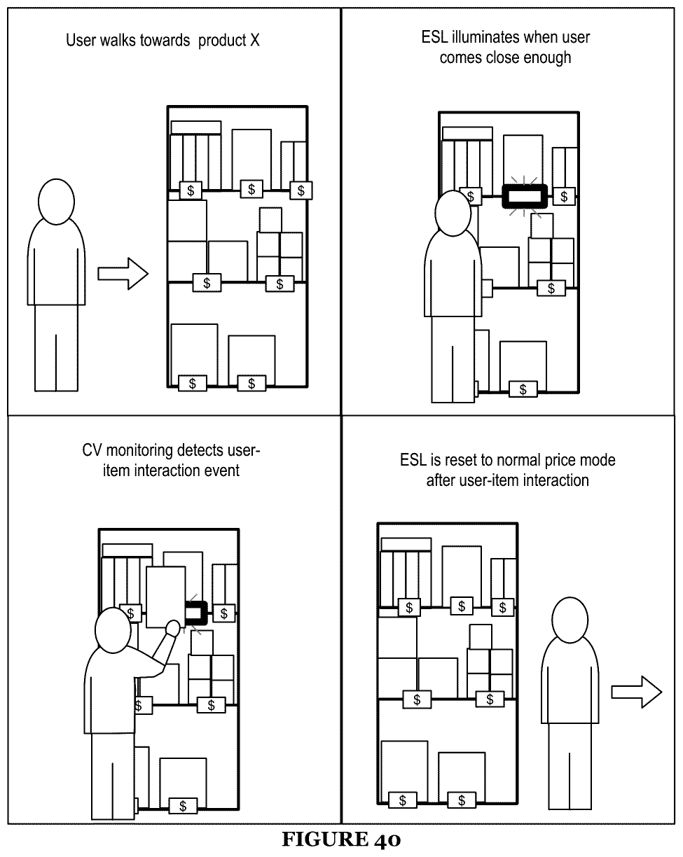

The feedback devices may deactivate or reset in a variety of ways. One variation deactivates or resets the feedback devices in response to a user completing some interaction. Accordingly, as shown in FIG. 39 modifying state of a subset of feedback devices based on the item data and the location of the user may include: detecting a user-item proximity condition when the location of the user is within a proximity distance threshold from an item indicated in the item data S131, activating a feedback device associated with the item in response to detecting the user-item proximity condition S132, confirming completion of a user-item interaction for the item S133, and deactivating the feedback device associated with the item S134. For example, as shown in FIG. 40, as a user walks down an aisle, a feedback device may initially be deactive; when the user comes within some proximity distance threshold; an appropriate feedback device can illuminate; the user picking up the item may be detected; and then, having completed the user-item interaction and moving away, the feedback device deactivates and returns to being an ESL in a default mode.

Confirming completion of a user-item interaction for the item may include receiving a trigger event indicating completion of a task associated with the item. For example, a user may use an app on a personal computing device to mark or otherwise indicate they are done with an item (e.g., because they have picked up the item or possibly because they no longer need it). When the app is managing a shopping list, this may result in progressing to the next item and the feedback devices may have state modified to assist directing the user to this new item.

Confirming completion of a user-item interaction for the item may alternatively include, using the sensor-based monitoring system, detecting completion of the user-item interaction. For example, a CV monitoring system may process image data and detect the user selecting the item for purchase. This interaction may indicate the user has completed some interaction with the item, thus the feedback device is no longer needed for that item.

Other processes may alternatively be used to confirm completion. In some variation, feedback devices may deactivate as the user according to user-item proximity condition. For example, an LED may grow brighter and/or start flashing as a user approaches and then dim and/or stop flashing as the user moves away.

The set of feedback devices preferably includes a plurality of feedback devices that is distributed across distinct item storage locations. This may form an array of feedback devices. In one exemplary implementation, a feedback device may be positioned at each stocking location of shelving down in an environment, which may enable signaling specific stocking locations. In another implementation, a feedback device may be positioned in each section of a shelf storage to mark sections, which may be used to signal general regions of a product.

The feedback devices may include one or more different types of feedback devices. The feedback may include a visual output and/or an audio output. In some variations, the feedback device may include an output medium detectable by another machine and not by a human such as an infrared output or a RF signal output.

The set of feedback devices may include a plurality of feedback devices with graphical displays. For such feedback device variations, modifying state of the subset of feedback devices can include altering display state of a graphical display of a feedback device in the subset of feedback devices. A feedback device with a display may display a graphical marker. The display may additionally or alternatively display a message. For example, the name or other type of identifier of the user may be displayed. The message may additionally include information like how many to select and/or what item or region is next for the user to pick up.

The set of feedback device may include a plurality of feedback devices with a visual beacon such as an LED or other illuminating element. Accordingly, modifying state of a subset of feedback devices may include altering illumination state of a visual beacon of a feedback device. A feedback device with an LED or other type of visual beacon may activate (e.g., turn on) in some manner as a way of drawing attention of a user or agent. A visual beacon may additionally or alternatively have its brightness adjusted, be pulsed, and/or have color changed as a controllable dimension for signaling information.

In another variation, the set of feedback devices includes a digitally controlled lighting system. The lighting system may be used to provide lighting during a default steady state. The lighting system may have the lighting change color, pulse or flash when in an active state. During a deactive state, the lighting system may default to a stable lighting state (which could be steady state on or off).

In another variation, the set of feedback devices includes a distributed speaker system. Multiple speakers or audio output devices may be distributed at different locations. Modifying the state of a feedback device that is an audio output device may involve playing an audio signal. The audio signal could be a sound effect. The audio signal in another variation could be speech or recorded audio. A message could be played to help a provide spoken directions to a user.

In one variation, the set of feedback devices includes a plurality of ESL feedback devices, which may be positioned on storage equipment (e.g., shelves, bins, etc.) adjacent to products in the environment. An ESL may alternatively be referred to as an electronic price tag, electronic product label, or some other electronic label or display. The ESL can include at least one visual output (e.g., a display and/or a visual beacon). Accordingly, modifying state of a subset of feedback devices may include altering visual state of the visual output of an ESL. The ESL may additionally or alternatively include an audio output or other types of outputs that may be used. The ESL feedback devices may be used primarily to display product information like name, and pricing information. An ESL could include an e-ink display or some other type of digital display.

An ESL device or any suitable network accessible device may include LEDs, graphical displays, an audio output, and/or device-to-device communication outputs. The ESL devices may be used by in a steady state as a mechanism for displaying pricing information for stocked items.

In another variation, the set of feedback devices could include a device with a device-to-device output. This could include an infrared light output or an electromagnetic signal output. These outputs may output a basic detectable signal, but may alternatively broadcast or output a signal conveying information.

The feedback devices are preferably associated with different locations in the environment. More specifically, the feedback devices may each be associated with different positions relative to items (e.g., products) in the environment. The location of products may be stored and/or modeled by a planogram or some other product location map. As described herein, a sensor-based monitoring system like a CV monitoring system may be used to generate and/or maintain a planogram.

In some variations, the locations of the feedback devices may be calibrated to a sensor-based monitoring system. Accordingly, the method may include calibrating locations of the set of feedback devices to detected locations of the sensor-based monitoring system. This may include iteratively modifying state of a feedback device, and detecting location of the feedback device through the sensor-based monitoring system. When the sensor-based monitoring system is a CV monitoring system, a feedback device with a visual output can be detected by processing image data of the CV monitoring system to detect the visual output. With the location of the feedback device calibrated to a location in the sensor-based monitoring system, the managing system can relate a detected user location to a location of an item.

In some variations, this may additionally calibrate a planogram. In the situation, where the feedback devices are ESLs then the location of the ESL may have strong correlation to a particular product type (e.g., SKU). Calibrating the ESLs with a CV monitoring system may function to indicate locations of products observed by the CV monitoring system.

The feedback devices, in one variation, may have state modified so as to draw attention to a specific location, the location of the feedback device and thereby a location of an item. For example, when a user wishes to buy a box of cereal, a feedback device near the box of cereal (e.g., an ESL for the box of cereal or a feedback device in the shelving section of the box of cereal) may activate to draw the attention of the user.

A feedback device, in another variation, may have state modified as a navigational cue. The feedback device may be updated not to signal a specific item location but as a way of guiding a user. For example, a feedback device near an end of an aisle may be used to signal if a user should visit that aisle (or not). In another example, a plurality of feedback devices may be updated in a coordinated sequence to create an animated sequence that guides a user. For example, a wave of illuminating LEDs may create wave of light moving in the direction of a targeted item.

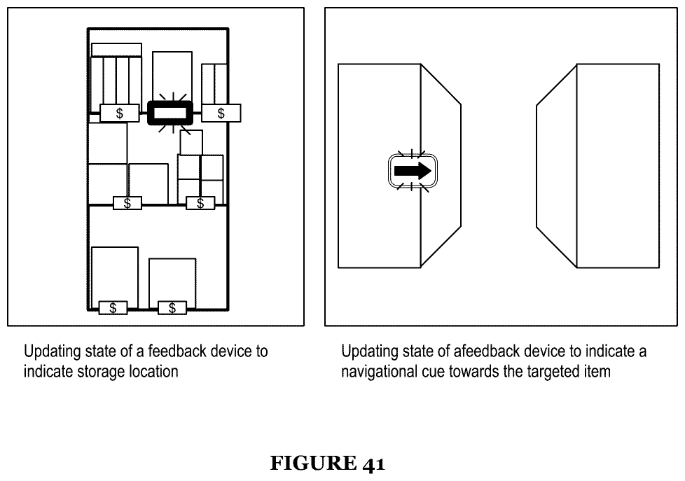

The feedback devices may be used in different ways within the same environment, with some used as navigational cues and others used to mark item locations. Accordingly, modifying state of a subset of feedback devices may include, as shown in FIG. 41, updating state of at least a first feedback device to indicate storage location of a targeted item from the item data, and updating state of at least a second feedback device to indicate a navigational cue towards the targeted item from the item data.

Modifying state of a subset of feedback devices (or modifying state of one feedback device) may be performed in a variety of ways which may depend on the type of feedback device and desired user experience. In some cases, the feedback device may have state changed such that there is a distinct difference between an active state or deactive state. Here an active state may be designed to attract attention for navigational purposes, and a deactive state may designed to not attract attention and/or to provide default functionality (operating as a digital price tag, providing normal lighting, serving as a store audio system).

Below are descriptions of possible ways of modifying state of a feedback device though one knowledgeable in the art would appreciate this is not exhaustive.

In one variation, a visual output of a feedback device can turn on and/or flash when in an active state to attract attention. The brightness, color, and/or pattern of flashing may be changed to indicate different information such as closeness to an item.

In another variation, a visual output of a feedback device may display a user-specific identifier. This may be a unique graphic, a username or identifier. This may alternatively be a message to communicate information in a textual manner.

In another variation, the feedback device may output a machine detectable code. A detectable code for a visual output may be detected by a camera or imaging system. For example, a camera on a personal computing device like a smart phone or headset may be able to detect the detectable code in the visual output. The detectable code may encode or otherwise convey information. The detectable code for an audio output may be broadcasted audio-based code. This may be layered with standard audio such that music played in the environment may have localized signals broadcast the detectable code in such a way that they are masked within the music but detectable by devices nearby. An audio-based detectable audio may alternatively be played in a frequency range outside of human hearing. Alternatively, a detectable code may be outputted by the feedback device using an output mode not detectable by humans such as using an RF-based communication medium.

In some cases, the feedback devices may have state modified between distinct states such as on and off states. In other variations, the feedback devices may have variable states that can vary across one or more dimensions.

In some variations, a feedback device may be modified and operated individually. For example, a single feedback device may be used to signal to a user where a particular product is located on a shelf.

In other variations, feedback devices may be modified and operated as a group. For example, multiple feedback devices may have state modified as a group to signal information to a user. Acting as a group may help make the changing state of the feedback devices easier to detect.

In one such variation, modifying a subset of feedback devices may include activating a sequence of feedback devices in a coordinated manner. This may be used to create animated effects across a plurality of feedback devices.

Spatial arrangement of the activation sequence may indicate directionality. For example, LED feedback devices arranged as a grid along the face of an aisle may turn on or off (or brighten/dim) in a coordinated manner. The lighted feedback devices may turn on and off in a wave like fashion towards a location of interest. This can include sequentially adjusting brightness of the LED feedback devices and timing to create an animation. This animation may be a directional animation if for example, a directive for the user is for the user to move in a particular direction (e.g., down an aisle towards some desired product). The animation may alternatively signal other information. For example, a radial animation may be used to signal that the user should halt because they are in the desired location (e.g., located within reach of a desired product). The animation of feedback devices may be adjusted based on presence and location of other users. Detected direction of attention of users may also be factored in. In particular, this may be used to generate feedback signals that are directed more at a targeted user and may avoid or mitigate how apparent such feedback signals are for other users.

Modifying state of a subset of feedback devices S130 may be used to provide guidance relevant to a single item or to potentially provide guidance relevant to multiple items.

When the method is used for providing guidance relevant to multiple items in the environment, the feedback devices may have state modified when the user is present in a location where they can observe the state of the feedback device. Though as discussed, some variations may not factor in location of a user. For a set of products, the method is at least partially iteratively processed such that a user can receive relevant guidance to locate a set of different items in an incremental fashion. For example, for a user with an associated shopping list, the method may incrementally provide guidance to items on the shopping list such that it first provides guidance to a first subset of items on the shopping list, then proceeds to provide guidance to a second subset of items on the shopping list. These subsets may be individual items or may, for example, be a number of items in close proximity. As discussed below, a recommended route may be generated, and a particular sequence of items may be provided such that the method iteratively cycles through the items to guide the user to items in an order based on the recommended route.

Herein, the method is primarily discussed as it could be used to provide human-detectable signals for a human user. This would help customers, order fulfillment workers, workers, and/or other users to more easily navigate and/or locate items in the environment. The method may alternatively be used with non-human agents or devices. For example, a mobile robotic agent may alternatively. The use of feedback devices may be particularly helpful in situations where the mobile robotic agent may not have access to item location data, but it would be helpful to be able to provide detectable cues to help one or more mobile robotic agents navigate a store and locate items. Feedback devices may additionally or alternatively generate signals that can be detected by other types of user devices such as mobile computing devices (e.g., phones, smart watches, etc.), spatial computing devices, smart headsets (e.g., Augmented Reality headsets, smart glasses, smart headphones, etc.). In this case dynamically modifying state of the feedback devices may be used to provide a detectable “layer” of information through the space of an environment that can be used to drive various user interactions on the computing device. In the case of a smart headset, the feedback devices may be updated to deliver infrared identifying signals or electromagnetic signals (e.g., nearfield RF broadcast), audio signals (e.g., outside of human-detectable frequency range), that can be transparently detected and used to trigger user interface events. For example, a user wearing a headset may have their shopping list used to cause relevant feedback devices to begin broadcasting a signal that can be detected by the headset, that when detected cause a navigational prompt to come up to indicate information like “Product X on this aisle” and/or “Product X is near by”.

In some variations, the method may additionally include processes to determine a recommended route for a given set of items. This route may be used to determine the sequence in which the feedback items have state modified. Accordingly, the method may include mapping agent path directions for the set of items within the environment based on a product location map S140, the agent path directions indicating a sequence of items; and wherein modifying state of a subset of feedback devices based on the item data and the location of the user further comprises sequentially updating the subset of feedback devices for a current item in the sequence of items, and upon determining completion of a user-item interaction for the current item, updating the current item to a next item in the sequence of items. Accordingly, the method may determine a route specified through the agent path directions that would facilitate navigating to each item in the set of items. Then based on a sequence in which the items are visited, the method will update the feedback devices to guide a user to the next item.

The agent path directions may be updated while navigating the store. Accordingly, the method may include updating the agent path directions in real-time based on the location of the user. The agent path directions may be updated or changed for various reasons such as a user deviating from the path, inventory state changes, congestion in the store. Accordingly, in one variation, updating the agent path directions in real-time based on the location of the user is further based on a change in inventory status of an item. In another variation, updating the agent path directions in real-time based on the location of the user is further based on detected user congestion. Other variations of generating and adjusting the agent path directions are discussed herein.

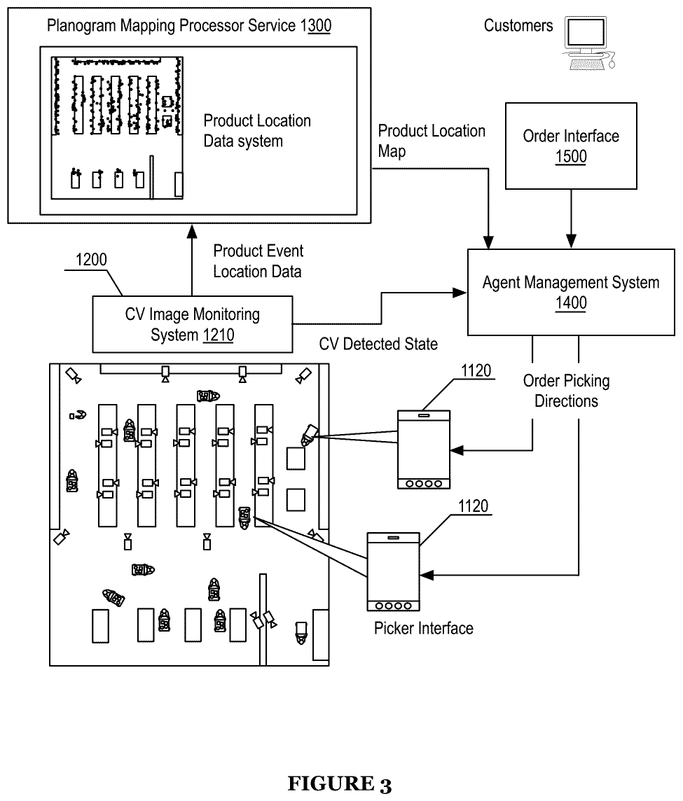

As shown in FIG. 4, a method for reactive route planning using a sensor-derived planogram can include generating, using a CV monitoring system, a product location map P110; mapping agent path directions for a set of waypoints within the environment based on the product location map P120; and updating a navigation system of an agent with the agent path directions P130. This method can function to generate a recommended path (e.g., path guidance) for the agent. The method can leverage a sensor-based and reactively updated planogram as a mechanism by which routes may efficiently be determined for tasks within item stocked environments. This may be particularly useful in retail environments where agents may be navigating to different waypoints (e.g., locations) that correspond to different product locations.

The method is preferably used to automate use of a sensor-based planogram with periodically or continuously updated product location data for use of enabling distinct digital interactions. The method can be used for enhancing efficiency of distributed order fulfillment but may additionally or alternatively be used in enabling unique interactions and capabilities to an order fulfillment system.

In particular, the method can have particular used in enabling digital tools used in situations where agents may have little to no familiarity with the items and/or environment in which they are working. This may make the system particularly useful as a digital solution for ordering systems that use personal shoppers that independently opt in to fulfilling one or more orders. In the case of robotic agents, the method may have particular utility in enabling deployment of robots that can more efficiently navigate the environment while other people are present.

In some variations a method for generating a planogram may be implemented in support of reactive route planning but may alternatively be used separately or independently in support for additional applications of a digital item mapping solution (e.g., for inventory systems, stocking systems, in support of tracking user interactions with products such as for automated checkout solutions).

Accordingly, the method may be adapted in various implementations to address different challenges. The processes and variation described herein may be used in combination or independently.

In one exemplary implementation, the method can include generating, using a CV monitoring system, a product location map (P110); mapping, using a graph traversal process for route planning, order picking directions based on planogram (P120); and updating remote agent client devices with order picking directions (P130). This implementation functions to implement traveling salesman problem solution processes (or other forms of graph modeling processes) in connection with a CV-based data.

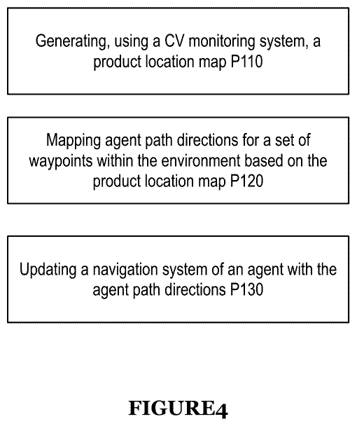

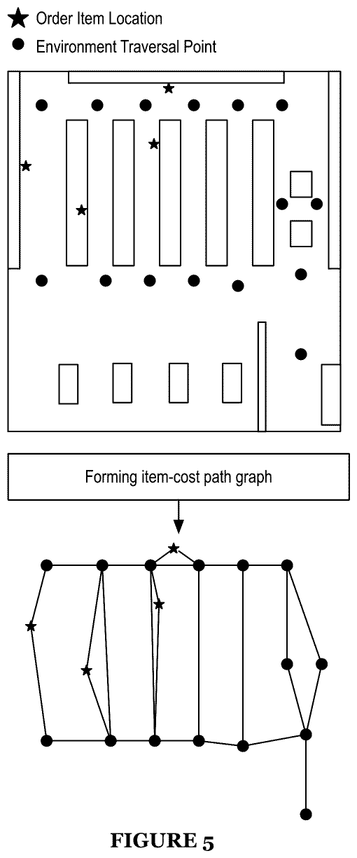

This implementation can include using real-time conditions and/or historical tracking so that calculation can be dynamic and reactive to store and/or conditions (e.g., the agent, how crowded store is, current placement options of products, physical locations of items, etc.). This implementation may include generating a graph with node-link mappings that can be based on physical location data, historical CV measured traversal speeds between nodes, detected or predicted congestion levels (used to augment link scores), detected performance of an agent (speed, instruction following performance, crowd navigation, etc.), and/or other detected aspects as shown in FIG. 5 and FIG. 6.

The method may be used in augmenting the navigation directions for one or more agents. The method can be used in providing at least partial navigational guidance to a mobile robotic agent. Such a mobile robotic agent could be a mobile robot such as a wheeled device, a leg-based/humanoid robot, flying robot (e.g., a drone), and/or other types of mobile devices with a form of locomotion to move through an environment. Such robots may be used for performing stocking tasks, cleaning tasks, scanning or monitoring an environment, item picking tasks, and/or other tasks.

The method may additionally or alternatively be used in providing navigational guidance to one or more user device agents used by a human user. Customers and/or workers may have a mobile computing device (e.g., a mobile phone, audio device, smart glasses, augmented reality headset, virtual reality headset, and the like) updated so that route related feedback can be provided to a user.

In some variations, guidance can be delivered to multiple robotic agents and/or user device agents within the environment. The variations described herein for the method may be used in any suitable combination. And examples for mobile robotic agents may similarly be used for user device agents.

In particular, the method can enable and/or use a dynamic planogram generated as a result of tracing product scanning identification events with predicted locations of products (using the CV monitoring system) and using the resulting planogram to form a waypoint graph usable for route planning.

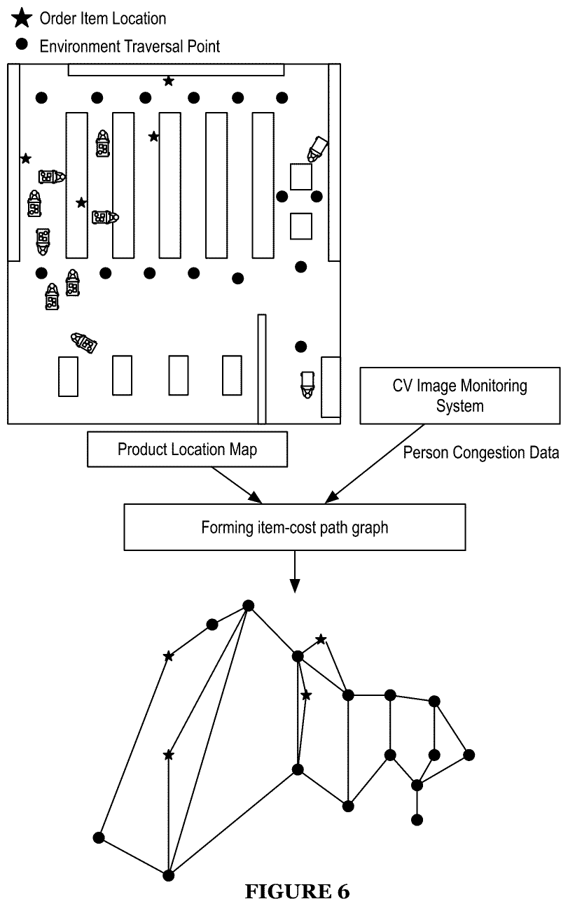

Accordingly, as shown in FIG. 7, an exemplary variation of the method can include generating, using a CV monitoring, a product location map of a plurality of items stocked in the item-stocked environment, by performing for a plurality of items merging product identifier data of an item with tracking, using the CV monitoring system, of the item to product stocking locations (the identifier data being collected from a set of product scanning events of product scanning devices) P110; mapping, using a graph traversal process for route planning, agent path directions based on product location map P1120, which includes: determining a waypoint graph for a set of waypoints based on the product location map P1121, and determining the agent path directions by performing a graph traversal process of the waypoint graph P1122; and updating navigation system of an agent with the agent path directions P1130.

The waypoints may be supplied from a variety of sources. The waypoints may originate from a work or task management system. In one example, an online order delivery service may generate a list of items to be picked by a worker so that the items can be delivered to an end customer. They may also be generated from a set of provided product identifiers. For example, a customer's shopping list entered within a digital application may be used to generate a recommended route.

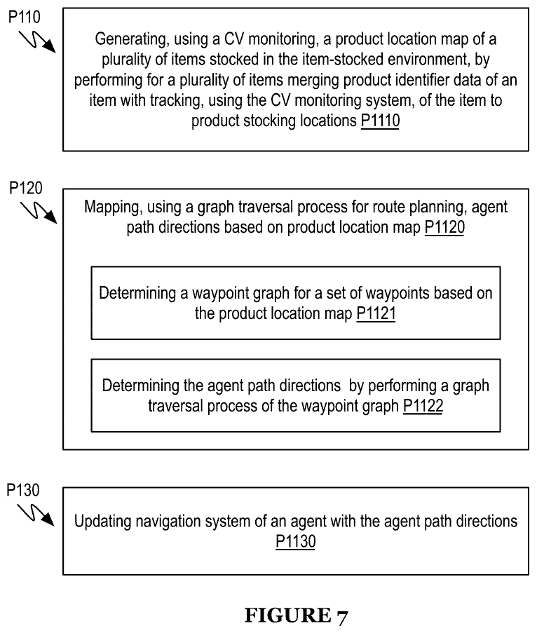

In an exemplary variation adapted for navigating a robotic agent within an item-stocked environment, the method can include, as shown in FIG. 8, generating, using a CV monitoring system, a product location map of a plurality of items stocked in the item-stocked environment, by performing for a plurality of items merging product identifier data of an item with tracking, using the CV monitoring system, of the item to product stocking locations P2110; receiving location of a mobile robotic agent and receiving one or more destination waypoint locations for the mobile robotic agent P2121; determining a waypoint graph for the set of waypoints based on the product location map P2122, and determining the agent path directions by performing a graph traversal process with the waypoint graph P2123; and updating a navigation system of the mobile robotic agent with the agent path directions P2130.

In some variations, the waypoints may be individual locations. The waypoints may be associated with specific locations of product identifiers, where the location of products is looked up and determined using the product location map. For example, a product picking or stocking robot may be assigned a task using a digital task management system to go to the locations of multiple products and perform some picking or stocking task (or any suitable task performed at the stocking location of a product). Those product locations can be used as the waypoints. In some variations, a waypoint may alternatively be defined as some region or section of the environment. A regional waypoint could be defined as some 2D surface region on the floor of the environment, a 2D or 3D surface or volume where products are stocked, and/or other regional descriptors. This may be used for mobile robotic agents that perform tasks over a region. A whole aisle of a grocery store, a section of a shelf, or whole section of a store may be set as a waypoint for a robot that performs a task. For example, a floor cleaning robot or a shelf sensing robot may have one or more waypoints to define sections of the environment where a task is performed.

A robot location may be detected using the CV monitoring system but may additionally or alternatively be detected using a positioning system of the robotic agent. For example, RF triangulation, GPS, beacon-based positioning, or other positioning systems may be used.

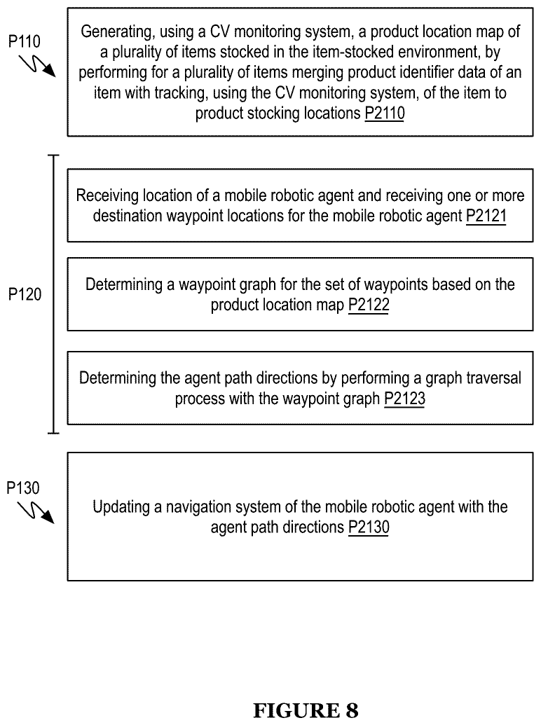

As shown in FIG. 9, a method for navigating a robotic agent within an item-stocked environment may additionally include navigating the mobile robotic agent based on the agent path directions and input from an obstacle avoidance system of the mobile robotic agent P2140. In some implementations, a mobile robotic agent may move fully under the guidance supplied by the agent path directions, but some variations, the robotic agent can follow the agent path directions while using dynamic, autonomous controls to avoid obstacles, dynamically navigate the local environment, and execute an enhanced path that generally follows the path directions. For example, the agent path directions can be generalized instructions to go down certain aisles or through certain regions of a store in a recommended sequence so that different waypoints can be visited in an efficient manner.

The method for navigating the robotic agent, accordingly, may include, at the mobile robotic agent, sensing nearby environment conditions with an onboard sensor system of the remote robotic agent, and navigating the nearby environment based on the nearby environment conditions. In this way, navigating the mobile robotic agent based on the agent path directions and input from an obstacle avoidance system of the mobile robotic agent is further based on the nearby environment conditions. Navigating may perform operations such as automatically steering around or avoiding obstacles, slowing down around certain objects (e.g., people, children, animals, other mobile robotic agents, etc.), stopping when a path is blocked, detecting and reporting when following the path directions are not feasible, locally detecting product locations (e.g., when within proximity to sense location of a product), and/or performing other sensing tasks.

An onboard sensor system can include a 2D or 3D imaging/camera system, ultrasound sensing system, proximity sensor system, a lidar system, structured light sensors, and the like. The CV monitoring system may supply some or all sensing data of the adjacent/nearby environment. In some variations, the robotic agents may follow detectable markers on the floor (e.g., graphical markers on the floor).

Some variations may include, when the robotic agent detects barriers or blocks in a path, or when conditions are different from reflected in the waypoint graph (e.g., floor is wet, high congestion or activity in a particular region), updating the waypoint graph with detected change in conditions around the robotic agent and updating the agent path directions using an updated waypoint graph.

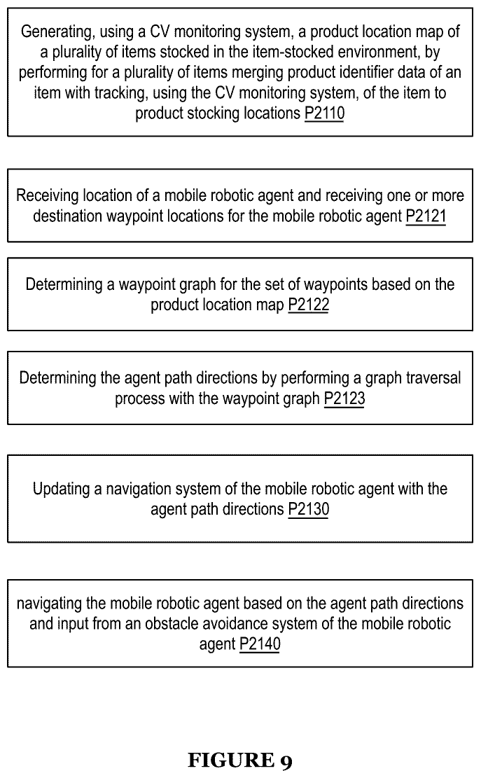

In an exemplary variation adapted for navigating a user device agent within an item-stocked environment, the method can include, as shown in FIG. 10, generating, using a CV monitoring system, a product location map of a plurality of items stocked in the item-stocked environment, by performing for a plurality of items merging product identifier data of an item with tracking, using the CV monitoring system, of the item to product stocking locations P3110; mapping, using a graph traversal process for route planning, agent path directions based on product location map P3120, which includes: detecting location of a user device agent P3121, receiving a set of product identifiers and determining a set of waypoints associated with locations of the product identifiers P3122, determining a waypoint graph for the set of waypoints based on the product location map P3123, and determining the agent path directions by performing a graph traversal process with the waypoint graph P3124; and updating the user device agent with the agent path directions P3130.

The locations used for the way points may be determined by searching, using a query or queries indicating the set of product identifiers, for product locations in the product location map.

The set of product identifiers may be based on products for which a user a user is looking for. The user could, for example, be a worker or a customer. The method could be used to help customers more efficiently navigate to one or more products of interest. For example, a shopping listed stored within an app on the phone of the customer may be used to create a recommended shopping path for the user. The method could alternatively be used to help workers better perform work tasks such as operational tasks like stocking, inventory counting, facing/tidying products, picking products for orders, and the like.

The recommended path could be optimized based for efficiency and to reflect the available inventory. As discussed herein the path could also recommended based on real-time conditions and/or historical patterns for navigating the store such as considering regions of congestion.

In one variation, updating the user device agent with the agent path directions may include updating a user interface output of the user device agent with real-time directions. This can include tracking the user and/or the user device agent and updating real-time directions with the next step of the agent path directions. If a user moves away from the agent path directions, updated real-time directions may update the user interface output with directions back to the intended path or trigger updating the agent path directions.

In another variation, updating the user device agent with the agent path directions may include tracking user-item interactions associated with the user device agent and then detecting when an interaction is completed for each waypoint. More specifically, the waypoints are product locations, and the variation may be used for detecting a product selection for a product in a shopping list, when a product is picked up this can be used to update the currently presented agent path direction. For example, a user may receive turn-by-turn directions to product A from a mobile computing device, when in proximity to the product, the CV monitoring system (and/or other sensor-based system) can detect the user picking up the item, and then the mobile computing device can be used to reflect that product A was picked up and then the turn-by-turn directions can be updated to a next product B. This can be repeated until all products are selected. In one variation, the waypoint graph and/or the agent path directions may be updated one or more times during the picking session. In one particular variation, the waypoint graph and then the agent path directions may be updated based on real-time conditions after a product waypoint is visited so that the next product waypoint and path to that next product waypoint can be enhanced.

In one variation, the method may be used to enhance digital order-delivery systems. As one variation, the set of products can be received from a digital delivery system. Thereby, a set of waypoints can be set based on products from one or more customer orders. In one variation, each customer order can be fulfilled by one picker (i.e., a user device agent used by a picker). In another variation, products from multiple orders can be fulfilled or partially fulfilled by a picker. Accordingly, the method can include: from a digital order-delivery system, receiving a set of items for an order; and setting the set of waypoints from locations determined for the set of products using the product location map.

In connection with a digital order system, the method include tracking order direction fulfillment of an agent. Tracking can be performed by using the CV monitoring system and/or other sensor-based monitoring system to detect user-item interactions (e.g., product pickup or put-back events). This can be used to automatically update an app of a picker to reflect the items selected for an order.

The method may additionally be used in detecting an out-of-stock condition based on the product location map and addressing the issue for the order. This can include proactively collecting alternative order input in response to this detected inventory status. For example, a customer making the order could select an alternative product, select an option to cancel the item order, and/or perform some other option.

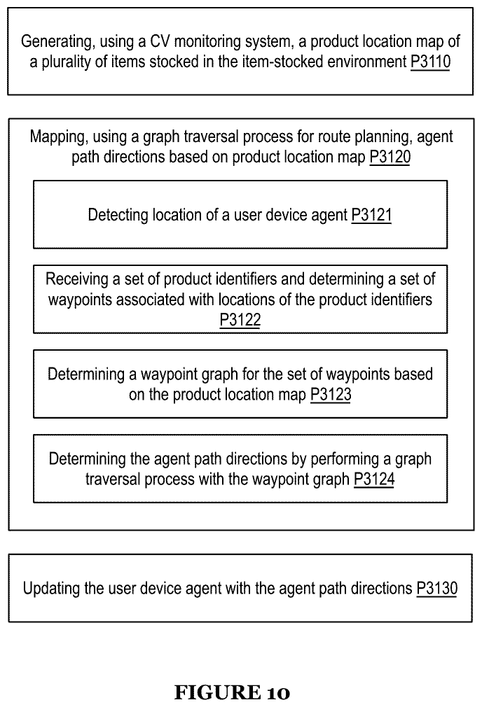

The method for reactive route planning can be used across a plurality of agents in an environment. In this way, multiple distinct agents can be supplied with customized agent path directions while simultaneously navigating an environment. Accordingly, an exemplary variation of the method, as shown in FIG. 11, can include generating, using a CV monitoring, a product location map of a plurality of items stocked in the item-stocked environment, by performing for a plurality of items merging product identifier data of an item with tracking, using the CV monitoring system, of the item to product stocking locations (the identifier data being collected from a set of product scanning events of product scanning devices) P4110; determining agent path directions for set of waypoint collections P4120, which can include, for each waypoint collection: mapping, using a graph traversal process for route planning, agent path directions based on product location map P4121; and for an agent assigned to each waypoint collection, updating a navigation system of an agent with the agent path directions of the agent's waypoint collection P4130.

A waypoint collection can be a set of waypoints. More specifically a waypoint collection can be a set of product locations based on a set of product identifiers. Each waypoint collection may be associated with one or more agent. For example, each customer may have a shopping list that is used to create agent path directions to navigate through each item on the shopping list.

In such a variation, mapping the agent path directions can include, for example, determining a waypoint graph for a set of waypoints based on the product location map, and determining the agent path directions by performing a graph traversal process of the waypoint graph.

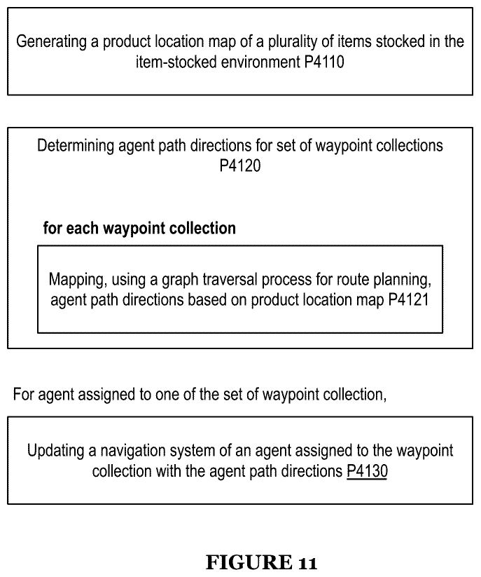

As discussed, the method may be used for both mobile robotic agents and user device agents. Accordingly, as shown in FIG. 12, the method may include: generating, using a CV monitoring system, a product location map of a plurality of items stocked in the item-stocked environment, by performing for a plurality of items merging product identifier data of an item with tracking, using the CV monitoring system, of the item to product stocking locations P5110; mapping, using a graph traversal process for route planning, a first set of agent path directions for a user device agent based on product location map P5120, which includes: detecting location of a user device agent S5121, receiving a first set of product identifiers and determining a first set of waypoints associated with locations of the product identifiers P5122, determining a first waypoint graph for the first set of waypoints based on the product location map P5123, and determining the first set of agent path directions by performing a graph traversal process with the first waypoint graph P5124; updating the user device agent with the agent path directions P5130; mapping, using the graph traversal process for route planning, a second set of agent path directions for a mobile robotic agent based on the product location map P5220, which includes: receiving location of the mobile robotic agent and a second set of waypoints for the mobile robotic agent P5221, determining a second waypoint graph for the second set of waypoints based on the product location map P5222, and determining the second set of agent path directions by performing a graph traversal process with the second waypoint graph P5223; and updating a navigation system of the mobile robotic agent with the second agent path directions P5230.

Generating the product location map of the plurality of items can, in one variation, be generated using a computer vision monitoring system. The computer vision monitoring system can be one such as described here. The computer vision monitoring system could include a plurality of imaging devices installed within the environment used to monitor activities of the environment (e.g., detect products/items, detected and/or track users, detect user-item interactions, and the like). In another variation, generating the product location map may use additional or alternative forms of sensor-based monitoring systems such as RFID (radio frequency identification) tag tracking systems, smart shelves (e.g., shelves using proximity sensors, integrated scales, touch sensors, and the like to detect shelf activities), and the like. Such sensor-based monitoring systems can be used in combination or in place of the computer-vision system.

Accordingly, in an exemplary variation of the method the CV monitoring system can include a plurality of imaging devices distributed across the item-stocked environment. Furthermore, generating a product placement map (and more specifically: for a plurality of items, merging product identifier data of an item with tracking of the item to product stocking locations) can include for each item of the plurality of items: determining an assigned product identifier code (using a product scanning device) of an item; detecting an identification location associated with assigning the product identifier code of the item at a time of the determining the assigned product identifier code, and associating the identification location with a product location based in part on the CV monitoring system.

Detecting the identification location may use the CV monitoring system or another sensor-based monitoring system to detect the location of the item or a product scanning device or some other element involved in determining the assigned product identifier code (e.g., a digital product label that outputs new product identifiers when updated).

Associating the identification location with a product location based in part on the CV monitoring system can include tracking the item (directly or indirectly) from the identification location to the product location. Directly tracking can include tracking the item or a person/container in possession of the item. Indirectly tracking may include spatially associating the location to another location (e.g., assuming the product ID output from scanning of a product label is associated with a shelf location directly above that product label).

The merging of product identifier data may come through data integration with the data output of some operational process such as routine and commonly performed tasks within a store like scanning products during at a checkout kiosk, scanning items during stocking, scanning items during price label updates, and/or during other tasks.

Described in another way, the product location map may be generated by generating item event location data through the CV monitoring system, collecting operational data with item identifier information, processing the operational data and establishing a candidate item location dataset using item event location data associated with the operational data, and translating the candidate product location dataset into a product location map. Other variations for generating or determining a product location map are described herein.

Exemplary variations of the method may include one or more different types of product scanning devices.

The product scanning device may be a graphical code scanner of a checkout kiosk. A graphical code scanner could be a barcode scanner, a QR code scanner, or identifier of any graphical code. Alternatively, RFID reader or any suitable scanner of an identifier can be used. In one example, a checkout kiosk may output transaction logs that include product identifiers and timestamps. Transaction logs can be associated with a customer at the checkout kiosk at the time of the transaction log. The product location (or a set of candidate product locations) can be determined by determining product pick up events performed by the customer.

The product scanning could be a mobile product code reader device (e.g., a handheld barcode scanner). Such a handheld barcode scanner may be used to scan an item during inventory tasks, stocking tasks, or other operational duties. This scanning event if performed near the stocking location of the product may be used to determine where near the scanning event a product is stocked.

As an alternative variation, detecting the assigned product identifier code of an item may include receiving a data update on a displayed product identifier code of a digital product label. This may be received by a digital product label. A digital product label (e.g., an e-ink price tag or other type of digital display used for displaying product information) may have its display updated. the product label can be associated with a product identifier. Changes in the product identifier may be detected and the associated product location (e.g., shelf above or below the label) can be updated as a location for that identified product. Alternatively, displayed content of a product label (e.g., a static, analog product tag) may be remotely determined using computer vision analysis of the product label.

In one variation the waypoint graph is a graph data structure with node-link mappings where the waypoints are represented as nodes and links are representations of travel scores. A travel score may be a measure of estimated travel time, travel distance, or other metrics. In some instances, the travel score may be a score that weighs multiple factors such as time, distance, complexity, risk of changing conditions, cart or robotic agent navigation challenges, and the like. Performing the graph traversal process can include performing a traveling salesperson process minimizing travel cost for navigating the waypoints.

Determining a waypoint graph for the set of waypoints based on the product location map can include generating a graph with node-link mappings based on physical location data of the waypoints (e.g., locations of the products), historical computer vision measured traversal speeds of an agent between nodes, detected or predicted congestion levels (used to augment link scores), detected performance of a particular agent (speed, instruction following performance, crowd navigation, etc.), and/or other aspects.

In some variations, the computer vision monitoring system may be used to detected real-time conditions, which can be used to augment the determined waypoint graph and thereby the resulting determined agent path directions. In particular, the CV monitoring system may track people, detect robotic agents, detect obstructions (e.g., product stocking activity, stagnant lines, crowds), and/or other conditions in the store. These may be used to update the travel scores links in the waypoint graph. Accordingly, the method can include detecting, using the computer vision monitoring system, conditions (e.g., congestion, obstructions, activity etc.) within the environment; and wherein determining the waypoint graph for the set of waypoints based on the product location map is further based on the conditions. This may, for example, be used to route an agent around crowded sections in a store.

In other variations, the waypoint graph may be dynamically updated in response to changing conditions. This can happen after initial determination of the agent path directions. Accordingly, the method may include detecting a change in conditions within the environment (e.g., detecting, using the computer vision monitoring system, congestion within the environment) and upon the change in conditions mapping, using the graph traversal process for route planning, updated agent path directions based on the product location map and the updated conditions.

As discussed, the method may have particular applicability for integrating with an ordering-delivery system or more generally an order fulfillment system. This system may use user device agents (e.g., computing devices used by pickers/workers) or mobile robotic devices (e.g., product picking robots).

In addition to using the graph modeling for route planning, the time cost modeling of order fulfillment can be used in outputting order fulfillment timing data. The method may be used for generating an order fulfillment using more reliable predictions on time to complete, monitoring and updating timing status, and/or scheduling fulfillment.

In another exemplary implementation, the method incorporates tracking of real-time inventory status, which functions to detect and use information related to location of items and stocking conditions (e.g., out of stock, almost out of stock). In some instances, this can include updating item location when it is moved. For example, the method may include tracking placement of item in a new location and using new location. This variation may be used in combination with directing another agent to move certain items to a new location so that a subsequent agent can more quickly pick that item.

In another example, tracking of real-time inventory status may be used for detecting an out of stock and canceling instructions to pick an item. For example, an agent may be told to not pick an item if it's detected as being out of stock. This update may even happen while an agent is picking items (e.g., after the order is placed).

In another example, tracking of real-time inventory status may be used in proactively collecting alternative order input in response to inventory status. This variation may be used when low inventory or out of stock inventory is detected. This may be performed while a customer is creating an order. If they select an item with low or no stock, then a user interface prompt may be triggered to collect resolution input. The customer may want to opt to select an alternative item, to skip the item if not available, or make some other suitable resolution. This variation may also be used to proactively address an issue after an order is placed. The method may include detecting, using the product location map, a change in status of an item in an order, and triggering a notification and collecting resolution input. In this case, an item may run out after the order is placed. The customer could receive an in-app message or some other communication and then prompted to use a user interface to enter input on how to resolve the issues.

In some exemplary implementations, the method may include tracking order direction fulfillment of an agent, which can include tracking agent, tracking agent-item interactions, and updating the order status in response to detected agent-item interactions. This variation can detect when an agent is in proximity to an item of an assigned order, and then confirm if the correct item was selected. When an agent is assigned multiple orders, fulfillment confirmation may additionally use CV monitoring to confirm that an item was correctly selected and then correctly sorted into a correct bin, basket, bag, or other type of container. For example, an agent may fulfill two orders with two different bags in a cart (one bag for each order). After detecting item selection (using CV processing), item placement may then be tracked to determine which bag the item is placed to confirm it was sorted into an appropriate bag. If the wrong bag is used, the computing system may trigger an alert on a client device of the agent. This may involve registering an application instance of agent with a CV-detected person.

As another related variation, detecting completion of an item selection task can be used in triggering updating of order picking directions. For example, picking directions such as the next item for picking, the path to use, and/or other details may be surfaced or presented to the user as next task directives. In some variations, the route planning in the mapping process (P120) can be updated prior to surfacing next tasks.

In some exemplary implementations, the method is performed in connection with multiple orders distributed across multiple agents. In such a variation, the method may incorporate tracking location of an agent including geographical location by sensing and collecting location information from a personal computing device (using GPS, cellular triangulation, IP location prediction, and the like). Coordinating orders across multiple agents may involve evaluating estimated arrival time of agents at a retail environment, prediction environment congestion, tracking and predicting agent picking speeds (potentially tracking across different product types), and/or factoring other inputs into how to efficiently distribute and assign orders. In one particular variation, the method can include tracking, using CV-person tracking, picking progress of agents when fulfilling orders to understand efficiency at different regions of a store, types of products, and the like. In one example, this can be used to apply a sensor-based metric to tasks like picking fresh produce, and then factoring that into assignment and/or into the mapping order picking directions. In some instances, these metrics can be incorporated into route planning process (e.g., a traveling salesman solution). In some instances, the method may involve coordinating hand off of items, partial order collection, item relocating, and/or other item handling logistics. The use of a CV monitoring system for sensing can enable a technological approach to making such processes feasible.

Block P110, which includes generating, using a CV monitoring system, a product location map, functions to build a dynamic planogram based on current conditions. Generating the product location map preferably works to continuously or periodically update the location data regarding products (or items) in an environment.

Generating the product location map can create a data system (e.g., a database system and/or data model) that can be queried and used to determine location data for a particular item type. In this way, products of an order can be mapped to specific locations in an environment.

In one variation, the location information is specific information related to where an item is displayed (e.g., shelf location, bin location, etc.). The location information may incorporate 3-D location information, descriptive location information (e.g., aisle, shelf, spot descriptors). This could be from a top-down two-dimensional mapping of the environment. The location information, however, is not limited to specific and exact information. In some variations, low precision location information may be used to guide an agent.

The product location map preferably includes updated information on location and is reactive to changes in location. Preferably, such real-time tracking can detect and update location information at an individual item level, such that the CV monitoring system can detect, track, and then update the product location map when an item is moved from one location to a second location. In other variations, the product location map may be updated periodically such as each hour, day, or week.

The product location map can additionally store item inventory information such as the number of items. The item quantity may be detected or measured using computer vision but may additionally or alternatively use other data sources such as an inventory management data system.

The inventory information can be specific counts of items but may also be descriptive classifications of inventory quantities. For example, processing of image data of an item's display location may be used in detecting stocking condition such as well stocked, low on stock, and/or out of stock.

Generating the product location map can include updating in response to inventory interaction. This variation may include detecting stocking events, item selection events (customers picking for purchase), tracking item movement (e.g., tracking moving of items from one location to another), and/or other item changes.

Some variations may include generating, using a CV monitoring system, a product placement map of a plurality of items stocked in the item-stocked environment, by performing for a plurality of items merging product identifier data of an item with tracking, using the CV monitoring system, of the item to product stocking locations (the identifier data being collected from a set of product scanning events of product scanning devices). Various alternative variations for generating a product location map are described herein. In some instances, generating the product location map may be used independent of directing an agent and may be used for alternative objects such as the alternative applications described herein.

Block P120, which includes mapping agent path directions functions to generate client data updates for instructing agents on how to move through a set of waypoints. This may be more particularly described as mapping agent path directions for a set of waypoints within the environment based on the product placement map.

Several variations of mapping the agent path directions are described herein depending on the application.

As shown in FIG. 7, block P120 may include mapping, using a graph traversal process for route planning, agent path directions based on planogram P1120, which includes: determining a waypoint graph for a set of waypoints based on the planogram P1121, and determining the agent path directions by performing a graph traversal process of the waypoint graph P1122.

As shown in FIG. 8, block P120 may include receiving location of a mobile robotic agent and receiving one or more destination waypoint locations for the mobile robotic agent P2121. The destination waypoint locations may be supplied by a system used to manage tasks of the robot. In some variations, an ordering service may supply a list of products for picking as part of a customer order.

As shown in FIG. 10, block P120 may include detecting location of a user device agent S3121, receiving a set of product identifiers and determining a set of waypoints associated with locations of the product identifiers P3122, determining a waypoint graph for the set of waypoints based on the product location map P3123, and determining the agent path directions by performing a graph traversal process with the waypoint graph P3124.

In another variation, the method is applied to fulfilling an order. According, block P120 can include mapping order picking directions based on planogram, which functions to generate client data updates for instructing agents on how to fulfill an order.

A method variation used for order fulfillment may include receiving an order. The order can be received through an online ordering system that provides a client user interface for a customer to compile a set of items for purchase and then place the order. The order may alternatively be communicated from an outside system. For example, a third-party ordering system may communicate order data using an application programming interface (API).

In one preferred variation, mapping order picking directions (i.e., the agent path directions) will use the planogram (i.e., the product location map) to convert order data into a graph traversal optimization process. In one particular variation, this involves converting orders into a traveling salesman problem (TSP) and calculating a preferred selected route. Accordingly, mapping order picking directions can include combining item order and planogram to a TSP graph problem. The resulting selected route could be an optimal path recommendation but may alternatively be any suitable route recommended based on various analysis. The preferred route may be further based on various heuristics, rules, and/or other processing which may be used in combination with output of a TSP solution process.

In a TSP solution process variation, the method may include constructing an item-path-cost graph using the product map and solving for a TSP route using the item-path-cost graph.

The item-path-cost graph in one variation can use the spatial location of the items of an order in combination with potential physical pathways to those items as shown in FIG. 5. The pathways may be automatically detected using computer vision analysis of the environment, but may alternatively, for example, be pre-configured. The item-path-cost graph is preferably based on updated/real-time data from the product location map. The nodes of the graph can represent item selection locations and/or other intermediary locations in the environment. The paths between the nodes can represent traversal path options where the paths can be weighted using CV-detected information related to cost of that path option.

In some variations, constructing the item-path-cost graph can include detecting people location within the environment and applying weights within the graph based on levels of congestion based on the detected people location as shown in FIG. 6. This may additionally or alternatively use historical data to predict the level of congestion in an environment and/or in particular regions of an environment. Such historical data may be based on various conditions (e.g., time of day, time of year, specific agent). This may be used to determine best-route recommendations to avoid paths through the store that would be slower. Other factors like detecting current stocking activities in the store may be used in updating the graph.

In another variation, the method may model a graph incorporating path options of different agents. This may assign different paths using various agent-specific parameters. This may function to allow modeling of different speeds and quality of product-picking for different agents.

The output of process P120, the order picking directions, can specify a sequence of item selection and optionally include one or more recommended paths between each item selection/interaction task.

In many instances, the order picking directions are comprised of one or more item-pick up interactions with a recommended path between those interactions. In some variations, such as where the method coordinates item-relocation between agents, the order picking directions may include item-interaction instructions of picking up an item, how to sort or group an item (e.g., bagging items for different orders) and/or repositioning an item. In some implementations, the order-picking directions may only fully specify all steps to complete an order and may present the next or a limited set of next steps.

In some variations, the method may include assigning order fulfillment (and/or the associated order-picking directions) to an agent. In one implementation, agents can be assigned order picking directions as they become available. In another implementation, assignment of order fulfillment may be based at least in part on tracked agent order fulfillment. Agents may be robotic agents and/or user device agents used by users. In some variations, the method may include tracking agent picking history, which can function to understand time and quality metrics of an agent for different items, item types or categories, environment locations, levels of congestion in a store, and the like. This may enable the method to automatically assign order fulfillment across a pool of agents in a way that can enhance operations. For example, picking tasks may be assigned to individuals based on predicted optimization of order distribution so that orders are distributed for enhanced efficiency. For example, one agent may be faster walking, another agent may be faster at picking produce, another may be slow or fast at locating certain types of products.

The mapping of order picking directions may not be limited to being performed a single time or being performed only prior to assignment to an agent. In some variations, the method can include updating order picking directions based on CV monitored state of the product location map. For example, detecting changing conditions may be used to determining an updated waypoint graph and updated agent path directions. This update may be further updated based on current status of the agent such as location of the agent and current path trajectory (is the agent following a recommended path, are they making progress along a path). This update may additionally factor in inventory conditions as indicated in the product location map. Changes in product availability or relocation of an item can be detected and automatically used to update directions.

This updating may not only automatically update route planning for fulfilling a single order but can also alter which order is being fulfilled by an agent. For example, if two orders A and B are being fulfilled and both have milk as an item, then a result of updating the order picking directions may switch a first agent from fulfilling order A to B and a second agent from B to A depending on different conditions. Similarly, an order picking direction may be updated to fully cancel order fulfillment and reassign, if for example, an agent encountered some issue or was delayed when fulfilling an order.

Updating or order picking directions can happen periodically or in response to some events. An example of such an event could be when an agent approaches an item for selection and/or after detecting an item being successfully selected. Updating the order picking directions can involve, for example recalculating TSP processing based on current conditions (e.g., only unselected items of an order may be factored in). This updating of order picking directions functions to maintain recommended directions that are current to current conditions.

Block P130, which includes updating a navigation system of an agent with the agent path directions, functions to communicate and alter the operating state of an agent based on the agent path directions.

For a robotic agent applied variation, block P130 may include, as shown in FIG. 9, updating navigation system of the remote agent with the agent path directions and navigating the mobile robotic agent based on the agent path directions and input from an obstacle avoidance system of the mobile robotic agent. The robot may move with the target of generally following the agent path directions but may use onboard sensors to check for obstacles and steer around other users, agents, and the like.

For user device agents, block P130 can include altering the user interface state of a computing device. Accordingly, block P130 may include updating the user device agent with the agent path directions.

When applied to fulfilling orders, block P130 may more specifically include updating remote agent client devices with order picking directions, which. functions to digitally trigger communication to and interaction with a client device used in communicating current order picking directions. remote agent client devices can be the user device agent receiving the updates. These may be mobile phone, watch, connected audio device, connect smart glasses, augmented reality/virtual reality headset, and the like. An agent-facing computing device is preferably in wireless communication with a managing computing system. Updating remote agent client devices with order picking directions preferably includes delivering or otherwise transmitting the order picking directions. This may involve pushing a communication to an agent-facing computing device or the agent-facing computing device polling a digital resource to retrieve the order picking directions. In this way, the method may be used to enable an updated instructional navigational interface used in fulfilling orders. It may additionally be used in providing live user interface feedback related to completion of tasks.

The agent client device may involve one or more different computing devices, and the method may be adapted to updating a variety of types of user interfaces such as a graphical user interface, an audio user interface, a tactile user interface, and/or any suitable form of user interface.

In a graphical user interface variation, an application may be updated so that information can be visually presented. In some cases, this information can update in real-time based on detected status of the agent (location and/or CV detected activity of the agent). In some variations, the graphical user interface could be an augmented reality (AR) user interface such as an AR headset or smart glasses. This may be used to present a real-time overlay showing path recommendations, highlighting expected item locations, and the like.

In an audio user interface variation, audio instructions may be presented using audio. This may include playing instructions and/or playing audio tones corresponding to different conditions. In one implementation, this can include tracking position of agent through CV tracking and playing audio signals coordinated to location of the agent and location-associated instructions. In this way, an agent could be told when to turn, hear audio signals that change with proximity and/or orientation to a targeted item, hearing a success or error tone/message after picking an item up, and the like.

In a tactile user interface, various vibrational signals may be triggered to communicate different aspects to the agent. A tactile user interface can be used in combination with another approach to specifying the order picking directions. For example, order picking directions may be printed and then the vibrations can be used to indicate success or failure of different tasks.

Once an agent is provided with order picking directions, the method may additionally facilitate monitoring and updating status of order fulfillment. This can include tracking state of agent in relation to the picking directions. Tracking state can include tracking state for a current direction (e.g., how close is the agent to the item, have they picked it up yet, etc.), progress in picking all items (e.g., “an agent has picked 3 of 7 items in an order”). This may additionally include tracking aspects like agent location relative to recommended locations. This variation may include detecting deviation from recommended path and updating order picking directions, which functions to adjust instructions based on sensed activities of the agent. For example, while the picking directions may specify or expect an agent to follow a particular path, the agent may take a detour or go another route, which can be detected using video/image-based person tracking or using other sensor-based tracking. The method can adapt and provided updated directions in response to detected current conditions.

### 4. Planogram Overview

As discussed, a dynamic planogram may be used for reactive route planning but may additionally or alternatively be used for alternative variations. In one variation, a dynamic planogram may be generated using operational data. The variations described may, for example, optionally be used independently or used in combination with the processes of generating a product location map or the planogram mapping processor service 1300 described above.

A system and method for applying store operational data for automated product location tracking within an environment function to map one source of product identifying empirical data onto sensor-detected information from various locations in an environment. In particular, the system and method are used with a computer vision based system such that product identifying empirical data is mapped to image-detected information. The system and method have applications in enabling a new and useful digital sensor-enabled system for generating a product location map that is dynamic, self-updating, and automated.

The system and method can establish a set of candidate associations between individual records in the empirical data source and image-detected information. These candidate associations may be noisy with many false associations. With sufficient empirical data, multiple instances of the same type of empirical data records can amplify true associations.

The system and method can be used for on-boarding and maintaining a product location modeling of an environment for computer vision applications or other digital services/interactions. Generally, the system and method analyze patterns between confirmed data input like transaction data from a point of sale (POS) system or from a product scanning device and adjacent or related image-based observations. In one preferred application, the system and method can be used in a retail environment to create a planogram of product placement throughout the retail environment using one or more store data input sources and one or more collection of image-based observations.

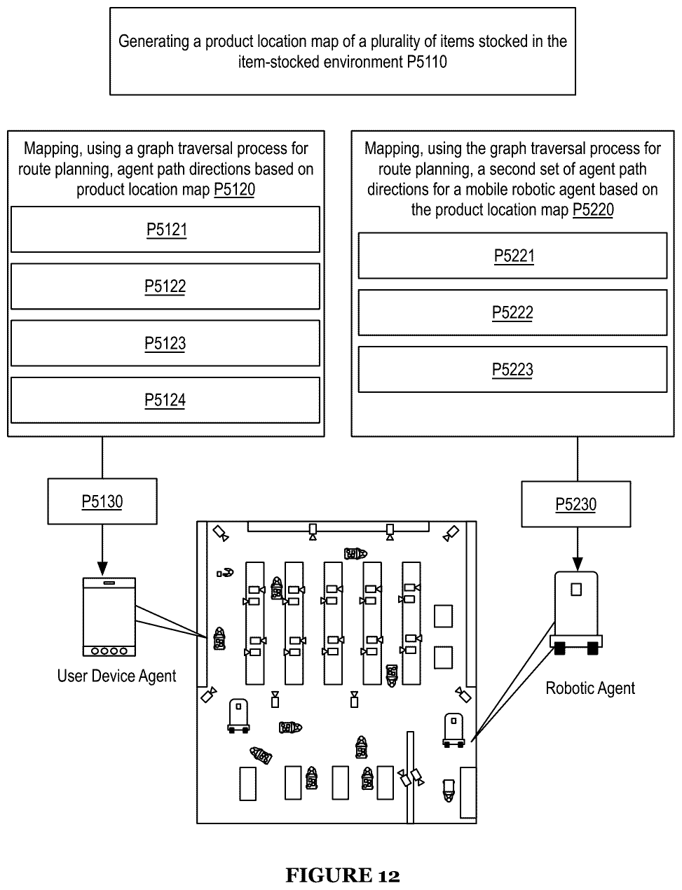

The system and method can use store data input that is highly accurate at identifying products and which may be fully independent of any computer vision or image processing. The system and method can use store operational data like transaction data (e.g., transaction and receipt data) from a store's POS system, stocking data from when workers stock the shelves, and/or other store data inputs specifying product identifiers as shown in FIG. 13. The system and method may then compare this empirical data source to a computer vision (CV) based observations such as customer paths, customer interaction events, detected changes in product shelving, and/or other CV-based observations. With sufficient observation, the system and method can detect patterns between occurrences of specific product identifiers and the location of CV observations.

The variation leveraging transaction logs highlights the system and method capabilities of using empirical data from events removed temporally and spatially from the actual placement of the products.

The system and method may additionally or alternatively use store operational data originating from product scanning at or near the storage location of products. In this way, the system can automate a process by which product location information can be recorded by combining scanning a product identifier (using a product scanning device) and detecting some event related to the location of the scanned product (e.g., placing the product on the shelf).

The system and method may be applied to translate a dataset of candidate product locations into a product location map that can be used in enabling a wide variety of unique capabilities of a computing system. A real-time and high accuracy product location map has not existed as a feasible and cost-effective tool.

As one example, the product location map can be used in enabling a dynamic and self-update map (which can be used for consumer map tools, for worker-directed store maps, and/or for maps used by mobile robotic devices).

As another example, the product location map can be used for dynamic mapping directions within a retail environment. Customers, workers, and/or robotic devices could be directed towards locations of products in an environment with higher accuracy.

As another example, the product location map can be used for inventory alerts such as out of stock alerts, misplaced item alerts, alignment with product layout objectives, and the like.

As another example, the product location map may enable highly accurate 3D product mapping capabilities within a retail environment. This may be used in combination with augmented reality (AR) computing devices to enable various AR or other types of digital experiences based on relative position of a device (or user) with the products. For example, product information can be overlayed as an augmented reality layer, where positioning of the overlay is based in part on the product location map.

As another example, the product location map may be used in various CV-based applications. CV-based applications can include store monitoring services, operational-focused applications, customer-focused applications, and/or other forms of CV-based applications.

In particular, the system and method may address a number of challenges involved in building computer vision based interaction applications. In particular, the system and method can be used for CV interaction applications for large environments like retail spaces. The system and method can help with the cold start problem of enabling CV-based services such as automated checkout, accelerated checkout, inventory management, and/or other CV-based applications. A retail environment like a grocery store will have thousands of different products, some of which may have no prior image data. Use of the system and method can speed up the on-boarding process for making the CV-based service operational within a new environment.

The system and method are preferably used in a retail environment. A grocery store is used as an exemplary retail environment in the examples described herein. However, the system and method are not limited to retail or to grocery stores. In other examples, the system and method can be used in supermarkets, department stores, apparel stores, bookstores, hardware stores, electronics stores, gift shops, and/or other types of shopping environments. Preferably, the system and method are used in combination with a sensor-based monitoring system used for automated or semi-automated checkout such as the system and method described in U.S. patent application Ser. No. 15/590,467, filed 9 May 2017, which is incorporated in its entirety by this reference. However, the system and method may be implemented independent of any automated checkout process. The system and method may also be adapted for other applications in environments such as warehouses, libraries, and/or other environments. In this way, the system and method may be used for tracking locations of any suitable type of item or object and is not limited to only products. In general, the items tracked will have some empirical data associated with them which may be empirical data such as an item identifier but could be any suitable type of empirical data such as an item property.

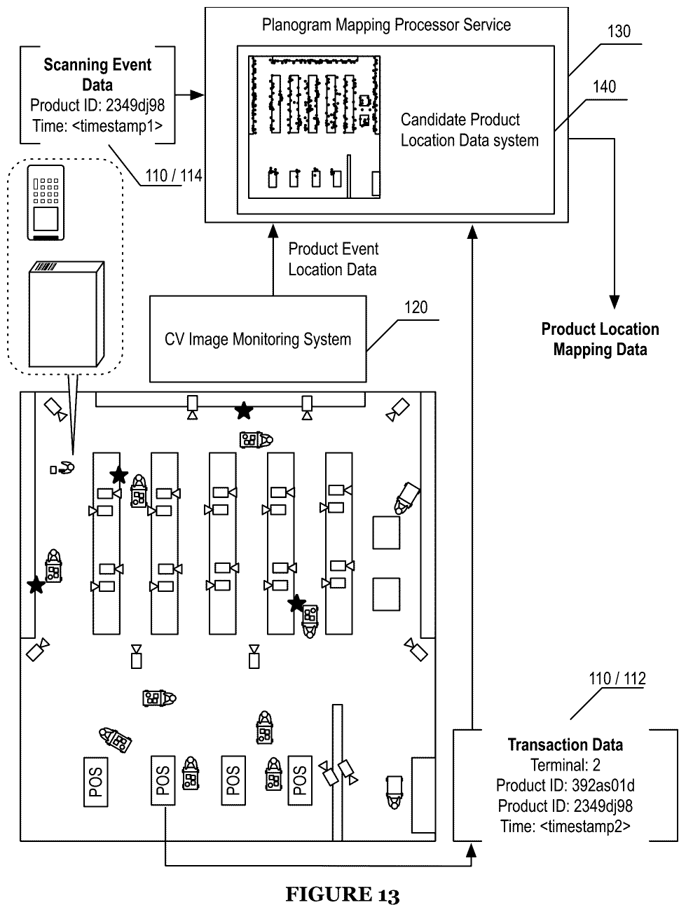

The system and method are preferably implemented in a way where a candidate product location dataset is progressively and repeatedly updated with candidate association data records relating product identifier information from empirical data sources (e.g., a product identifier scanned during a checkout event or product scanning event) and an image-detected location information. The candidate association data records are referred to herein as probable location markers (e.g., data points). A product location map is produced by analysis of a collection of such probable location markers. For example, as shown in FIG. 14, the system and method may involve progressively updating a candidate product location dataset that stores a plurality of probable product location markers, which comprises multiple instances of: at an electronic device, scanning a machine-readable product code and reading a product identifier; at the electronic device communicating, to a computing device of an inventory monitoring system, the product identifier; at a set of imaging devices, collecting image data, wherein the set of imaging devices are configured to capture a field of view that includes product storage locations; detecting, using a computer vision processing model, product event location data at the product storage locations; at the inventory monitoring system, matching the product identifier to at least one product event location in the product event location data; and at the inventory monitoring system, updating the candidate product location dataset with a probable product location marker that associates a location property of the product event location and the product identity. When sufficient candidate product location markers are updated, the system and method may then translate the candidate product location dataset into a product location map.

In one preferred implementation, the system and method use receipt data from the store. The receipt data may be collected as transaction log indicating a product identifier for each item purchased. The system and method can then use image-based analysis using computer vision and/or human-assisted labeling to establish a path through the store for the customer responsible for a transaction. These locations can be associated with the product identifier. With analysis of multiple purchases of a product, the customer paths will have overlaps near location(s) of the product in the store. This may be used to generate a map of the store where products are located.

In a related implementation variation, the system and method can use image data where user-item interactions like item-pickup events are labeled. They may be detected and labeled with shelf location information. For a given product identifier in the receipt data, location data from one or more selected user-item interactions can be modeled as a candidate location. The selected user-items interactions can be selected based on temporal conditions (e.g., occurring within a defined time window prior to the purchase of an item) and/or customer/agent conditions (e.g., user-item interaction involves the customer associated with a particular receipt). As in the other implementation with analysis of sufficient receipt data, the actual location of the products can be amplified and false candidate location information deamplified and ruled out. This may be used to automate generation of a planogram specifying specific shelf locations of the store.

As a related implementation variation, the system and method may also use detected changes in product storage in a shelf as a source of location data. These changes may also allow specific regions on a shelf and image data of a product from that region to be identified. As in the user-item interactions, location data from one or more detected changes can be modeled as a candidate location for a given product item transaction, and with sufficient receipt data the true locations can be detected through analysis of the candidate locations. This may be also used to automate generation of a planogram specifying specific shelf locations of the store. This approach because of the automatic detection of product image data can further be used in training a computer vision model for product identification.

Other implementations may use alternative or additional sources of empirical data like data from stocking activities. A worker may be required to scan items as part of an inventory tracking process when they stock items on the shelf. The time and optionally location information from this stocking activity can similarly be used to establish candidate associations with changes detected through collected image data. With sufficient data from multiple stocking events, possibly from multiple days of product stocking, the system and method can map product identifiers to specific locations in the store with high confidence. Continued monitoring of data can preferably resolve low confidence situations or situations where data is noisy. In one specific stocking implementation variation, a stocking procedure may map digital scanning of product barcode information to a computer vision detected product location. In one variation, a fiducial marker or other suitable CV detectable object/marker may be positioned at the shelf location for a product in coordination with scanning of the product. Such mobile product scanning variations can leverage existing stocking or inventory tracking procedures but may additionally or alternatively serve as a method by which the product location map can be actively built or resolved. The method can automatically establish an association between the product identifier and the shelf location.

The system and method may provide a number of potential benefits. The system and method are not limited to always providing such benefits and are presented only as exemplary representations for how the system and method may be put to use. The list of benefits is not intended to be exhaustive and other benefits may additionally or alternatively exist.

As a potential benefit, the system and method serve as an automated way to onboard all or at least a large portion of a store. A CV-based monitoring system can be on-boarded with no or little pre-existing data in a relatively short period of time. This may greatly accelerate the rate at which a CV-based monitoring systems for purposes of automated self-checkout, assisted checkout, and/or inventory tracking can be put to use in a store.

As another potential benefit, the system and method can be modified to work with different levels of computer vision capabilities. Some implementations can use asynchronous analysis of image data. With low latency CV capabilities, the system and method can additionally be made to update responsive to events as they happen.

As another potential benefit, the system and method can be integrated into normal operations of a retail environment. During on-boarding the normal POS checkout procedure can continue as normal, while the system and method builds out a product location map. Similarly, a worker performing routine stocking activities like stocking products, performing price updates, or product inventory, can be leveraged with digital integration with a product scanning device to map probable product locations.

As another potential benefit, the system and method can be a continuous process that is ongoing so as to continually update and dynamically respond to changing conditions. Product layouts change for a wide host of reasons. Similarly, the products sold by a store can change drastically. The system and method can flexibly adapt to such changes.

As another potential benefit, the system and method may be able to measure the state of the product location map. The confidence of the product mapping for the environment can be inspected through analysis of the product location map. Such inspection may, for example, report on the state of the accuracy or confidence of product location mapping as a whole, by location, and/or by product. Furthermore, in some variations, the system and method may trigger alerts as to changing conditions such that the “health” and/or capabilities of the product location map can be known and/or addressed.

As another potential benefit, the system and method can provide a dynamic and substantially real-time digital product location map. A substantially real-time product location map can be characterized as one that can feasibly be continually maintained to reflect daily or hourly state. The system and method can leverage continually occurring activities like checkout transactions and/or product stocking events in updating the product location map.

As another potential benefit, the system and method may enable product location mapping for a subset of products. With an ability to measure predictive capabilities, the system and method can be configured to provide product mapping capabilities for subsets of products based on the state of the underlying candidate product location dataset. In some variations, as data records in the candidate product location dataset are added and/or age, the system may enable or disable location predictions. For example, the product location mapping of a product may be enabled once a condition is satisfied where the probable location markers in the candidate product location dataset can meet some threshold of a confidence score in predicting location. Similarly, product mapping may be disabled when there are not enough probable location markers to accurately predict location (e.g., because the markers are not high enough in confidence or because they have expired).

### 5. Planogram System

As shown in FIG. 13, a system for applying store operational data for automated product location tracking within an environment can include at least one empirical data source 110 such as a transaction data source 112 or scanning event data source 114, an image monitoring system 120, a planogram mapping processor service 130, and a candidate product location data system 140. The planogram mapping processor service 130 and a candidate product location data system 140 may be part of an inventory monitoring system or other suitable computer system.

The empirical data source no functions as a data integration that can capture, read, or provide data access to various instances of collected empirical data. The empirical data will generally be a form operational data that includes one or more substantially verified product identifiers. The empirical data source will generally collect the data in connection with certain events which through computer vision can be associated with detected image-based conditions using the image monitoring system 120.

A transaction data source 112 functions to collect highly accurate product information. The transaction data source in one variation can include at least a subset of the checkout/POS terminals in the store including the worker-stationed POS stations and the shelf checkout stations. Transaction data can be retrieved from these terminals as purchases are made. The transaction data source may alternatively be a communication data interface to a database or other data repository recording the transaction data. The transaction data preferably includes transaction records that specify receipt information and/or the product identifiers of products purchased. Transaction records preferably include a timestamp property indicating the time the purchase. Transaction records may additionally include a location property indicating the location or terminal where the purchase occurred. This may be used in determining the customer or one or more people to consider as the potential customer responsible for the purchase. Transaction records may additionally include a customer identifier if, for example, the customer supplied loyalty card information.

In some implementations, the system may include the POS terminal devices. In other implementations, a data interface into transaction data, which was provided (at least in part) by such terminal devices may additionally or alternatively be used.

A scanning event data source 114 functions as data access to product identifiers that were selectively scanning during some operational activity such as when stocking products, taking inventory, updating pricing/signage, scanning to mark locations, and/or other suitable activities. A scanning event data is preferably generated by a mobile scanning device that includes wireless communication to a server of the system (e.g., the planogram mapping processor service 130) for recording and processing. Alternatively, the scanning event data could be stored on the scanning device and later uploaded or communicated to the planogram mapping processor service 130.

In some implementations, the system may include the product scanning devices. Alternatively, the system may alternatively interface with a scanning event data system that obtains scanning event data from such devices.

A product scanning device may include code scanning element such as a barcode scanner, QR scanner, NFC reader, RFID tag reader, or other suitable code readers. The product scanning device may additionally include a visual identifier which could be statically marked on the device, displayed within a display of the device, a light or other type of visual emitter exposed on the body of the product scanning device. The scanning devices may additionally include other elements to facilitate its use such as a user interface element. The user interface of the product scanning device may be used to deliver feedback to the operator, to direct stages of the product locating process (scan, initiate product locating time window, trigger detection of an identifier for product locating), and/or to perform other tasks.

An image monitoring system 120 of a preferred embodiment functions to transform image data collected within the environment into observations relating in some way to items and locations within an environment.

The image analysis preferably employs a form of CV-based processing wherein the image monitoring system 120 is a CV monitoring system. The image monitoring system 120 may additionally or alternatively use human-assisted labeling or other forms of semi-automated analysis of the image data.

The image monitoring system 120 may be used in tracking customer/person location, detecting user-item interactions (e.g., customer picking up an item for purchase), detecting changes in product shelving (e.g., a product was removed, moved, and/or placed on a shelf), and/or detecting other image-based information. The image monitoring system 120 will preferably include various computing elements used in processing image data collected by an imaging system. In particular, the image monitoring system 120 will preferably include an imaging system and a set of modeling processes and/or other processes to facilitate analysis of user actions, item state, and/or other properties of the environment.

The imaging system functions to collect image data within the environment. The imaging system preferably includes a set of image capture devices. The imaging system might collect some combination of visual, infrared, depth-based, lidar, radar, sonar, and/or other types of image data. The imaging system is preferably positioned at a range of distinct vantage points. However, in one variation, the imaging system may include only a single image capture device. In one example, a small environment may only require a single camera to monitor a shelf of purchasable items. The image data is preferably video but can alternatively be a set of periodic static images. In one implementation, the imaging system may collect image data from existing surveillance or video systems. The image capture devices may be permanently situated in fixed locations. Alternatively, some or all may be moved, panned, zoomed, or carried throughout the facility in order to acquire more varied perspective views. In one variation, a subset of imaging devices can be mobile cameras (e.g., wearable cameras or cameras of personal computing devices). For example, in one implementation, the system could operate partially or entirely using personal imaging devices worn by users in the environment (e.g., workers or customers).

The imaging system preferably includes a set of static image devices mounted with an aerial view from the ceiling or overhead. The aerial view imaging devices preferably provide image data that observes at least the users in locations where they would interact with items. Preferably, the image data includes images of the items and users (e.g., customers or workers). While the system (and method) is described herein as they would be used to perform CV as it relates to a particular item and/or user, the system and method can preferably perform such functionality in parallel across multiple users and multiple locations in the environment. Therefore, the image data may collect image data that captures multiple items with simultaneous overlapping events. The imaging system is preferably installed such that the image data covers the area of interest within the environment.

Herein, ubiquitous monitoring (or more specifically ubiquitous video monitoring) characterizes pervasive sensor monitoring across regions of interest in an environment. Ubiquitous monitoring will generally have a large coverage area that is preferably substantially continuous across the monitored portion of the environment. However, discontinuities of a region may be supported. Additionally, monitoring may monitor with a substantially uniform data resolution or at least with a resolution above a set threshold. In some variations, a CV monitoring system may have an imaging system with only partial coverage within the environment.

The planogram mapping processor service 130 functions to process image-based event data with the empirical data to output a product location map. The planogram mapping processor service 130 preferably includes one or more processes and one or more computer-readable storage mediums (e.g., non-transitory computer-readable storage mediums), wherein instructions are stored on the one or more computer-readable storage mediums such that when executed, the one or more processors process the empirical data and establish a candidate product location dataset using image event location data associated with the empirical data, and analyze and translate the candidate product location dataset into a product location map.

The candidate product location data system 140 is preferably a dataset or data model maintained within one or more data systems. The candidate product location dataset can include data records for multiple product types and, optionally, substantially all product types tracked in the environment (e.g., all products sold in the store). Here “substantially” may be characterized as a majority of product types. In many implementations, the method can build a dataset to more than 90% or 95% of products having data records pairing their product identifiers to a location. In some variations, substantially all product types may be a set of products selected for tracking and monitoring through the method. By way of example, different sizes and types of stores could have thousands, tens of thousands, or even more of different product types.

The candidate product location dataset can store data records to model locations of such volumes of different product types. Furthermore, the candidate product location data can store multiple data records for one product type for enhanced predictive capabilities. As such a candidate product location dataset, when being translated into a product location map for a store may have tens to hundreds of thousands and/or over a million data records (e.g., probable location markers) used in producing an updated and reliable product location map.

The modeling of the candidate product location dataset may generalize to addressing storage of a product in multiple locations, changes of product storage locations, introduction of product types, removal of product types, changing in the shelf space allocated to a product type, and/or other changes.

A probable location marker can be stored as a database record that stores or includes a reference to a location property and product identifier. A probable location marker may additionally include or reference a time property, a confidence score and/or another type of score, a location property, and/or other data that may be used in evaluating the marker when assessing product locations.

The format of the probable location markers may be stored in the dataset for vector/spatial calculations such that queries of the candidate product location dataset can find nearest neighbors, measure proximity, perform spatial averaging (e.g., mean, mode, median averages of product predictions in relation to a particular location), apply various forms of proximity filtering or proximity weighting, and/or perform other spatial calculations. The location markers may be indexed by location and product identifier for responsive search and analysis.

The planogram mapping processor service 130 may additionally operate on, inspect, analysis, maintain, or otherwise process and use the candidate product location data system 140 in producing a product location map or information related to assessed product location mappings.

The system may be used within other sensing systems that leverage sensed state of product locations provided by the system.

### 6. Planogram Method

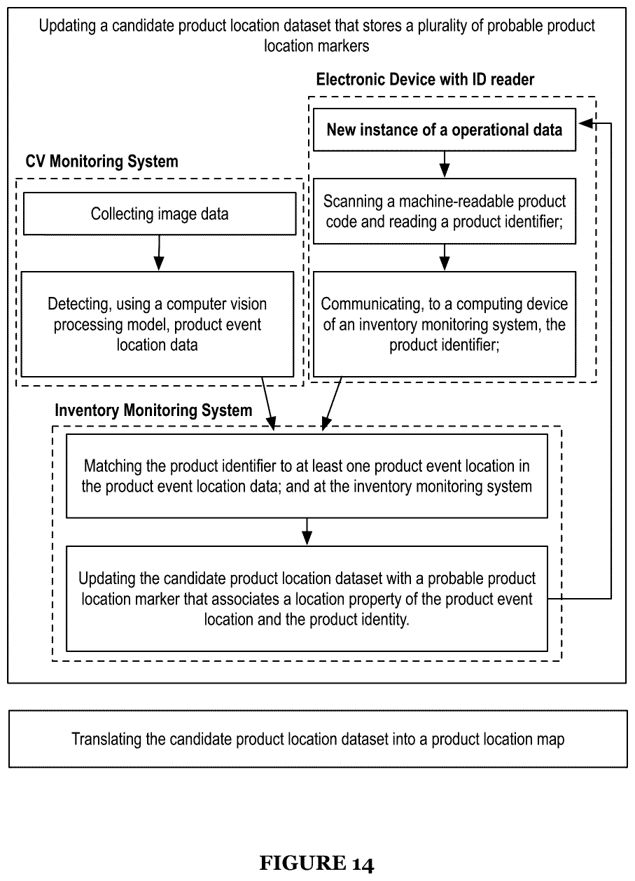

As shown in FIG. 15, a method applying store operational data for automated product location tracking within an environment can include collecting operational data with item identifier information S10, generating item event location data through a sensor monitoring system S20, processing the operational data and establishing a candidate item location dataset using item event location data associated with the operational data S30, and translating the candidate item location dataset into an item location map S40.

The method functions to leverage patterns in occurrences between operational data (an empirical data source of item identifiers) and image-related data to determine a model of item locations within an environment.

The method coordinates operation of a specialized process involving at least two different data systems so as to create a dataset that maps empirical item identifier data to potential locations. The method preferably uses temporal, spatial, and/or user associations between the operational data and the item event location data to update a candidate item location dataset with data records of probable item locations. The candidate item location dataset can then be queried, processed, or otherwise transformed to be used an item location map. This may be used in better detecting items involved in user-item interactions, detecting changes or other item related placement changes, and/or other suitable applications such as those described herein.

The method may apply a variety of approaches for the combined processing of operational data and analysis of image data.

In one example, the method can be used in detecting patterns between the occurrences of purchases of a specific product as detected by receipt data and the location of product pick-up events in the store. This may be used for the purpose of labeling products at that location using the product identifying information from the receipt data.

In another example, the method can be used in automating detecting an associated product location when person scans a product in proximity to the product storage location.

The operational data is preferably collected at an electric device into which item information is entered. Generally, the electronic device will include a code scanner device such as a machine-readable code scanner device (e.g., a barcode scanner, QR code scanner, radio frequency identifier reader, and the like).

The item event location data is preferably collected from one or more sensor monitoring systems. Herein, the sensor monitoring system is primarily described as a computer vision monitoring system which operates on image data collected from the environment to detect location information related to items present in the environment. The system and method may be configured for use with other sensing components or systems such as smart shelving units (e.g., using digital scales, proximity sensors, etc.), radio frequency identifier (RFID) tracking systems, proximity sensors, and the like.

A CV monitoring system preferably involves collecting image data from one or more image sensors using processing of the image data using one or more CV processing models in detecting product event location data. The CV monitoring system can additionally be used in other aspects of the method such as detecting users in proximity to where operational data is created (e.g., identifying a shopper associated with a transaction) or detecting location of the scanning device.

The implementation of the method may depend on objectives and desired output of the method. The method may additionally be adapted to various capabilities of a CV monitoring system. In one exemplary variation, the method can use image event location data associated with specific storage location information to generate a planogram of the store identifying shelving location of specific products, which could be used for CV product identification, inventory tracking, and/or other objectives. In another variation, the method may use image event location data with coarser floor plan location information (e.g., 2D floor plan location) to generate a product map, which may be used by customers for finding a given product.

The method is preferably used in generating a product location map such as a planogram. In one implementation, the method may be used during an on-boarding process of a retail environment to automatically generate an initial product mapping in the store. In this variation, the method may be performed as an initialization process for launching a CV-based application within the retail environment. In another implementation, the method may be used periodically or continuously within an environment. For example, the method may be used selectively to resolve issues in a product location map, such as if the identity of a product at a particular location is unknown, if a product can't be identified (e.g., using a CV product classifier), and/or in response to other issues.

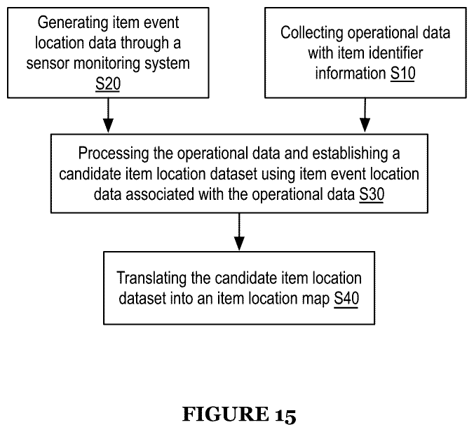

As shown in FIG. 16, in variations where the method uses a CV monitoring system, the method may include collecting operational data with item identifier information S10; generating item event location data through a computer vision monitoring system (S20), which comprises, collecting image data S22; detecting, by processing the image data with a computer vision processing model, item event location data S24; processing the operational data and establishing a candidate item location dataset using item event location data associated with the operational data S30, and translating the candidate item location dataset into an item location map S40.

The methods and systems described herein may be applied to any suitable type of item or object. The method and system may have particular applications in creating a map of where different products are stored within a store or shopping environment. Herein, references to product or use of a product as a descriptor may be used in place of item or object. The method and system are not limited to just products and may be used for any suitable type of items or objects, as would be appreciated by one skilled in the art.

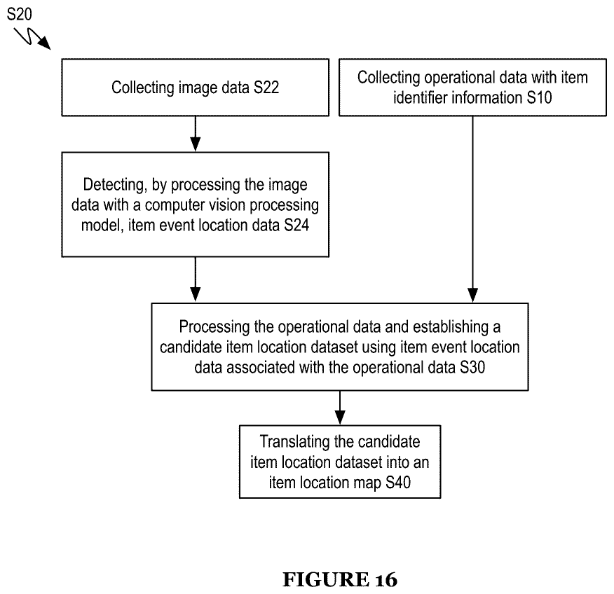

As shown in FIG. 17, a variation of the method applied to products, which may be stored/displayed at various places in a shopping environment, can include: collecting product identifier codes as part of product entry event data of an electronic device S410; collecting image data S422; generating, using a computer vision processing model, product event location data S424; processing the product entry event data and establishing a candidate product location dataset using product event location data associated with the product entry event data S430; and translating the candidate product location dataset into a product location map S440.

The method is preferably implemented such that the candidate product location dataset can be updated with multiple instances of paired product identifiers and location information based on product event locations.

In many instances, the candidate product location dataset will include data records for multiple product types and, optionally, substantially all product types tracked in the environment (e.g., all products sold in the store). Here “substantially” may be characterized as a majority of product types. In many implementations, the method can build a dataset to more than 90% or 95% of products having data records pairing their product identifiers to a location. In some variations, substantially all product types may be a set of products selected for tracking and monitoring through the method. By way of example, different sizes and types of stores could have thousands, tens of thousands, or more different product types. The candidate product location dataset can store data records to model locations of such volumes of different product types. Furthermore, the candidate product location data can store multiple data records for one product type for enhanced predictive capabilities. As such a candidate product location dataset, when being translated into a product location map for a store may have tens to hundreds of thousands and/or over a million data records (e.g., probable location markers) used in producing an updated and reliable product location map.

The modeling of the candidate product location dataset may generalize to addressing storage of a product in multiple locations, changes of product storage locations, introduction of product types, removal of product types, changing in the shelf space allocated to a product type, and/or other changes.

Additionally, the method preferably can collect multiple independent data records for the same type identifier. For example, one type of cereal (with a specific product identifier) may have multiple data records stored as probable location markers for that type of cereal—these data records may be cross-matched and used in predicting with high confidence (e.g., higher than 90%, 95%, or even 99% confidence) the location of the cereal.

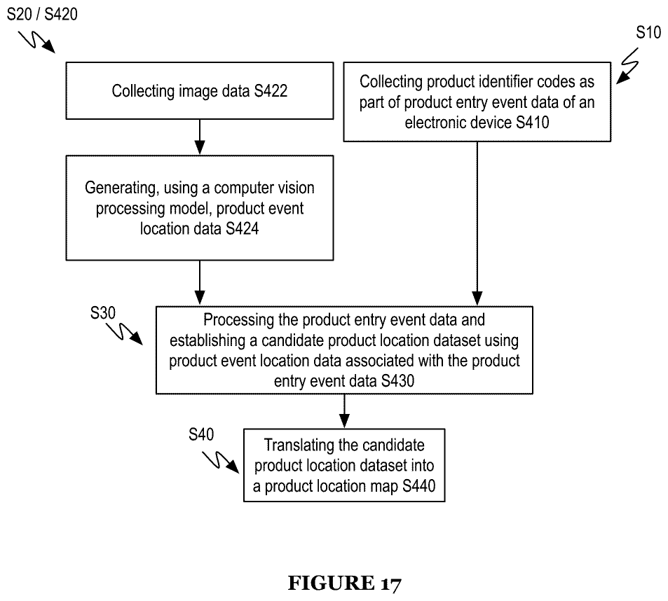

Accordingly, the processes of the method are preferably implemented in an iterative and repeated manner. As shown in FIG. 18, a variation of the method performed iteratively can include: processing a set of product entry event data and building a candidate product location dataset; wherein processing a product entry event data (i.e., an event instance of the set of product entry event data) comprises: identifying one or more associated product location events and storing, in the candidate product location dataset, a data record (e.g., a probable location marker) mapping a location property of the item location event with a product identifier of the product entry event data; and translating the candidate product location dataset into a product location map.

Processes S10 and S20 are preferably performed in connection with the method such that an iterative implementation of the method.

More specifically, as shown in FIG. 14, the method may include progressively updating a candidate product location dataset that stores a plurality of probable product location markers, which comprises multiple instances of: at an electronic device, scanning a machine-readable product code and reading a product identifier; at the electronic device communicating, to a computing device of an inventory monitoring system, the product identifier; at a set of imaging devices, collecting image data, wherein the set of imaging devices are configured to capture a field of view that includes product storage locations; detecting, using a computer vision processing model, product event location data at the product storage locations; at the inventory monitoring system, matching the product identifier to at least one product event location in the product event location data; and at the inventory monitoring system, updating the candidate product location dataset with a probable product location marker that associates a location property of the product event location and the product identity. When sufficient candidate product location markers are updated, the system and method may then translate the candidate product location dataset into a product location map.

In one variation, this iterative variation may be performed such that transaction event data generated by one or more POS terminal devices can be read and processed to match select items to corresponding product location events.

In another variation, this iterative variation may be performed, in one variation, such that transaction event data generated by one or more POS terminal devices can be read and processed to match select items to corresponding product location events.

The method may be implemented while incorporating one or more of the variations described herein.

A first exemplary implementation leverages data integration into transaction logs gathered by one or more checkout terminal devices (e.g., POS systems used for worker assisted scanning/code entry based checkout, self-checkout kiosks, and the like) in combination with sensor-based tracking of events that can be linked with individual. This implementation variation establishes associations between product identifying information in the transaction logs to event location data, where the event location data be associated with a location and time that is physically and temporally displaced from creation of transaction logs at a checkout terminal device.

A second exemplary implementation leverages receiving product identifying information gathered from operational data that occurs in proximity to item storage sites. This variation may incorporate more direct associations between extracted product identifiers and item locations using digital product scanners used during product stocking and/or inventory maintenance tasks.

As a third exemplary implementation, a method may be implemented that uses a hybrid of the two descriptions above as shown in FIG. 1.

Other alternative implementations may alternatively be used.

In a transaction log focused implementation, the method may be configured for leveraging transaction data and matching product identifiers from transaction logs to potentially associated product shelf events that were detected using computer vision (or other suitable sensor analysis). Transaction logs and product shelf events may be matched by one of a variety of association conditions. One exemplary association condition is when the transaction log and the product shelf event correspond to the same computer vision detected person. For example, a user detected in proximity to a POS terminal device at the time of the transaction log can be tracked and detected as being associated with one or more product shelf events. Other association conditions may also be used such as matching any product event within some time period as being associated with a product identifier of a qualifying transaction log and using the cumulative predictive capabilities of multiple markers in amplifying accurate locations and allowing inaccurate locations to be filtered as noise.

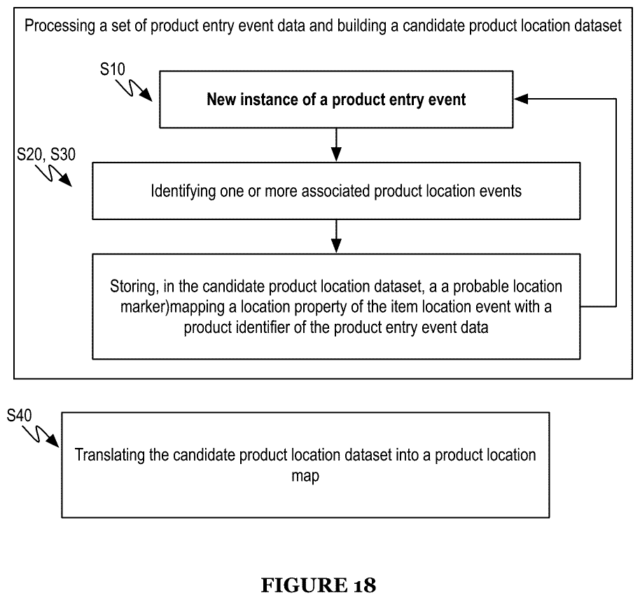

As shown in FIG. 19, a method variation for use with transaction data may include: at a point of sale (POS) terminal device, reading (scanning) a product identifier (e.g., scanning a machine readable code) S212; communicating, to a computing device of an inventory monitoring system, a transaction log that includes the product identifier and a timestamp S214; collecting image data S222; detecting, using a computer vision processing model, product event location data S224; identifying a set of product shelf events in the image event location data that satisfy an association condition for the transaction log S232; storing the set of product shelf events as probable location points of the product identifier in a candidate product location dataset S234; and translating the candidate product location dataset into a product location map S240.

Variations and detailed description of the methods and systems for such a variation are described herein.

In a product scanning focused implementation, the method may be configured for integrating with a product scanning device used when interacting with products near their storage location. Such a method variation can match product identifiers read or entered at a product scanning device to potentially associated product shelf events that are detected using computer vision (or other suitable sensor analysis) in association with a scanning event. In one exemplary implementation, a product is scanned (e.g., while stocking the product or during inventory tasks), this triggers a time window where changes in the image data in nearby product storage locations are associated with the scanned product identifier. Other alternative implementations can similarly be used.

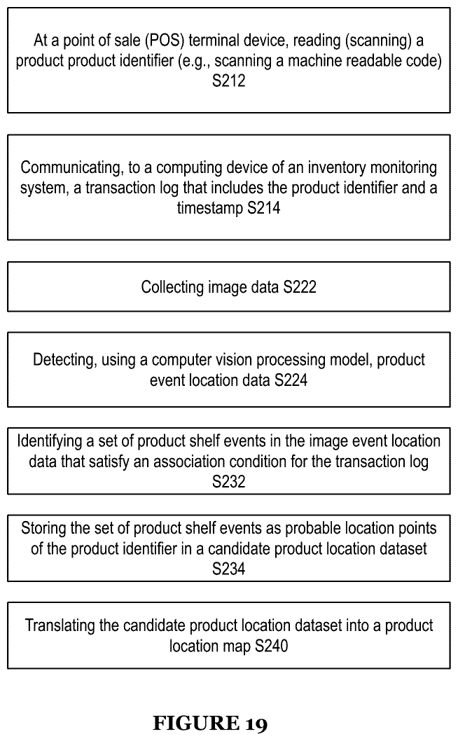

As shown in FIG. 20, a method variation for use with scanning event data may include: at a product scanning device, reading a product identifier (e.g., scanning a machine readable code) S312; communicating, to a computing device of an inventory monitoring system, the product identifier as part of a product scanning event S314; collecting image data during a defined product locating time window of the product scanning event S322; for the scanning event, detecting, by processing the image data using a computer vision processing model, a product shelf event S324; adding, to a candidate product location dataset, a probable location marker associating a location of the product shelf event to the product identifier S332; storing the set of product shelf events as probable location points of the product identifier in a candidate product location dataset S334; and translating the candidate product location dataset into a product location map S340.

Variations and detailed description of the methods and systems for such a variation are described herein.

Block S410, which includes collecting product identifier codes as part of product entry event data of an electronic device, and its related variations function to access empirical data that includes some portion of information that the operator would like to map to location information. Preferably the empirical data includes or is a product identifier that can provide high confidence verification of the identity of a product. The empirical data is preferably connected in association with a specific item of the product (e.g., scanning barcode of a particular product) or a group of the item (e.g., scanning a barcode for a supply crate containing the particular product. The product entry event data may be a single event but more preferably is comprised of multiple instances comprising, at a first electronic device, collecting empirical product identifier data during product processing event.

The product entry event data is preferably a form of operational data that may result from various operational activities in the environment.

One variation of operational data can include transaction data, which can specify product identifiers for products purchased in a retail environment. The transaction data may be provided as a transaction log. The transaction data preferably specifies records with properties that include a timestamp and a product identifier. In some variations, transaction data is organized by receipt data that can include multiple product identifiers and a time stamp for the combined purchase of the listed products.

In another variation, the operational data can include product scanning event data, which can specify a product scanning event where a select product is read. In some variations or instances, the method can leverage product scanning event data when a product is scanned in proximity to the storage location of the product and some action, and, in connection with the scanning event, some visually detected event occurs in the storage location of the product so that the product identifier can be mapped to the location.

In many instances, collecting product identifiers includes scanning, reading, and/or receiving entry (e.g., keying in of a product identifier) the product identifiers into the electronic digital device. For example, scanning a barcode, QR code, or any suitable machine-readable code and reading into the electronic device the corresponding product identifier. Alternatively, collecting product identifiers could include product identifiers resulting from user entry or input. For example, in some cases, a worker may enter the numerical code of a product identifier if it can't be read. Collecting product identifiers alternatively include interfacing with a data source of operational data. For example, transaction logs stored by a set of POS terminal devices may be stored within a database, and the transaction logs may be retrieved using a data interface.

There may be one or more electronic devices used in supplying product entry event data. Additionally, there may be one or more different types of electronic devices used. The electronic device preferably includes a scanner or reader (e.g., a machine code reader like a barcode or QR code reader).

An electronic device may be a point of sale (POS) terminal device in the case where the product entry event data includes transaction data. The POS terminal device can additionally perform checkout transactions and collects the product identifiers as part of building a receipt for a checkout transaction, the information of which is stored as part of a transaction log.

An electronic device may be a product scanning device in the case where the product entry event data includes transaction data. A product scanning device may be a mobile code reading devices. The product scanning device may include wireless communication to a remote computing system (e.g., an inventory monitoring system). The product scanning device may additionally include user interface input or outputs, which in some variations may be used to direct product locating processes or to provide feedback. In some variations, it may additionally interface with an inventory system, stocking system or other suitable system.

In many implementations, block S410 is implemented in connection with multiple electronic devices, each contributing to instances of different updates to the candidate product location dataset.

A product identifier may be any suitable code for a product. It generally will be an alphanumeric code that identifies a particular SKU item that is tracked and/or sold within the environment. The product identifier may be a code used by a point-of-sale system in identifying products and accessing product information. A product identifier could be a SKU (stock keeping unit) identifier, PLU (price look-up) code, a UPC (universal product code), an ISBN (International Standard Book Number), and/or any suitable type of product identifier.

The product entry event data will generally include a timestamp or other type of time property associated with a product entry event (e.g., time of a transaction log or a product scanning event).

The product entry event data may additionally include an association to a location. In a transaction related example, the POS terminal device location may be recorded and/or detected as part of the transaction log. In a product scanning example, the method may include detecting location of the product scanning device. This may involve using a location sensing element on the product scanning device (e.g., GPS, RF triangulation, or other forms of location sensing). This may alternatively include processing collected imaged data and detecting location of the product scanning device. In some instance the product scanning device may include a visually identifying marker (fiducial marker) or may emit an identifying signal.

In some variations, product entry event may additionally be associated with a person. In the case of transaction data, a transaction log may be associated with a customer identifier. The customer identifier may be associated with the receipt data based on a loyalty card, credit card information, and/or other customer associated information collected in association with a transaction. A person may alternatively be associated with product entry event by detecting, through processing of the image data, a user present in proximity to the site of the product entry event. For transaction data, the method may include using computer vision analysis of image data associated to detect a user (e.g., a customer) in proximity to the POS terminal device at the time of a checkout interaction that is associated with the transaction log.

Collecting the product entry event data, in one variation, is performed in a batch. The product entry event data or a subset of product entry event data can be accessed, retrieved, or otherwise obtained and then supplied to block S430 for processing. For example, weeks of transaction log data may be uploaded and submitted for processing.

Collecting product identifiers, in an alternative variation or instance, is performed in real-time or substantially real-time. Such a variation may responsively process product entry events as they happen. Herein, real-time can be characterized as a process of collecting transaction data in response to new transaction data. This variation may be performed when the system implementation includes communication integration with the checkout systems (e.g., the POS terminals) used within the retail environment. This variation may be used for updating and refining product location map as data becomes available.

Collecting product identifiers as part of product entry event data is preferably performed as a parallel process to processing image data in block S420. While the collection of product identifiers data is used to organize data records to be used as an empirical data source, the processing of image data is used to find potentially related environmental information identifiable through image data or other sensing technologies. The processing of image data can be performed independent from collection of transaction data. The processing of image data may alternatively be responsive to and performed in connection with a specific product entry event. The sequence and ordering of processes involved in processing image data and collecting transaction data can be architected in a variety of ways.

The method preferably includes a generating product event location data through a computer vision monitoring system (S20), which functions to use sensor-based approaches to interpreting activity at product storage locations. The product event location data is derived from events (at a storage location of a product) that either naturally or artificially relate to a product entry event. For example, when an item is purchased, there is naturally some event where the product was picked up by a customer at some location in the store. In another example, a product scanning event may be used in connection with an artificially contrived event where the operator of the product scanning event performs some action that can be registered as the location of the just-scanned product.

Generating product event location data through a computer vision monitoring system can include collecting image data S422; and generating, using a computer vision processing model, product event location data S424.

Product event location data (alternatively characterized as image event location data) is preferably a data set stored within some data system that records detected image activity (changes, gestures, interactions, etc.) related to placement location of products in the environment. Product event location data can record different CV-detected events such as detected change in a storage location, detected user-item interaction, detected user within an interaction distance from items, detection of a location marker, or other CV detected events related to location.

In some implementations, various product events may be tracked continuously, and the resulting data set can be used by the method. Different product events may be detected across the environment. Furthermore, such events may occur simultaneous and at different locations.

Alternatively, some implementations, may perform image analysis in response to specific tasks. For example, select image data from an environment (e.g., from a specific camera, during a select time period) may be processed in response to some product entry event (e.g., scanning of a product).

Location information from a product event can be stored with an association to a time and location properties. The form of the location information can vary depending on implementation and objectives.

In one location variation, the location information can be image data location, wherein the location is specified as a location within image data of one or more cameras.

In another location variation, the location information can be spatial coordinates either within a global coordinate system, an environment global system, or relative to some other coordinate system. The spatial coordinates in some implementations, can be two dimensional (e.g., location within the footprint of an environment). three dimensional (e.g., location in 3D space).

In another location variation, the location information can be a descriptive location which may define the location according to a custom format. For example, location within an environment may be parameterized by how locations are specified in that environment (e.g., section, aisle, shelf, row, column, bin, space, and/or other suitable descriptors). For example, the location of some product may be analyzed and assigned a location descriptor of aisle 3, shelf two, column 5.

In one variation, the method may include marking storage units (e.g., equipment for storage like shelves, racks, or bins) with visual identifiers that can be recognized from processing the image data. These visual identifiers may mark different descriptive locations or may be used in defining a custom location coordinate system. In one implementation, shelves may be marked with an array of visual identifiers. Then the method may include detecting the array of visual identifiers and translating the arrangement and identity of the visual identifiers into a location grid used in assigning location properties for product events detected in the image data.

Block S422, which includes collecting image data, functions to collect video, pictures, or other imagery of an environment. The image data is preferably captured over a region expected to contain objects of interest (e.g., inventory items) and interactions with such objects. Preferably, time coverage of the transaction data and the image are for overlapping periods of time. Image data is preferably collected from across the environment from a set of multiple imaging devices. Preferably, collecting image data occurs from a variety of capture points. The set of capture points include overlapping and/or non-overlapping views of monitored regions in an environment. Alternatively, the method may utilize a single imaging device, where the imaging device has sufficient view of the exercise station(s). The image data preferably substantially covers a continuous region. However, the method can accommodate for holes, gaps, or uninspected regions. In particular, the method may be robust for handling areas with an absence of image-based surveillance such as bathrooms, hallways, and the like.

The image data may be directly collected and may be communicated to an appropriate processing system. The image data may be of a single format, but the image data may alternatively include a set of different image data formats. The image data can include high resolution video, low resolution video, photographs from distinct points in time, image data from a fixed point of view, image data from an actuating camera, visual spectrum image data, infrared image data, 3D depth sensing image data, parallax, lidar, radar, sonar, passive illumination, active illumination, and/or any suitable type of image data.

The method may be used with a variety of imaging systems, collecting image data may additionally include collecting image data from a set of imaging devices set in at least one of a set of configurations. The imaging device configurations can include: aerial capture configuration, shelf-directed capture configuration, movable configuration, and/or other types of imaging device configurations. Imaging devices mounted over-head are preferably in an aerial capture configuration and are preferably used as a main image data source. In some variations, particular sections of the store may have one or more dedicated imaging devices directed at a particular region or product so as to deliver content specifically for interactions in that region. In some variations, imaging devices may include worn imaging devices such as a smart eyewear imaging device. This alternative movable configuration can be similarly used to extract information of the individual wearing the imaging device or other observed in the collected image data.

Block S424, which includes generating, using a computer vision processing model, product event location data, functions to generate image-based information from the image data. Generating product event location data can include performing CV processing of the image data and/or any other suitable type of automated image analysis. Generating product event location data may additionally include retrieving labeling of image data, which may include supplying image data to a human labeling tool for human-assisted labeling of the image data. Human labeling of the image data may be triggered by CV detected events such as detecting image data where a customer may be interacting with a product so that item-pickup events can be labeled with time and shelf-position of the item-pickup event.

Generating product event location data may be performed in real-time in response to the occurrence of some event like a person moving through an environment, a person performing some action, the state of a product on a shelf changing, and/or any suitable state of the image data. If transaction data is additionally collected and processed in substantially real-time, a product location map can be updated with low latency (e.g., accurate as of 5-15 minutes). Alternatively, generation of product event location data may be performed asynchronous to the occurrence of the related event. For example, image data may be collected and then transformed into product event location data at a later time.

The product event location data may use a variety of image-detected signals. Customer tracking, customer-item interactions, shelving changes, and/or detection of a shelf space indicator are four exemplary image-detected signals that may be used.

Various techniques may be employed in processing image data using computer vision processes or models such as a “bag of features” object classification, convolutional neural networks (CNN), statistical machine learning, or other suitable approaches. Neural networks or CNNS such as Fast regional-CNN (r-CNN), Faster R-CNN, Mask R-CNN, and/or other neural network variations and implementations can be executed as computer vision driven object classification processes or models that when applied to image data can perform detection, classification, identification, segmentation, and/or other operations. Image feature extraction and classification and other processes may additionally use processes like visual words, constellation of feature classification, and bag-of-words classification processes. These and other classification techniques can include use of scale-invariant feature transform (SIFT), speeded up robust features (SURF), various feature extraction techniques, cascade classifiers, Naive-Bayes, support vector machines, and/or other suitable techniques. The CV monitoring and processing, other traditional computer vision techniques, deep learning models, machine learning, heuristic modeling, and/or other suitable techniques in processing the image data and/or other supplemental sources of data and inputs. The CV monitoring system may additionally use human-in-the-loop (HL) processing in evaluating image data in part or whole.

In the variation with customer tracking, a customer (or more generally a person or “agent”) is tracked within the environment. Tracking a customer can involve performing continuous tracking. Tracking a customer may alternatively involve periodic detection of location of a customer. Preferably, CV-based person tracking is used for tracking multiple people within the environment. Alternatively, human labeling can be used for manually associating one or more images of a person with an identifier. Customer tracking can be used to link particular potential product locations to a product identifier from an empirical data source.

In one implementation, a set of product locations may be generated for any location within some interaction distance from a user. For example, if a user walked down aisle 2 and 4 then all those storage locations may be marked as potential locations of the single product that they purchased which was identified in a transaction log.

In another implementation, customer tracking may be used to isolate the number of customer-item interactions to those that relate to a customer that is also associated with a transaction log. For example, only the item-pick up events detected for the user that was at the POS terminal device at the time of checkout may be selected in S430.

In a variation with customer-item interaction detection, generating image event location data can include processing image data with a customer-item interaction classifier model and detecting a customer-item interaction event. This can be used for detecting the occurrence of events like an item-pickup event but may also be used for item-put-backs and/or other interaction events. The detection of a customer-item interaction event preferably determines the location within the environment where the interaction occurred. It may more specifically detect and specify 3D position or shelving position where the interaction occurred, which will presumably be where a product was stored. This may be used in tracking which products were selected a customer. In another variation, human-assisted labeling of image data may be used for detecting or labeling of customer-item interaction events or properties of such events. In some implementations, product shelf position may not be used, and location could be specified as a floor location, which functions as a 2D or 2.5D (e.g., when multiple floors) mapping of location.

In some implementations, additional sensors may be used in facilitating customer-item interaction detection. A second sensing system may trigger some item storage change at particular location. In some instances (such as product scanning variations), this may all that's needed. In variations, where association with a customer or user is used to link it to a corresponding product entry event, the CV monitoring system can then detect one or more users in proximity to the event location and track the user.

In another variation, generating image event location data can include processing image data and detecting changes in product shelving, which functions to detect when placement of a product on a shelf is changed. Detecting changes in a product shelving preferably detects the removal of a product, which can indicate an item-pickup event. Detecting changes in product shelving may additionally include item movement, placement, and/or other changes.

Detecting changes in product shelving may be performed independent of any customer tracking. Detecting changes in product shelving preferably implements a CV-base image processing sequence for monitoring the status of stored products within an environment. In one variation, processing of image data can include removing foreground objects of image data with product shelving, which may function to remove humans, carts, and/or other foreground obstructions. Removing foreground objects may include performing a time windowed averaging of image data. For example, averaging pixel values over five or 10 minutes will remove most customers browsing a store. Longer time windows may be used to also filter out foreground objects like dollys or other temporary objects that may be present in one location for longer durations. The result of removing foreground objects of the image data can be shelving isolated image data. Processing of the image data can then include a subsequent stage of detecting changes in the shelving isolated image data, where changes in shelving can be detected overtime. Accordingly, detecting product event location data may include removing foreground objects of the image data thereby forming background object image data, and detecting changes in the background object image data.

Detecting changes in product shelving may detect a region of the shelf where there was a change. In one variation, automated analysis of the image data can be used for classifying the shelving position so that location may be stated a more contextually relevant manner such as a labeling a location. For example, a location such as aisle 3, shelf 3, position 12 may be specified for where a change happened.

In connection with detecting changes in product shelving, image data of a product can be collected and stored at the region where a change occurred. The product image may be collected from image data prior to when a product was removed or after a product was placed. Once a product identifier can be associated with that position and product, the collected image data may be used in training a CV product classifier model. Similarly, product images extracted from the image data may be processed for various monitoring tasks (to detect potential changes in stocking) and/or validation tasks.

In a variation using product scanning event data (e.g., stocking data), generating image event location data can include processing image data and detecting a shelf space indicator. The shelf space indicator can be a physical marker recognizable by the CV system. In one variation, the shelf space indicator could be an object with a machine-readable code or a distinct object recognizable by a CV system. In another variation, the shelf space indicator could be an active indicator that can be activated in connection with collection of stocking data. For example, in response to scanning of a new product, the shelf space indicator may activate signaling to a CV monitoring system that the location of the marker should be collected. The shelf space indicator may be positioned stationary. In another variation, the shelf space indicator may be used by a user to indicate a region of space associated with a product. For example, after scanning a product, a worker may wave the physical marker over the shelving space in which the product is stocked.

In one specific stocking implementation variation, a stocking procedure may map digital scanning of product barcode information to a computer vision detected product location. In one variation, a fiducial marker or other suitable CV detectable object/marker may be positioned at the shelf location for a product in coordination with scanning of the product. The method can automatically establish an association between the product identifier and the shelf location.

Block S430, which includes processing the product entry event data and establishing a candidate product location dataset using product event location data associated with the product entry event data, functions to coordinate pairing of product identifier(s) with one or more product event locations. Block S430, additionally functions to generate a dataset showing potential relationships between the product entry event data and image-detected product event location data.

The candidate product location dataset can model potential relationships between product identifiers (determined from product entry event data) and locations in the environment (determined at least in part from the image data). Accordingly, the candidate product location dataset will generally store locations in association with a product identifier. A candidate product location dataset is preferably comprised of a plurality of data records that associate location and a product identifier. Herein, the data records may be stored as probable location markers which are data points/predictors of potential locations for a product identifier as determined by an instance of pairing a product entry event and image-based event location.

The candidate product location dataset is a data model maintained within one or more data system. In one exemplary implementation, a probable location marker can be stored as a database record that stores or includes a reference to a location property and product identifier.

The format of the probable location markers may be stored in the dataset for vector/spatial calculations such that queries of the candidate product location dataset can find nearest neighbors, measure proximity, perform spatial averaging (e.g., mean, mode, median averages of product predictions in relation to a particular location), apply various forms of proximity filtering or proximity weighting, and/or perform other spatial calculations. The location markers may be indexed by location and product identifier for responsive search and analysis.

In some variations, the probable location marker can additionally store a time property, which may note the time when the marker associated with its creation. The time property may be used in time weighting the marker when assessing product location predictions. The time property may be used for other uses as well such as expiring the marker after a certain time.

In some variations, the probable location marker can additionally store a confidence score or another type of evaluation score. The confidence score may signify the confidence in the prediction, which may be based on the conditions leading to its prediction. In some cases, such as a product scanning event, a resulting probable location marker can be of high confidence. In other cases, such as if a product identifier from a transaction log is potentially mapped to 4 potential locations, those may have lower confidence since, in most cases, only a single one of those locations would be correct. A confidence score could be used in weighting a marker's location predictive value during “clustering/consolidating” when outputting a product location in block S440.

In some variations, the locations may additionally or alternatively be scored in other ways (e.g., as an alternative version of a confidence score or as an additional score used in evaluation). The score could indicate a class of association. For example, some associations may be classified as a strong classification if there is a 1-to-1 correspondence between the image event location record and the purchase instance for product identifier or a weak classification if there are multiple possible image event location data records that may correspond to a purchase instance of the product identifier.

The probable location markers are preferably built up over multiple instances of different product entry events. In time, there are preferably multiple probable location markers for each product. For an environment with over ten thousand SKUs, this may result in over hundred thousand probable location markers that are continually updated.

In some implementations, a candidate product location dataset is stored for a specific environment. For example, each store can have its own candidate product location dataset. In some scenarios, such as for related stores with similar layout plans, a candidate product location dataset may use a dataset of one or more stores or may merge datasets. This may be used in augmenting product location predictions using an outside environment candidate product location dataset. Such outside environment datasets will generally be weighted to deprioritize the impact of its probable location markers, but they could be used reinforcing or negating lower confidence location predictions in certain situations such when there is little data. For example, when a new cereal is introduced, a store A may have several instances where markers are added to indicate that it is stored in a cereal aisle. If a store B just received this new cereal, then it may more quickly provide high confidence predictions of storage in the cereal aisle.

The method is preferably robust against the candidate product location dataset including incorrect associations. With sufficient product entry event data that includes multiple observations of purchases involving the same product identifier, accurate associations of event location data and a products identifier can be amplified and incorrect associations deamplified during block S440.

Establishing candidate product location dataset using the product event location data associated with the product entry event data preferably includes identifying associated image-based product events for a particular product entry event (e.g., a segment of transaction data or a particular product scanning event). Temporal properties, customer-association properties, timing and/or location sequencing of events, and/or other techniques may be used for determining an association. Various systematic approaches to processing records of the product entry event data may additionally or alternatively be used in facilitating the identification of an association.

In some instances, a single product identifier from a product entry event data record will be matched to a location of a product event from the product event location data. In response, a single probable location marker can be added to the candidate product location dataset. In other instances, a single product identifier from a product entry event data record can be matched to multiple locations of different potentially related product events from the product event location data. In response, multiple probable location markers can be added to the candidate product location dataset. The confidence scores can be adjusted to reflect the uncertainty in mapping between product identifier empirical data and the location of the product related to that particular event (e.g., transaction or product scanning).

Transaction data and product scanning event data may be processed in various ways. However, exemplary approaches that may be useful for a particular type of operational data are described herein. However, such variations may be adapted and applied in other scenarios.

Transaction data may be processed to pair product identifiers (identified during checkout transaction data) to possible places where the items were located. The method can be configured to address the various challenges in making such pairings such as selective processing of transaction data and/or selective processing of product identifiers within receipts, batch processing (e.g., for identifying unions for shared product items), scoping or filtering product event locations by properties of a transaction, and/or other suitable techniques.

Processing the transaction data preferably includes individually processing records of the transaction data. In one variation, the transaction data is organized by receipts, where each receipt includes a set of product identifiers (one product identifier for each line item). These receipts (i.e., the transaction data) and the included product identifiers may be processed to associate one or more product event location data record with a product identifier.

In some variations, the receipts may be selectively processed for scenarios to isolate associations between a product identifier and image event location data records, which functions to strategically leverage situations where it is easier to determine strong associations. Receipts with particular characteristics may be processed because of the conditions of the receipt to better signal an association between a product identifier and image-based data. In this way, processing transaction data can include selectively processing a select transaction data record that satisfies a mapping condition. The mapping condition can be one or more different conditions.

In some variations, a select transaction data record may be selectively processed by one of a set of different mapping processes depending on the properties of the transaction data record. For example, a transaction data record of a checkout receipt with one product identifier never before processed may be processed differently from a second transaction data record of a second checkout receipt with 4 different products that have previously been seen multiple times.

In one exemplary implementation, records for single item transactions are selected for processing. Single item transactions may be used to better signal an association between some image-detected event and a product identifier. For example, if a customer associated with the purchase of one box of cereal is detected to perform only one item-pickup interaction, then the association between the product identifier of the box of cereal and the location of the item-pickup interaction will be a strong indicator of the location of the product.

In another exemplary implementation, receipts that include a set of products but with only one product that has no or low location data (e.g., few or low confidence probable location markers) may be processed since that product with little location data may be better located. Location data of other product identifiers can be used on the receipt to reduce potential product event location data records. As an example, a receipt may be processed that includes a first product with no location information and a second product with high confidence location information (based on previously determined location modeling). There may be two item-pickup interactions performed by the customer associated with the receipt. In this situation, one item-pickup interaction can be associated with the location of the first product with high confidence by eliminating the location of the other item-pickup interaction if it is at the expected location of the second product.

As another variation, selected collections of receipts may be processed in combination. For example, a set of receipts including a new product may be processed in combination. The union of locations for item-pickup interactions between those multiple receipts can be used to specify a candidate item location.

Establishing a candidate product location dataset using the product event location data associated with the transaction data preferably includes identifying associated product event location data for a given segment of transaction data, which functions to determine at least subset of product event location data records to link with one or more product identifier. In the case of transaction data, the candidate product locations can represent a noisy set of potential locations for different instances of a product being purchased. When the product event location data includes item-pickup events, this may be used to identify potential item-pickup events that could potentially have been associated with that product identifier. Patterns in timing and/or customer proximity are two preferred approaches for signaling an association. As discussed above, potential associations can be revised based on other information like known locations of other products on a receipt.

Identifying associated product event location data can be done using temporal scoping (i.e., using a temporal association) and/or customer scoping (i.e., using a customer association shared).

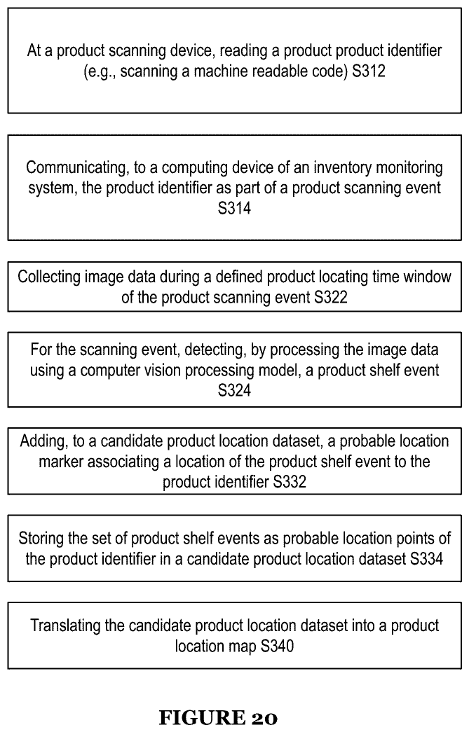

Temporal scoping preferably identifies product event location data that satisfies a temporal condition for a given transaction record as shown in FIG. 21. In one implementation, identifying associated product event location data includes selecting image event location records that occurred within a defined time window before a transaction record. For example, a product purchase can be associated with all item pick up events that occurred 10 minutes before the purchase of the product. While this may include many inaccurate associations, multiple observations of purchases of the product can reveal high confidence predictions for product location during block S440.

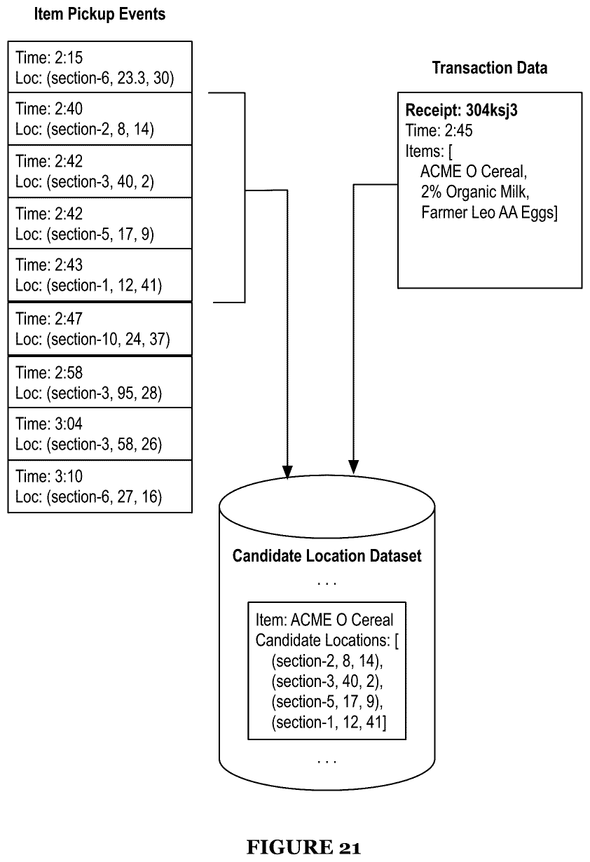

Customer scoping (or more generally user scoping) preferably identifies product event location data that is associated with one or more customer (or other agent entity like a worker) that is associated with a transaction record. In one variation, customer scoping is used to associate image event location records that are associated with the same customer associated with a transaction record as shown in FIG. 22. CV or image labeling of image data can be used in matching a customer to a specific transaction record. For example, item pickup events for one customer may be used as candidate locations of a product purchased by that customer.

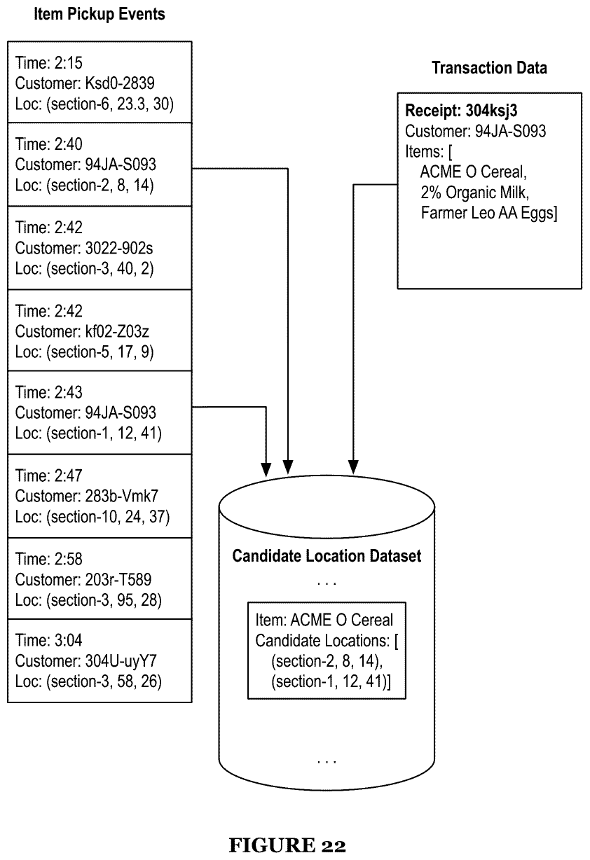

Customer scoping can be extended to situations where a one-to-one mapping of person and transaction record is not available. As shown in FIG. 23, a set of people in the vicinity of where a transaction occurred may be considered as potential customers and all associated image event location records of those people can be mapped to one or more products of a receipt transaction.

Customer scoping may use person tracking to determine the set of associated image-detected events. Customer scoping could alternatively use instances of customer detection. For example, one implementation of the method may not involve tracking of customers but may instead detect and associate an identifier of a customer for each customer-item interaction. In this way, all customer item interactions can be determined for a given customer.

As discussed, different variations of the method may use different types of product event location data. Examples of product event location data can include customer location tracking data, customer-item interaction event data, and/or shelving change data.

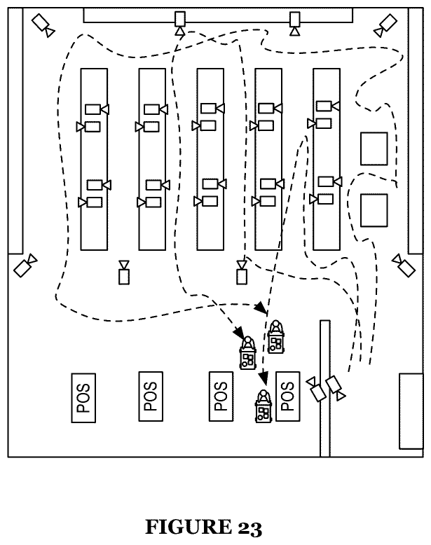

In a variation with customer location tracking, all locations along a customer path may be stored as a candidate location for a product purchased by that customer. Customer scoped selection of customer paths is preferably used. As shown in FIG. 24, the overlap of multiple paths of customers purchasing one shared product can be a signal for the location of that product. As an exemplary scenario of this technique for identifying the location of a product using the intersection of customer paths, one customer purchases milk and a box of cereal, and a second customer purchases various other products and the same type of cereal. Any overlap of the paths of these two customers could be a candidate location for that type of cereal assuming the cereal is positioned in one location. If there is only one region of overlap, then that is a strong signal for the location of the cereal. Extending this exemplary scenario over many customers and many different transactions, the location of the cereal box could be determined with high accuracy even if that cereal is stored in multiple locations. In a description of data modeling implementation, a series of probable location markers for a product may be stored along the path (or alternatively, the path itself may be stored as the location property). During inspection of the candidate product location dataset, intersection of paths that share a common product identifier can indicate a likely location of the product.

Further analysis of the customer paths can be used to clean the data. In one variation, customer position and or motion that are unlikely to correspond to any product locations may be removed such as when the customer is walking down the middle of an aisle. This may be used to filter a customer path to positions when potential item interactions could happen.

In a variation with customer-item interaction events, labeled interactions like item-pickup events may be selected that have some potential relationship with a transaction record. In a temporally scoped variation, all item-pickup events within some time period can be associated with a product identifier. In a customer scoped variation, item-pickup events involving the customer associated with the transaction record may be associated with a product identifier.

In another variation with shelf change events, regions where there were changes in product shelving can be as selected as having a potential relationship with a transaction record. In a temporally scoped variation, all shelving changes that happen within some time period can be associated with a product identifier. In some variations, shelf changes at locations where the product can be automatically detected and/or where a product is mapped to that location with high confidence may be ruled out. If customer tracking is additionally used, then a customer-scoped association may be used where shelf change events can be considered if they happened when a transaction-associated customer was nearby at the time of the shelf change event. In this way, shelf changes far from the customer will not be candidate locations for a product identifier.

Alternative approaches may be used for processing product scanning events. In many scenarios of the product scanning event, the scanning of the product identifier occurs near the storage location of the product and is performed by someone who is performing some task related to the product or the location of the product, such as stocking the product, updating price information of the product, marking location of the product, and the like. In one example, such product scanning events may result from stocking data.

In a variation using product scanning event data, location information associated with a visual detection of an activity, or an identifier can be used to ascertain the location of a product can be selected for association with scanned product information (e.g., using a barcode scanner). In this variation, a one-to-one association may be established based on sequence or timing of events (i.e., using temporal scoping).

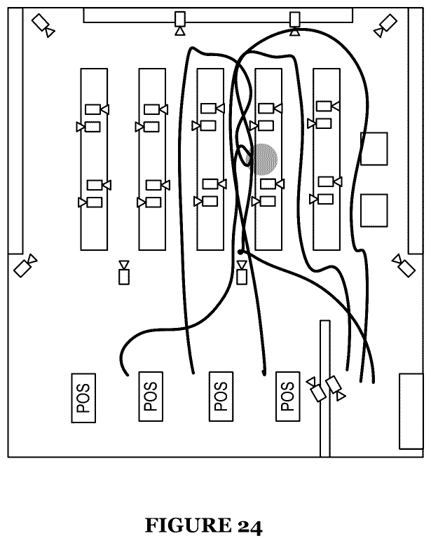

In one implementation, shelf space indicator can be used as a visually detectable identifier. This could be a static identifier. It may also be the product scanning device itself. A worker following a standard stocking procedure using the shelf space indicator may facilitate matching of product identifiers to locations. As one example, a worker may place a shelf space indicator (a visually detectable signal) at a product's position on a shelf and then manually scan the associated product using a barcode scanner. The timestamp of the UPC scan can be paired to the location of automatically detected shelf space indicator at that time. As another example shown in FIG. 25, a worker can pick up an item and scan it, place the shelf space indicator on the item position, then replace the shelf space indicator with the product, and then move on to the next item. In one variation, multiple locations or a region of shelf space may be indicated. For example, a worker could scan a product and then place a shelf space indicator in multiple locations on a shelf. Each location captured can similarly be associated with the initially scanned product.

In a related variation, the method may automatically detect the location to associate with a product scanning event. This may be done by detecting a product event such as a pickup or place-back interaction/gesture, detecting a change in the product display image data (by analyzing background image data), and the like. For example, a worker may scan a product, then placing the product on the shelf during a time window after scanning may be detected because of a change in the image data of the shelved products.

In one variation, the method may include detecting location of the product scanning device at the time of a product scanning event. This may be used by using sensing location using GPS, RF triangulation, or other forms of location sensing. The location of the product scanning event may alternatively be detected and determined by processing image data and detecting the presence of the product scanning device. For example, a device visual identifier (passive or active) may be displayed and then detected.

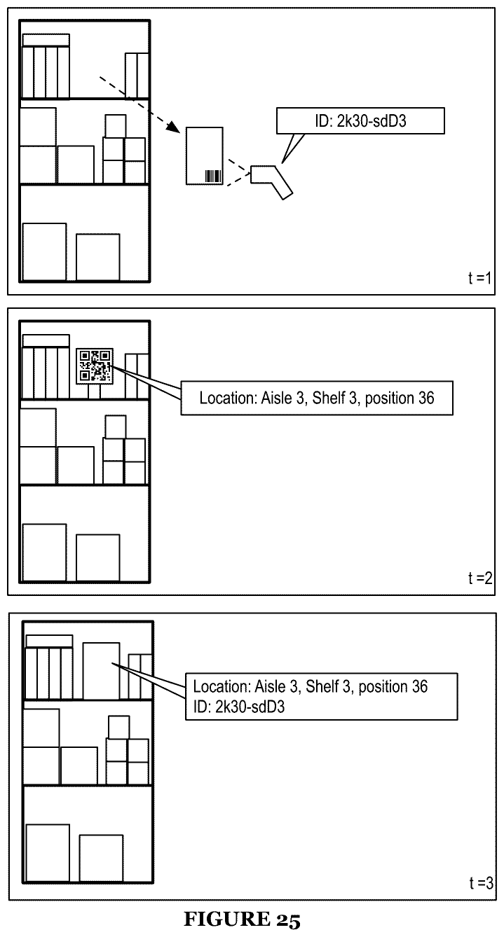

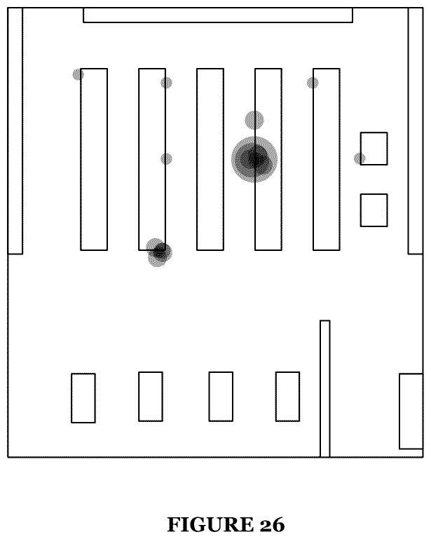

Block S440, which includes translating the candidate product location dataset into a product location map, functions to analyze the candidate product location data set to detect patterns. Translating the candidate product location dataset into a product location map preferably leverages analysis of candidate product location data from multiple, independent instances of processed operational data. Patterns in candidate product locations (stored in the form of probable location markers) from different transactions or product scans can indicate with high confidence that a location is associated with the product identifier. If a product is stored at two locations like if a type of cereal that's stored in the cereal aisle but also at a promotional endcap (at the end of another aisle), then both locations will be reinforced with sufficient instances of operational data as shown in FIG. 26. Candidate locations for a product can quickly be removed and not included in the product location map. In this way a product location map can be generated with high accuracy. As shown in FIG. 26, the product location map can characterize 2D environment position, but may alternatively create a product location map with 3D mapping, descriptive locations, or other formats for representing locations. As shown in FIG. 27, the product location map can similarly resolve specific product locations on a shelf. The product location map is preferably a data model that may be used. In some cases, the product location map may be a data model that can be queried and used.

Translating the candidate product location dataset into a product location can be used in outputting various results.

In one variation, the method involves outputting a product prediction for a given location. A data request can be received and processed with location descriptor. It could be a point, a region, or any type of descriptor related to location in the environment. In response, the method can involve querying the candidate product location dataset synthesizing probable location markers in proximity to the location descriptor and identifying a product prediction. For a point location, this can involve accessing nearby location markers and scoring them to determine a prioritized list of product predictions. For a region, this may involve accessing location markers within the region and optionally within some distance threshold from the region and scoring them to determine a prioritized list of product predictions. The location markers can be distance weighted such that those nearer the location descriptor are valued more. The location markers may additionally be time weighted such that more recent location markers may be given more value than older location markers. Additionally, the scores of the location markers may additionally be incorporated into the product prediction.

A single product may be output. Alternatively, a list of possible products may be outputted along with their associated confidence scores (or other suitable metrics). In cases, where a region is queried, then there may be a list of products contained within that region. In one example, a whole aisle could be queried, and the result could be a list of all products predicted to be in that aisle.

In another variation, the method involves outputting a full product location map with data on product location predictions for an entire environment product prediction for a given location. This can use similar techniques above, where product predictions are generated for locations across an entire store. In some variations, clustering of location markers may be used to determine regions where a product is displayed. Other suitable forms of analysis may alternatively be used.

In another variation, the method involves outputting a likely location or locations for a queried product identifier. In this variation, a product identifier is received as part of a data query. In response, location markers associated with the product identifier are accessed, and the clustering of the location markers is analyzed to determine predicted locations. These clusters can be scored using confidence scores, time weighting, and other aspects like the number of location markers to determine confidence of a product being located at a storage location. Clustering of large number of recent high values location markers will generally indicate a likely location. This location reporting may additionally include inspecting location markers are similar locations to determine if other location markers indicate other products are more likely to be located at a storage location. For example, if a product was recently moved, newer location markers of a different product may indicate that this location is no longer being used.

The translation of candidate product location dataset into a product location map may be continually performed. Product placement may be constantly changing as products run out, new products are introduced, seasons change, and/or as the result of other changes within the store. The translation of candidate product location data into a product location may include decaying or weighing information by recency, which preferably involves amplifying (or otherwise emphasizing) recent data and/or deamplifying (or deemphasizing) older data. Seasonal patterns may additionally be factored into the modeling and updating of the product location map. As another variation, data from other environments (e.g., other retail locations) may also be used in refining or supplementing a product location map and/or the candidate product location data. These and other techniques may be used to make the method resilient to changes in product location.

The method may additionally apply the product location map for various applications. The product location map may be used as an automated planogram. The product location map may be used to augment a CV monitoring system by supplying expected product identity for a given location in the environment. The product location map may also be used in various operational tools such as detecting when inventory is low, when products are misplaced, and/or other. Other related inventory analytical tools may also be combined with such a product location map. For example, a service could monitor shelving tidiness and pair that with the product location map for reporting the shelving tidiness of specific products. As yet another application, the product location map can be used in the automated collection of image data for a given product and training or updating of a CV model with image data that is automatically labeled through this method. As another application, the product location map can be used in various interactive features. For example, a searchable product map of a store could be generated and used to provide highly detailed directions for finding specific product.

As one example, the product location map can be used in enabling a dynamic and self-updated map. A product location map can be presented as a viewable digital map within a user interface. Users could zoom in and out and see locations of different products. This may be used in providing automated store navigation instructions. For example, given a shopping list an optimized path through the store can be presented using the product location map. A digital product location map may also be queried and searched. Searches can use inspection of the candidate product location dataset or use a pregenerated product location map.

As another example, the product location map can be used for inventory alerts such as out of stock alerts, misplaced item alerts, alignment with product layout objectives, and the like.

As a related example, analysis of the candidate product location map may additionally or alternatively be sed in reporting on the state of a product location map. Locations with low confidence/data can be reported, new products can be detected, products with low confidence location data can be reported, and/or other conditions can be detected. In some cases, alerts may be trigged so that various actions like product scanning events can be performed to facilitate resolution of the issues.

As another example, the product location map may enable highly accurate 3D product mapping capabilities within a retail environment. This may be used in combination with augmented reality (AR) computing devices to enable various AR or other types of digital experiences based on relative position of a device (or user) with the products. For example, product information can be overlaid as an augmented reality layer, where positioning of the overlay is based in part on the product location map.

As another example, the product location map may be used in various CV-based applications. CV-based applications can include store monitoring services, operational-focused applications, customer-focused applications, and/or other forms of CV-based applications.

In particular, the method may include, as part of analysis of an automated checkout system, detecting a user-item interaction event, and for a location of the user-item interaction event querying the product location map (or alternatively the candidate product location dataset) in determining a product identity.

In some variations, computer vision identification of products may be used within the method to augment creating and/or maintaining a product location map.

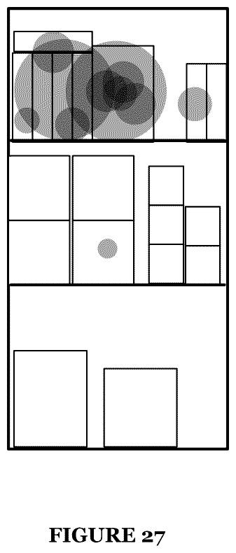

In one variation, CV product classification of the image data may be used in validating product identification. In some cases, the product map may be used as a check to validate CV product classification. In other cases, the CV product classifications may be used as a check to validate the product location map. In such a variation, the method, as shown in FIG. 28, may further include querying the product location map for the product identity at a first location; determining, using a computer vision product classifier model, a computer vision product identify at the first location; and comparing the map product identity to the computer vision product identity. If a result of the comparison matches, then the confidence in the CV product classification and/or the product location map may be validated. If the result of the comparison indicates misalignment, then some action may be initiated to resolve the issues. Misalignment could result in updating of the CV product classifier model. Misalignment could result in updating the related location markers for lower confidence or issuing some alert to resolve an issue with the product location map.

In another approach that doesn't use product classification, background image changes can be monitored through periodic inspection of the image data. In particular background image changes for a region that had a high confidence product location prediction may signal a change in stocking. This may be used to automatically alter location markers (expiring them, lowering their scores, etc.).

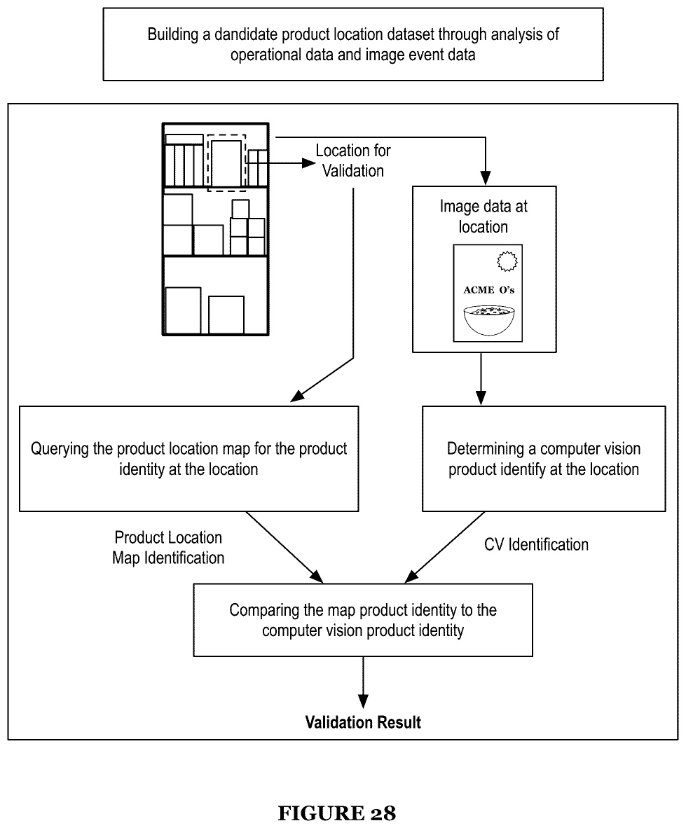

Computer vision analysis of the image data may additionally be used in refining the mapping of product locations. In some cases, automated image segmentation can be applied on the stocking of products to determine the product stocking regions within the environment. This segmentation preferably creates segments defining regions where the same type of product is displayed. This may be used in producing a more accurate reflection of the expected product location information. Accordingly, as shown in FIG. 29, translating the candidate product location dataset into a product location map can include: segmenting, using a product grouping computer vision segmentation model, regions of the image data into regions of similar product types; and assigning product locations by analyzing probable product location markers with locations in spatial proximity to each region. This segmentation can be performed to detect if and when bounds of product stocking change. If bounds change then this may trigger updates to the product location map. For example, a product location map update can be triggered if product X has its shelf space expand one column while adjacent product y shelf space contracts or shifts by one column.

There are many variations and options in which the method may be implemented. As described two main variations involve a transaction data focused variation and an on-site product scanning variation. Another related variation can involve instances of updating the candidate product location dataset with transaction data derived location markers and product scanning event derived location markers.

As shown in FIG. 19, a method variation for use with transaction data may include: at a point of sale (POS) terminal device, reading (scanning) a product identifier (e.g., scanning a machine readable code) S212; communicating, to a computing device of an inventory monitoring system, a transaction log that includes the product identifier and a timestamp S214; collecting image data S222; detecting, using a computer vision processing model, product event location data S224; identifying a set of product shelf events in the image event location data that satisfy an association condition for the transaction log S232; storing the set of product shelf events as probable location points of the product identifier in a candidate product location dataset S234; and translating the candidate product location dataset into a product location map S240.

The use of transaction data described as it is applied within a iterative process can include: progressively updating a candidate product location dataset that stores a plurality of probable product location markers, which comprises multiple instances of: at a point of sale (POS) terminal device, scanning a machine-readable product code and reading a product identifier; at the POS terminal device, communicating, to a computing device of an inventory monitoring system, the product identifier as part of a transaction log that includes a list of product identifiers and a timestamp; at a set of imaging devices, collecting image data, wherein the set of imaging devices are configured to capture a field of view that includes product storage locations; detecting, using a computer vision processing model, product event location data at the product storage locations; at the inventory monitoring system, identifying a set of product event locations in the product event location that satisfy an association condition for the transaction log, and, at the inventory monitoring system, updating the candidate product location dataset with a set of probable product location markers that each associate a location property of one of the set of product event locations with the product identifier. When the candidate product location dataset is sufficiently updated with probably location markers, then the method may proceed to translating the candidate product location dataset into a product location map.

As discussed herein, one technique of identifying a set of product event locations to match to a product identifier in a transaction log can involve scoping by customer. In this way, updating the candidate product location dataset may further involve detecting, through a person detection computer vision processing model, a user in proximity to the POS terminal device during a time of the timestamp; and where identifying a set of product event locations in the product event location that satisfy an association condition for the transaction log includes identifying a set of product event locations in the product event location data that are associated with the user. The user in proximity to the POS terminal device may be detected by detecting or accessing location of the terminal device and searching for users in a customer region defined near the POS terminal device.

As also discussed herein, use of transaction data may further involve selective analysis of receipts. In this way, identifying a set of product event locations for a transaction log (e.g., matching the product identifier to at least one product event location) may be conditionally performed if the list of product identifiers of the transaction log satisfies a mapping condition. As discussed herein, various selective processes may be used, which could depend on the number of items in the receipt, the conditions of other related receipts. The current location markers stored for a product identifier, and the other conditions.

As shown in FIG. 20, a method variation for use with scanning event data may include: at a product scanning device, reading a product identifier (e.g., scanning a machine readable code) S312; communicating, to a computing device of an inventory monitoring system, the product identifier as part of a product scanning event S314; collecting image data during a defined product locating time window of the product scanning event S322; for the scanning event, detecting, by processing the image data using a computer vision processing model, a product shelf event S324; adding, to a candidate product location dataset, a probable location marker associating a location of the product shelf event to the product identifier S332; storing the set of product shelf events as probable location points of the product identifier in a candidate product location dataset S334; and translating the candidate product location dataset into a product location map S340.

The use of product scanning events described as it is applied within a iterative process can include: progressively updating a candidate product location dataset that stores a plurality of probable product location markers, which comprises multiple instances of: at a portable product scanning device, scanning a machine-readable product code and reading a product identifier; at the portable product scanning device, communicating, to a computing device of an inventory monitoring system, the product identifier as part of a product scanning event; at a set of imaging devices, collecting image data during a defined product locating time window of the product scanning event, wherein the set of imaging devices are configured to capture a field of view that includes product storage locations; detecting, using a computer vision processing model, product event location data at the product storage locations; at the inventory monitoring system, matching the product identifier to at least one product event location in the product event location data; and at the inventory monitoring system, updating the candidate product location dataset with a probable product location marker that associates a location property of the product event location and the product identity. When the candidate product location dataset is sufficiently updated with probably location markers, then the method may proceed to translating the candidate product location dataset into a product location map.

The defined product locating time window may be configured to be a time window preceding.

The product scanning variations above, may make use of location scoping to find and/or limit product event location data to location indicating activity in proximity to the scanning event. Accordingly, such a variation matching the product identifier to at least one product event location in the product event location data may include matching the product identifier to a product event location in proximity to the location of the product scanning device. Being in proximity may be conditional on being within a set displacement, being within the same region, being present within the same field of view of a camera, being present within a set of camera views. For example, a scanning event may trigger matching the product identifier to a product event location within three cameras covering a region at or adjacent to the location of the scanning event.

In a related variation, in connection with updating the candidate product location dataset, the method may include detecting location of the product scanning device. This may involve sensing location using a location service like GPS, RF triangulation, and the like. This may alternatively include detecting the product scanning device location by detecting a visual identifier of the product scanning device in the image data.

As another variation, matching the product identifier to at least one product event location may involve temporally scoping product event locations. In general, the product event locations that should be associated with a scanning event will either be directly before, during, or after.

In this way matching may involve matching the product identifier to at least one product event location preceding a time of the product scanning event. This may be the product event location right before (and optionally within some spatial scope of the scanning event). This may alternatively be multiple product event locations within some defined time window.

This may alternatively include matching the product identifier to at least one product event location detected during a time of the product scanning event. For example, scanning a product may also trigger identifying a product event (e.g., an identifier) in proximity to the scanning device.

This may alternatively include matching the product identifier to at least one product event location proceeding a time of the product scanning event. This may be the product event location right after (and optionally within some spatial scope of the scanning event). This may alternatively be multiple product event locations within some defined time window after.

In some variations, the duration of the time window may be defined by successive scanning events such that locations can be determined from the image data during time windows between a sequence of product scanning events. This may be particularly useful when stocking as it could track full stocking regions when multiple instances of one product are placed on a shelf. For example, a worker scans a product that is being stocked, then places a crate of that product on the shelf, possibly arranging it so that there are multiple columns and stacks of the item. All these regions can be detected through processing the image data (e.g., using a background image change process). Every location where the product was stocked may be associated with that product identifier.

In another variation, matching may involve receiving a locating time window signal that indicates when a product event location is expected. For example, a user interface element on the product scanning device may allow an operator to trigger when to check capture the product location. For example, a worker scans a product, then holds a visual identifier at the location of the product and then hits a location capture button input, the CV system detects the location of the visual identifier—resulting in high confidence product identifier to location marking in an easily executed process.

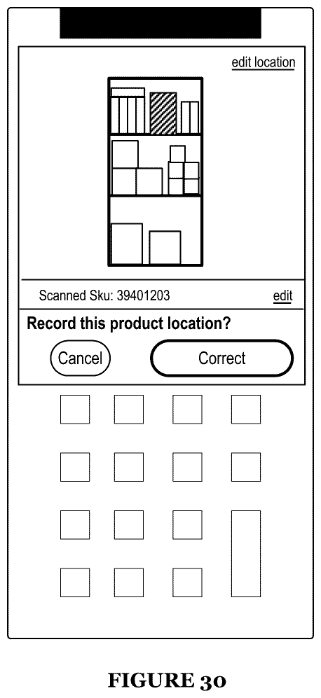

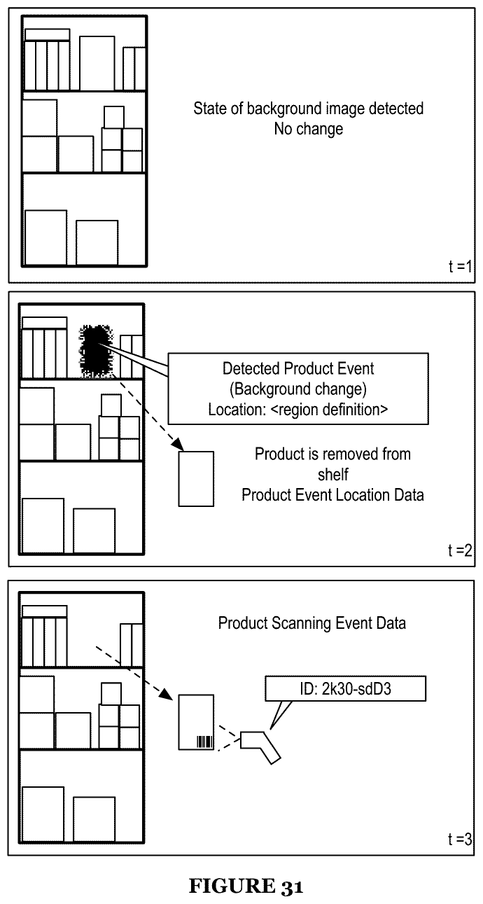

The product event locations may be detected in a variety of ways. Detecting “shelf” changes or product storage changes is one preferred technique. In one variation, detecting product event location data comprises removing foreground objects of the image data thereby forming background object image data, and detecting changes in the background object image data. This can be applied to detecting removal of a product before a scanning event (taking the product down to scan) as shown in FIG. 31. This may alternatively be applied to detecting placement of a product after the scanning event (scanning the product and then placing the product in its storage location) as shown in FIG. 32.

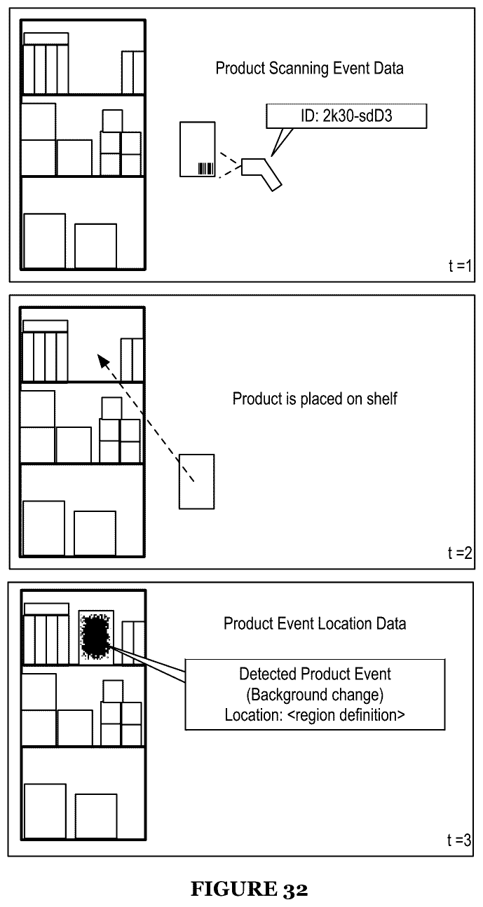

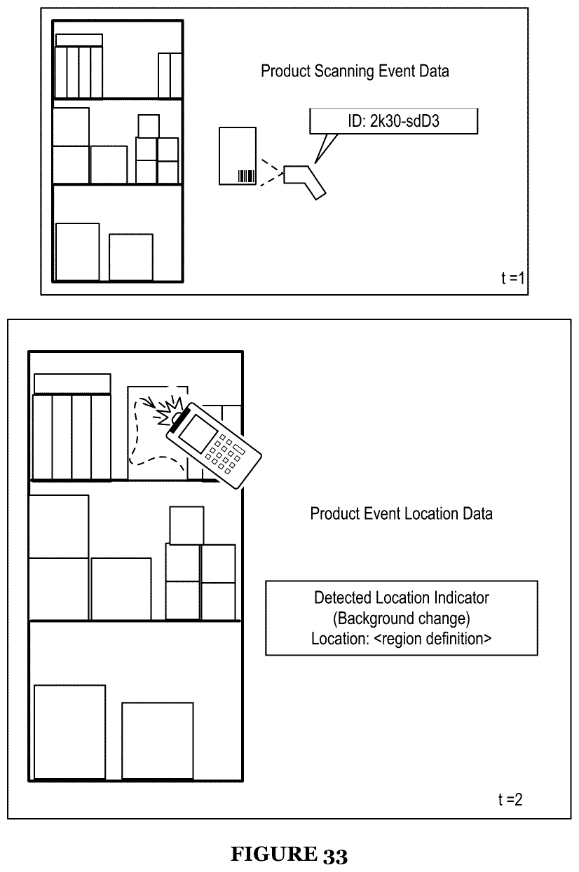

In some variations, as indicated above, a visual identifier may be used tool for marking locations of a product as shown in FIG. 33. In such a variation, detecting product event location data can include detecting a visual identifier during a product locating time window. In some instances, the visual identifier may be a separate object. In other instances, the visual identifier of the product scanning. Matching the product identifier to a product event location in the product event location data may then include using location of the visual identifier as the location matched to the product identifier. A probable location marker then associates this location to the product identifier.

In some instances, the visual identifier may be a graphic displayed on a screen of the product scanning device. The visual identifier may be a static recognizable graphic (fiducial marker). The visual identifier may alternatively be unique or identifying. The encoded identifier of the visual identifier could be associated with the scanning device (to avoid confusion to other scanning devices). The encoded identifier of the visual identifier may alternatively be dynamically generated and unique to the scanning event.

In one variation, the visual identifier can be an emitted time-variable visible signal. This may be implemented by emitting a time varying light signal. This signal could be detected by the cameras. In some instances, this light signal could be an IR light signal that can be detected through IR sensitive imaging devices. In this way, detecting a product event location may include, during a product locating time window, emitting the visual identifier as a time-variable visible signal.

In another variation of the visual identifier, detecting product event location data may include tracking the location of the visual identifier in identifying a defined location region. For example, the visual identifier may be moved by an operator in front of the region. In one implementation, the visual identifier can be activated and deactivated in response to a user control. Detecting of the visual identifier can mark location points used to define the bounds of a location region. For example, a worker could mark the corners of a rectangle defining the shelf space of a product by activating the visual identifier (hitting a button that triggers display of the identifier) at each corner.

In some variations, the scanning event variations may make use of the fact that a user is actively using the scanning device and provide feedback as to the state of the product locating process. In this way the method may include: in response to updating the candidate product location dataset with a probable product location marker, communicating product location feedback to the product scanning device, which is presented on the product scanning device. The product location feedback may be confirmation of completing the locating process. The feedback could, for example, be a visual, tactile, or audio alert indicating completion of locating the product. The feedback may alternatively indicate an error or issue which would indicate the process may need to be repeated.

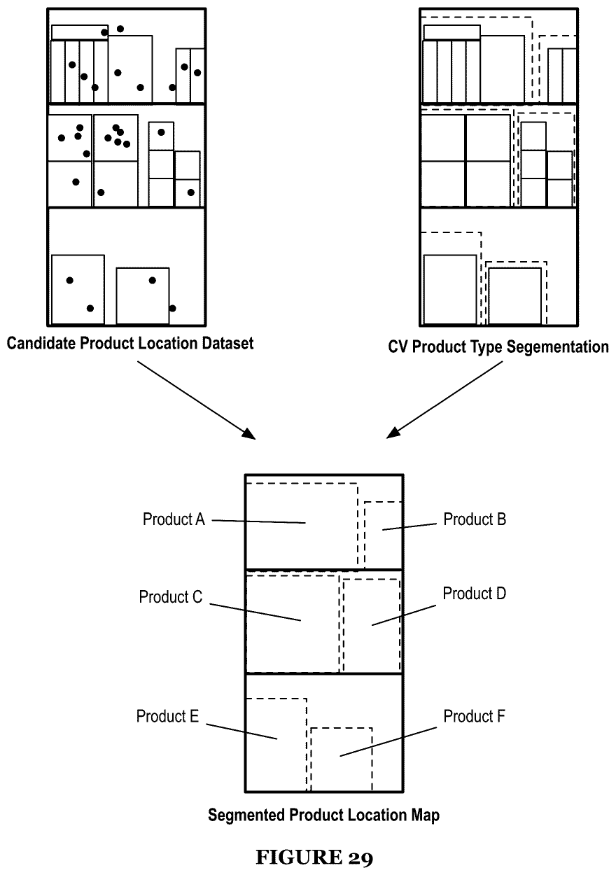

In some cases, visual feedback and user confirmation may be incorporated into the process. In this variation, communicating product location feedback to the product scanning device may include: communicating a descriptor of the detected location to the product scanning device; presenting the descriptor through a user interface output of the product scanning device, and receiving user confirmation as shown in FIG. 30. In response to positive user confirmation, a corresponding probable location marker can be stored. In response to a negative user confirmation, the user interface and the method may repeat detection of product event location, entry of operational data, cancel the creation of a new probable location marker, and/or take any suitable action.

### 7. System Architecture

The systems and methods of the embodiments can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor, but any suitable dedicated hardware device can (alternatively or additionally) execute the instructions.

In one variation, a system comprising of one or more computer-readable mediums (e.g., a non-transitory computer-readable medium) storing instructions that, when executed by the one or more computer processors, cause a computing platform to perform operations comprising those of the system or method described herein such as: dynamically modifying state of the feedback device for a set of targeted items or more specifically accessing item data of a user at an environment; at a sensor-based monitoring system, monitoring location of the user within the environment; and modifying state of a subset of feedback devices based on the item data and the location of the user.

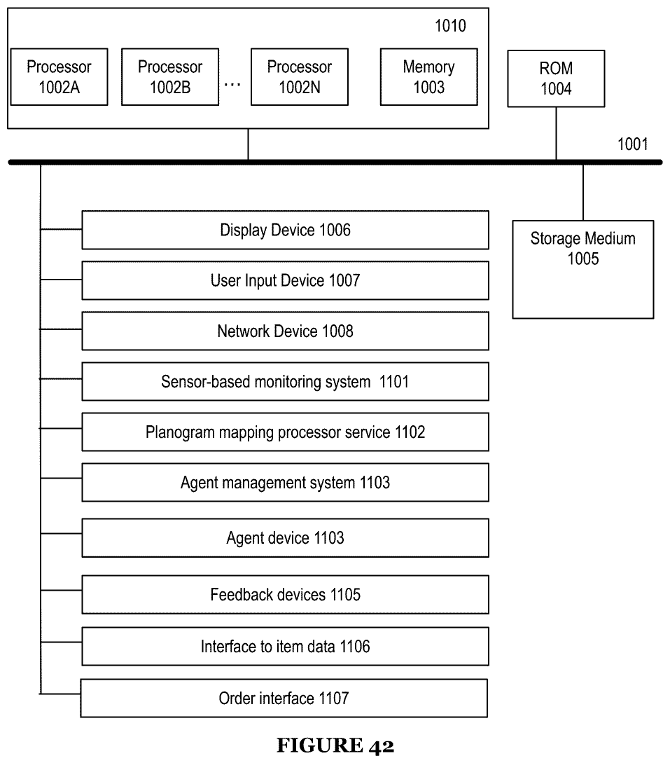

FIG. 42 is an exemplary computer architecture diagram of one implementation of the system. In some implementations, the system is implemented in a plurality of devices in communication over a communication channel and/or network. In some implementations, the elements of the system are implemented in separate computing devices. In some implementations, two or more of the system elements are implemented in same devices. The system and portions of the system may be integrated into a computing device or system that can serve as or within the system.

The communication channel 1001 interfaces with the processors 1002A-1002N, the memory (e.g., a random access memory (RAM)) 1003, a read only memory (ROM) 1004, a processor-readable storage medium 1005, a display device 1006, a user input device 1007, and a network device 1008. As shown, the computer infrastructure may be used in connecting sensor-based monitoring system 1101, planogram mapping processor service 1102, agent management system 1103, agent device 1104, set of feedback devices 1105, interface to item data 1106, optionally an order interface 1107, and/or other suitable computing devices.

The processors 1002A-1002N may take many forms, such CPUs (Central Processing Units), GPUs (Graphical Processing Units), microprocessors, ML/DL (Machine Learning/Deep Learning) processing units such as a Tensor Processing Unit, FPGA (Field Programmable Gate Arrays, custom processors, and/or any suitable type of processor.

The processors 1002A-1002N and the main memory 1003 (or some sub-combination) can form a processing unit 1010. In some embodiments, the processing unit includes one or more processors communicatively coupled to one or more of a RAM, ROM, and machine-readable storage medium; the one or more processors of the processing unit receive instructions stored by the one or more of a RAM, ROM, and machine-readable storage medium via a bus; and the one or more processors execute the received instructions. In some embodiments, the processing unit is an ASIC (Application-Specific Integrated Circuit). In some embodiments, the processing unit is a SoC (System-on-Chip). In some embodiments, the processing unit includes one or more of the elements of the system.

A network device 1008 may provide one or more wired or wireless interfaces for exchanging data and commands between the system and/or other devices, such as devices of external systems. Such wired and wireless interfaces include, for example, a universal serial bus (USB) interface, Bluetooth interface, Wi-Fi interface, Ethernet interface, near field communication (NFC) interface, and the like.

Computer and/or Machine-readable executable instructions comprising of configuration for software programs (such as an operating system, application programs, and device drivers) can be stored in the memory 1003 from the processor-readable storage medium 1005, the ROM 1004 or any other data storage system.

When executed by one or more computer processors, the respective machine-executable instructions may be accessed by at least one of processors 1002A-1002N (of a processing unit 1010) via the communication channel 1001, and then executed by at least one of processors 1001A-1001N. Data, databases, data records or other stored forms data created or used by the software programs can also be stored in the memory 1003, and such data is accessed by at least one of processors 1002A-1002N during execution of the machine-executable instructions of the software programs.

The processor-readable storage medium 1005 is one of (or a combination of two or more of) a hard drive, a flash drive, a DVD, a CD, an optical disk, a floppy disk, a flash storage, a solid-state drive, a ROM, an EEPROM, an electronic circuit, a semiconductor memory device, and the like. The processor-readable storage medium 1005 can include an operating system, software programs, device drivers, and/or other suitable subsystems or software.

As used herein, first, second, third, etc. are used to characterize and distinguish various elements, components, regions, layers and/or sections. These elements, components, regions, layers and/or sections should not be limited by these terms. Use of numerical terms may be used to distinguish one element, component, region, layer and/or section from another element, component, region, layer and/or section. Use of such numerical terms does not imply a sequence or order unless clearly indicated by the context. Such numerical references may be used interchangeable without departing from the teaching of the embodiments and variations herein.

As a person skilled in the art will recognize from the previous detailed description and from the figures and claims, modifications and changes can be made to the embodiments of the invention without departing from the scope of this invention as defined in the following claims.

We claim:

1. A method comprising:
accessing item data of a user at an environment;
at a sensor-based monitoring system, monitoring location of the user within the environment;
modifying state of a subset of feedback devices based on the item data and the location of the user, wherein the subset of feedback devices is part of a set of feedback devices distributed within the environment.

2. The method of claim 1, wherein modifying state of the subset of feedback devices based on the item data and the location of the user comprises:
detecting a user-item proximity condition when the location of the user is within a proximity distance threshold from an item indicated in the item data, and
activating a feedback device associated with the item in response to detecting the user-item proximity condition.

3. The method of claim 2, wherein modifying state of the subset of feedback devices based on the item data and the location of the user further comprises:
confirming completion of a user-item interaction for the item, and
deactivating the feedback device associated with the item.

4. The method of claim 1, wherein modifying state of the subset of feedback devices comprises: updating state of at least a first feedback device to indicate storage location of a targeted item from the item data, and updating state of at least a second feedback device to indicate a navigational cue towards the targeted item from the item data.

5. The method of claim 1, wherein accessing item data of a user at an environment comprises access a shopping list with a set of items.

6. The method of claim 5, further comprising: mapping agent path directions for the set of items within the environment based on a product location map, the agent path directions indicating a sequence of items; and wherein modifying state of the subset of feedback devices based on the item data and the location of the user further comprises:
sequentially updating the subset of feedback devices based on a current item in the sequence of items and the location of the user, and
upon determining completion of a user-item interaction for the current item, updating the current item to a next item in the sequence of items.

7. The method of claim 6, further comprising, updating the agent path directions in real-time based on the location of the user.

8. The method of claim 7, wherein updating the agent path directions in real-time based on the location of the user is further based on a change in inventory status of the item.

9. The method of claim 7, wherein updating the agent path directions in real-time based on the location of the user is further based on detected user congestion.

10. The method of claim 1, wherein the set of feedback devices is a plurality of feedback devices that is distributed across distinct item storage locations in the environment.

11. The method of claim 1, wherein the set of feedback devices comprises a plurality of feedback devices with graphical displays; wherein modifying state of a subset of feedback devices comprises altering display state of a graphical display of a feedback device in the subset of feedback devices.

12. The method of claim 1, wherein the set of feedback devices comprises a plurality of electronic shelf labels positioned on storage equipment adjacent to products in the environment; and wherein modifying state of the subset of feedback devices comprises altering visual state of a visual output of an electronic shelf label.

13. The method of claim 1, wherein the set of feedback devices comprises a plurality of feedback devices with light emitting diode (LED) visual beacons; and wherein modifying state of the subset of feedback devices comprises altering illumination state of a visual beacon of a feedback device.

14. The method of claim 1, wherein the sensor-based monitoring system is a computer vision monitoring system.

15. A non-transitory computer-readable medium storing instructions that, when executed by one or more computer processors of a computing platform, cause the computing platform to perform operations comprising:
accessing item data of a user at an environment;
at a sensor-based monitoring system, monitoring location of the user within the environment;
modifying state of a subset of feedback devices based on the item data and the location of the user, wherein the subset of feedback devices is part of a set of feedback devices distributed within the environment.

16. A system comprising:
a set of feedback devices distributed at distinct locations across an environment;
an interface to item data of users;
a sensor-based monitoring system comprising configuration to perform operations comprising:
monitoring location of the user within the environment, and
modifying state of a subset of feedback devices based on the item data and the location of the user, wherein the subset of feedback devices is part of a set of feedback devices distributed within the environment.

17. The system of claim 16, wherein the configuration is further configured to perform operations comprising:
detecting a user-item proximity condition when the location of the user is within a proximity distance threshold from an item indicated in the item data, and
activating a feedback device associated with the item in response to detecting the user-item proximity condition.

18. The system of claim 17, wherein the set of feedback device comprises a set of electronic shelf labels that comprise at least a visual output, where the state of the visual output is modified.

19. The system of claim 17, wherein the sensor-based monitoring system is a computer vision monitoring system.

20. The system of claim 16, wherein the interface to item data of users is a data interface to a digital shopping delivery service.
